(19) United States
(12) Patent Application Publication
(10) Pub. No.: US 2004/0088284 A1
(43) Pub. Date: May 6, 2004

(54) Extraction of information as to a volume group and logical units

(76) Inventors: John Gourlay, Sacramento, CA (US); Fengliang Hu, North Highlands, CA (US); Thomas Vachuska, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/284,373

(22) Filed: Oct. 31, 2002

(51) Int. Cl. G06F 7/00

(52) U.S. Cl. 707/3

(57) ABSTRACT

A method of data extraction for use with a host, connected to one or more logical units (LUNs), that is operable to host a volume manager that manages access to the one or more LUNs via the creation of one or more volume groups, the method includes: providing one or more queries to the volume manager; and determining, for each volume group, which of the one or more LUNs are members of the volume group based upon results of the queries, respectively.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

A storage area network (SAN) is a high-speed, high-bandwidth inter-server network utilizing integrated hardware and software to provide a robust, high-speed storage backbone. A SAN enables clusters of servers to share storage with exclusive data access or to share data on common storage devices, depending on the SAN topology. SAN networks are useful, for example, in fully networked enterprises that require storage of terabytes of information collected on each customer and each transaction. The need for high availability and security of data adds to escalating requirements. SANs offer fast, available pools of storage that can be shared throughout an enterprise, yet managed through simplified operations.

SANs include large collections of storage elements, such as multiple hard disk drives, tapes, etc. To ensure adequate performance of a SAN, data and metrics (measurements of performance, capacity, efficiency, etc.) are gathered. These metrics are used to determine, among other things, performance trends and statistics by which possible problems (such as bandwidth bottlenecks) can be anticipated and prevented.

With a SAN or other storage environment according to the Background Art, it is known to run a storage area manager (SAM) process on a server within the SAN. As its name implies, the SAM, in part, manages the interaction between components of the storage environment as well as interaction of application programs having storage needs (consumers) with components of the storage environment.

FIG. 1 is a block diagram of a system 100 that includes a SAM 120, a SAN 108 and a consumer 130. The SAM 120 can be loaded on a managing host device 106. Also loaded on the managing host 106 is a client 122 that includes a graphical user interface (GUI). The managing host 106 can run either a WINDOWS NT or WINDOWS 2000 operating system. The SAM 120 can communicate with the host agent 126 using a JAVA RMI over, e.g., a LAN.

The consumer of storage, or storage consumer, 130 can be loaded on a managed host 104. Also loaded on the managed host 104 can be a volume manager 128 and a host agent 126 of the SAM 120. The volume manager 128 (and therefore the managed host 126) can communicate with the SAN 108 (via a Fibre Channel, iSCSI, etc. link) and/or a local/dedicated SCSI device 118 (via a SCSI link).

The SAN 108 has various storage devices connected to it, such as a SCSI/FC device 112 or a SCSI device 114 connected via a bridge 116. The SAN 108 also includes an SNMP device 110 by which the SAM 120 can communicate with the SAN 108.

For ease of reference, a block has been drawn around the SAN and the related storage resources. This block has been given the reference number 102 and is labeled SAN+Resources. Logical units (LUNs) (not depicted) represent paths of access to the SAN+Resources 102.

The host agent 126 has builder components 132 and the SAM 120 has corresponding builder components 124. The builder components 132 that include a volume gatherer 134, a user gatherer 136 and a file gatherer 138. The volume gatherer 134 collects summary information regarding consumption by the storage consumers 130, the user gatherer 136 identifies who can consume storage and the file gatherer 138 collects details of both who, namely which user, and what, namely a list of data types, are consuming the available storage.

Via the client 122, a user of the SAM 120 can observe the total amount of storage available on a logical volume and an amount of the available storage that has been consumed. But no additional information concerning the relationship between a logical volume and its associated LUNs is available from the SAM 120 via the client 122.

### SUMMARY

An embodiment of the invention provides a method of data extraction for use with a host, connected to one or more logical units (LUNs), that is operable to host a volume manager that manages access to the one or more LUNs via the creation of one or more volume groups. Such a method includes: providing one or more queries to the volume manager; and determining, for each volume group, which of the one or more LUNs are members of the volume group based upon results of the queries, respectively.

Additional features and advantages of the invention will be more fully apparent from the following detailed description of example embodiments, the appended claims and the accompanying drawings.

### BRIEF DESCRIPTION OF THE DRAWINGS

FIG. 1 is a block diagram of a SAN, a managing host and a managed host according to the Background Art.

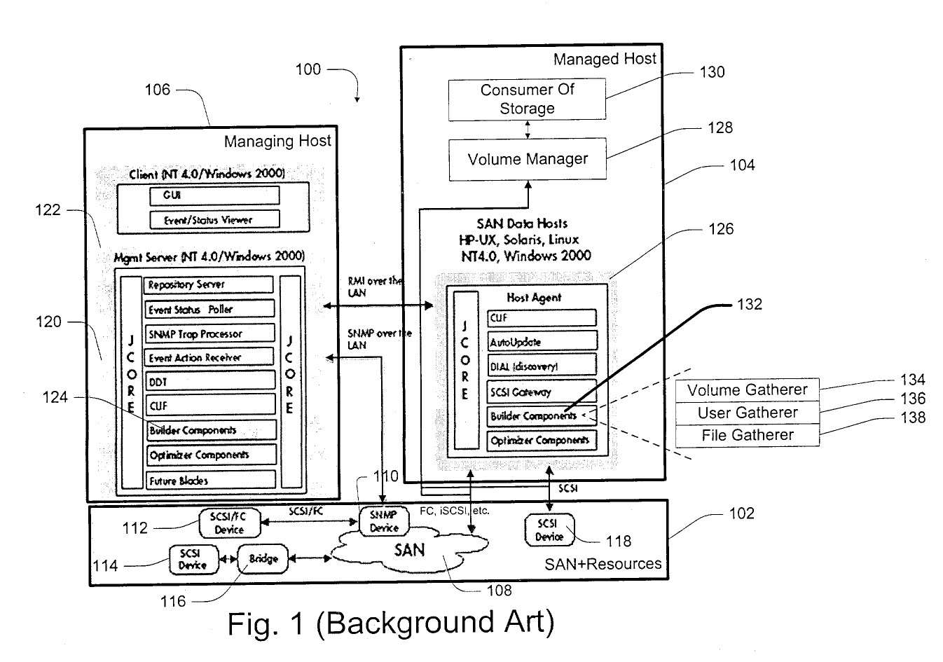

FIG. 2 is a block diagram of a SAN, a managing host and a managed host according to an embodiment of the invention.

FIG. 3 is a sequence diagram of data collection actors and actions according to an embodiment of the invention.

FIG. 4 is a UML class diagram according to an embodiment of the invention.

FIG. 5 is a diagram depicting relationships according to an embodiment of the invention.

Actions in a UML sequence diagram are depicted with arrows of different styles. A [symbol] indicates an action that expects a response action. A [symbol] indicates a response action. A [symbol] indicates an action for which the response is implied. And a [symbol] indicates an action for which no response is expected.

The accompanying drawings are: intended to depict example embodiments of the invention and should not be interpreted to limit the scope thereof; and not to be considered as drawn to scale unless explicitly noted. ,

### BRIEF DETAILED DESCRIPTION OF EXAMPLE EMBODIMENTS

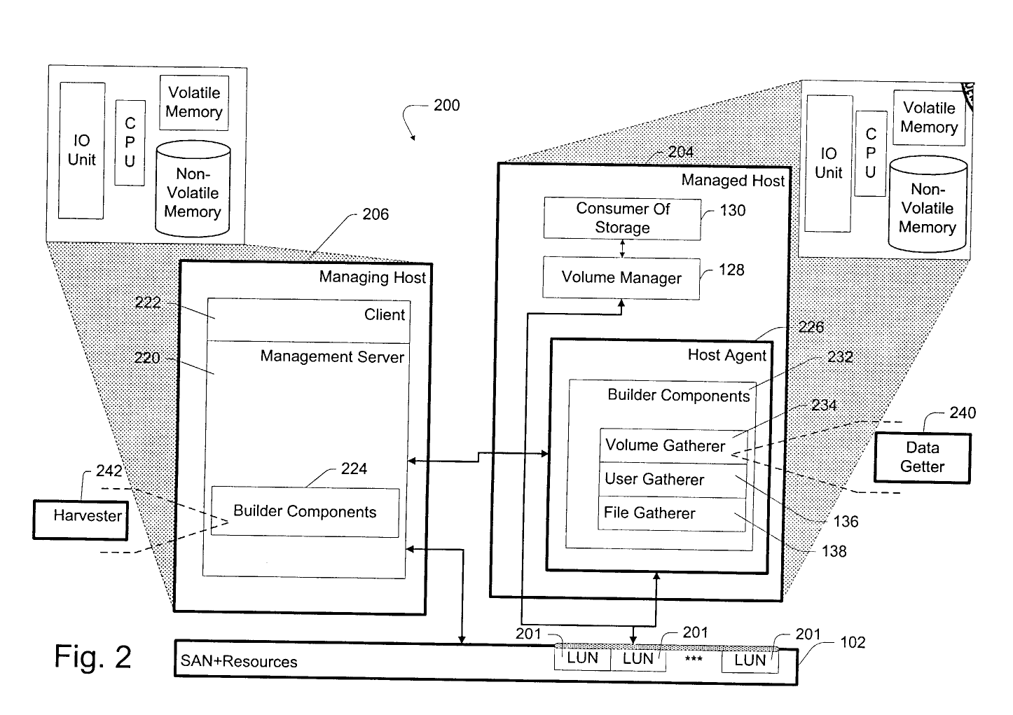

FIG. 2 is a block diagram of a system 200 according to an embodiment of the invention that includes a SAN+Resources 102, a managed host 204 (connected to the SAN+Resources 102) and a managing host 206 (connected to each of the SAN+Resources 102 and a host agent 226 of the managed host 204). The SAN+Resources 102 can be the same as in the Background Art. Each of the managed host 204 and the managing host 206 can be implemented by typical computers that, e.g., have: a CPU; volatile memory (such as RAM, DRAM, SRAM, etc.); non-volatile memory (such as magnetic, opto-magnetic and/or opto-hard disk drives, flash memory, etc.); and an input/output (IO) unit (adapted to provide a man-to-machine interface and/or a machine-to-machine interface). Paths into the SAN+Resources 102 are indicated as logical units (LUNs) 201.

Similar to the Background Art, the managing host 206 has software loaded on it that includes a management server or SAM 220 and a client 222 (that includes a GUI, etc.). The SAM 220 includes building components 224. But unlike the Background Art, the builder components 224 include a harvester component 242.

Also similar to the Background Art, the managed host 204 includes a volume manager 128, a consumer of storage 130 (such as an application program) and a host agent 226. The host agent 226 has builder components 232 that include a volume gatherer 234, a user gatherer component 136 and a file gatherer component 138. But unlike the volume gatherer 134 according to the Background Art, volume gatherer 234 includes a data getter component 240.

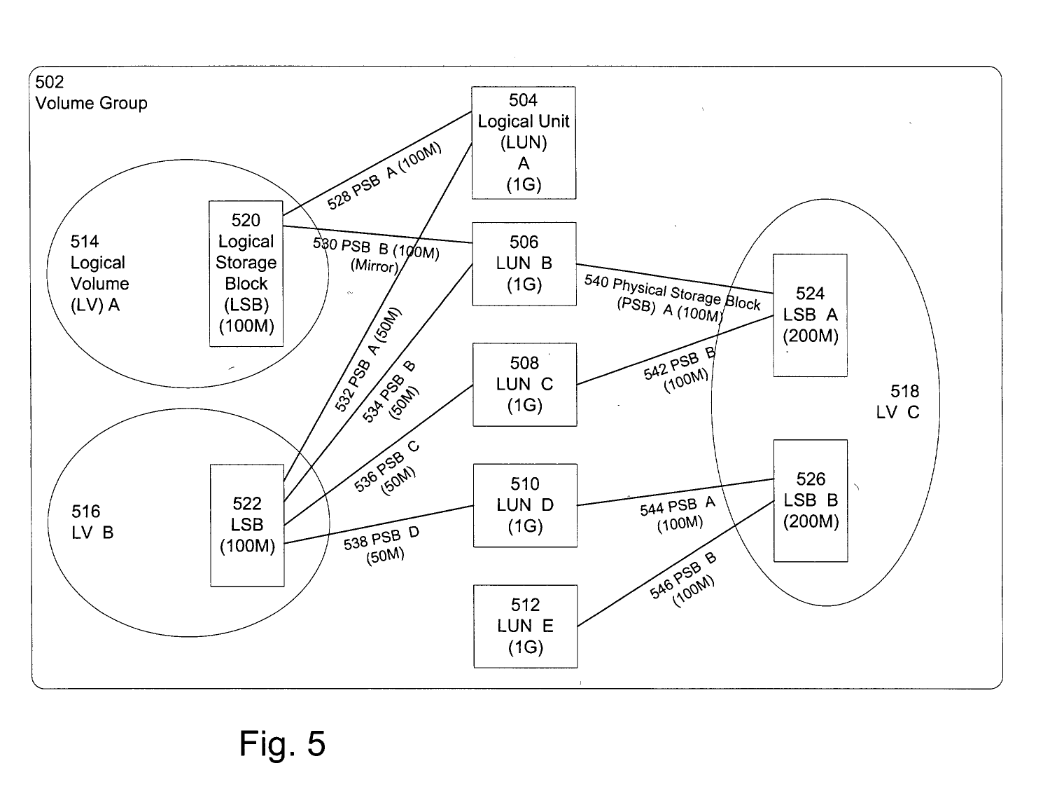

The harvester 242 and the volume gatherer 234 (via the data getter 240) extract information about the utilization of storage allocated on the SAN+Resources 102 to the managed host 204. FIG. 5 is a diagram of relationships according to an embodiment of the invention that represent such utilization, albeit in terms of a simplistic example. It should be understood that the relationships depicted in FIG. 5 have applicability far beyond the example circumstances depicted in FIG. 5.

In FIG. 5, a volume manager 128 has created a single volume group 502 that has as its members logical units (LUNs) A-E (504-512). It should be noted that a volume manager 128 can create multiple volume groups. A LUN should be a member of a single volume group.

Four logical storage blocks (LSBs) 520, 522 and 524 and 526 are depicted in FIG. 5. An LSB can have one or multiple physical storage blocks (PSBs) that map to it, either directly or indirectly via one or more intervening child LSBs. A LUN can map to one or more PSBs.

As to the details of the example that is FIG. 5, each of the five LUNs A-E 504-512, respectively, represents 1 GB of memory. Logical volume A (514) has a single LSB (520) that represents 100 MB memory. A PSB (528) represents 100M of memory allocated on the LUN A (504). A PSB (530) represents 100M of memory allocated on the LUN B (504) in a mirror arrangement.

Logical volume B (516) has a single LSB (522) that represents 150 MB memory in a RAID 5 arrangement. Four 50 MB PSBs 532-538 map from LUNs A-D (504-510), respectively. It is noted that the, e.g., PSB 538 represents 50 MB of overhead needed for the RAID 5 arrangement.

Logical volume C (518) has two LSBs (524 and 526) that each represent 200 MB and together represent 400 MB of memory. Two 100 MB PSBs 540 and 542 map from LUNs B-C (506-508), respectively. Two 100 MB PSBs 544 and 546 map from LUNs D-E (5010-512), respectively.

The hypothetical numerical details in FIG. 5 can be described as representing 3 logical volumes distributed across 5 LUNs. LUNs A (514) and C (508) have 150 MB usage. LUN B (506) has 250 MB usage. LUN D (510) has 150 MB usage. And LUN E (512) has 100 MB usage. Percentage usages can be determined for each LUN relative to its maximum capacity, e.g., LUN A is at 15% usage=(150 MB/1 GB)*100. The total usage of the LUNs A-E 504-512 is 800 MB, or 16%=(800 MB/1 GB)*100. Free space at the volume group level is 4.2 GB. Any one of LVs A-C (514, 516 and 518) can extend into that free space. It is to be noted that the LSB 526 can be viewed as an extension of LV C (518). Such statistics about a volume group are desirable. An embodiment of the invention makes available the data regarding the volume group, logical volumes, LSBs, PSBs and LUNs needed to provide such statistics, respectively.

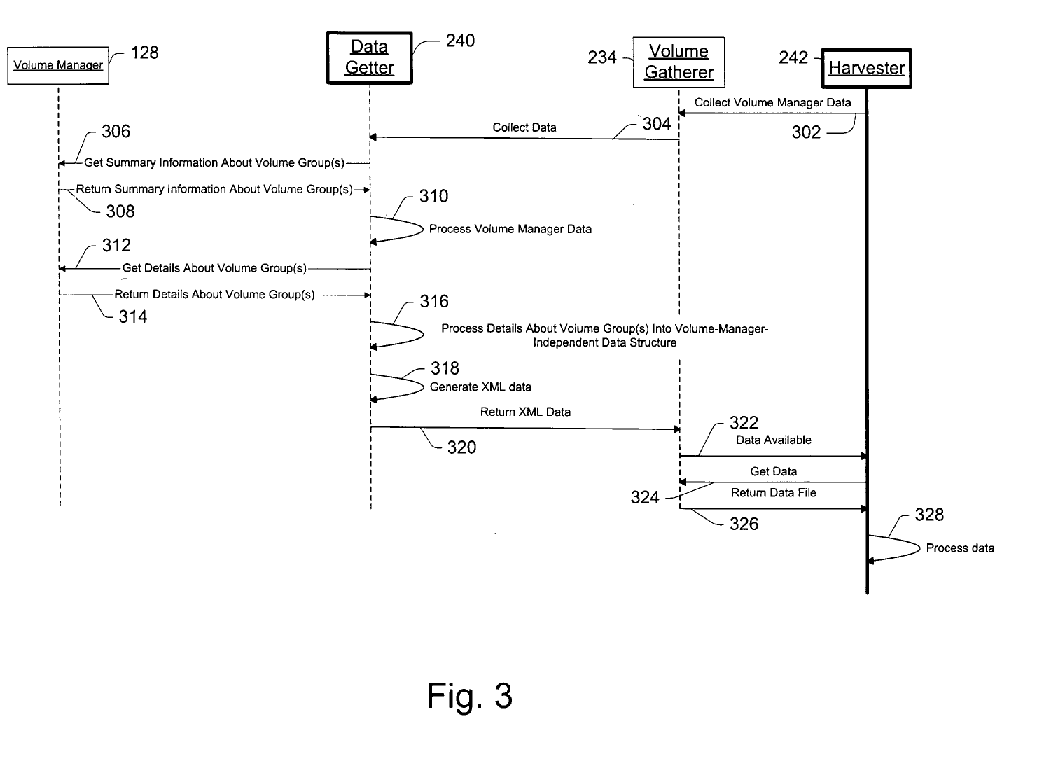

The harvester 242 and the volume gatherer 234 (via the data getter 240) extract information about the utilization of the LUNs 201 on the SAN+Resources 102. A sequence of actions and the associated actors that extract such data is depicted in FIG. 3, a UML sequence diagram.

At action 302 in FIG. 3, the harvester 242 instructs the volume gatherer 234 to extract or gather data related to relationships between volume groups and LUNs. Next, via action 304, the volume gatherer 234 calls the data getter 240 in order to obtain the desired data. In turn, the data getter 240 (via action 306) queries the volume manager 128 to obtain summary information about the currently configured volume group(s) that the volume manager 128 manages. The summary information, e.g., can be a list of the volume groups.

At action 308, the volume manager 128 returns the requested volume group summary information to the data getter 240. At action 310, the data getter 240 processes the volume group summary information. Such processing, e.g., can be making a request for detailed information regarding each identified volume group. At action 312, the data getter 240 queries the volume manager 128 to obtain details about the volume group that the volume manager 128 manages.

Actions 306, 308, 310, 312 and 314 reflect a two-part technique, namely collecting a list of groups and then retrieving the detailed information about each of the groups. Alternative techniques can be used to extract the detailed information about volume groups.

At action 314, the volume manager 128 returns the requested details concerning the volume group. At self action 316, the data getter 240 processes the volume manager details into a format, e.g., a data structure, that is independent of the type of volume manager from which the details were obtained (to be discussed in more detail below). For example, at action 316, the data getter 240 also filters out data from the volume manager 128 that is too granular to be of diagnostic and/or predicted value to a user of a SAM 220.

At self call 318, the data getter 240 converts the data into a language that facilitates the transmission and interpretation of the data, e.g., XML. At action 320, the data getter 240 provides the XML to the volume gatherer 234. At action 322, the volume manager 234 notifies the harvester 242 that the requested data is available. At action 324, the harvester 242 requests the data from the volume gatherer 234. At action 326, the volume getter 234 provides the XML data set to the harvester 242. Lastly, at action 328, the harvester processes the XML data set, e.g., to present the data in a more user-friendly format and/or inclusion in a database.

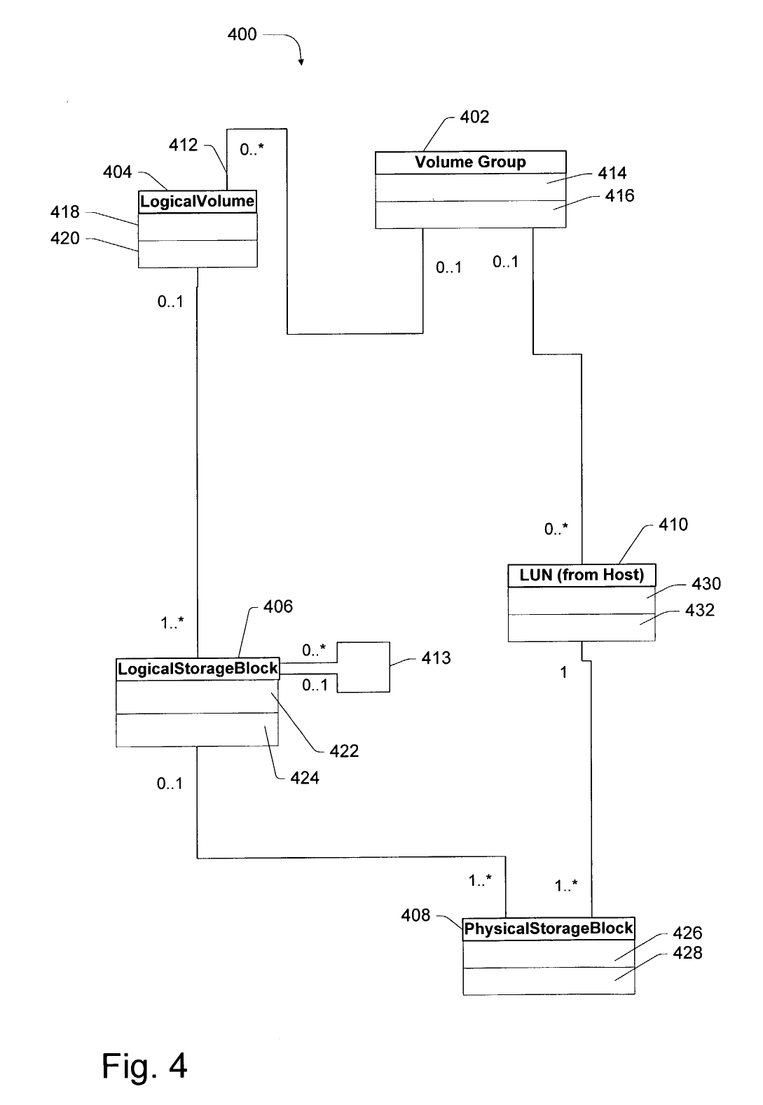

FIG. 4 is a JAVA class diagram that depicts the various relationships represented by the standardized data set produced by the data getter 240 at action 316. In FIG. 4, a set 400 of data objects (DOs) includes a volume group DO 402, a logical volume (or storage consumer) DO 404, a logical storage block (LSB) DO 406, a physical storage block (PSB) 408 and a logical unit (LUN) DO 410. A line connecting one DO to another indicates a relationship between the DOs. For example, a relationship line 412 connects the volume group DO 402 to the logical volume DO 404.

Near where the line 412 connects to the volume group DO 402 is listed the legend “0..1”. This indicates that the logical volume DO 404 can have between 0 and 1 volume group DO 402 to which the logical volume DO 404 reports. Near the end of the line 412 that connects to the logical volume DO 404 is located the legend “0..*”. This indicates that there can be between 0 and an infinite number of logical volume DOs 404 that can report to the volume group DO 402. In other words, the volume group DO 402 can have multiple logical volume DOs 404 that report to it, but each logical volume DO can report to at most one volume group DO 402.

Similarly, the LSB DO 406 can report to at most one logical volume DO 404. But a logical volume DO 404 can have one or more LSB DOs 406 that report to it.

Relationship line 413 indicates a relationship between a parent LSB DO 406 and a child LSB DO (not separately depicted from the parent LSB DO 406). A child LSB DO can have at most one parent LSB DO. But a parent LSB DO can have zero, one or more child LSB DOs.

The relationship between the LSB DO 406 and the physical storage block (PSB) DO 408 is as follows. The PSB DO 408 can have at most one LSB DO 406 to which it reports. But the LSB DO 406 has one or more PSB DOs 408. A relationship between the PSB DO 408 and the logical unit (LUN) DO 410 is as follows. Each PSB DO 408 has one LUN DO 410 to which it reports. But the LUN DO 410 has one or more PSB DOs 408 that report to it.

Lastly, the relationship between the volume group DO 402 and the LUN DO 410 explained. The LUN DO 410 can have at most one volume group DO 402 to which it reports. But the volume group DO 402 can have zero, one or more LUN DOs 410 reporting to it.

Each of the DOs depicted in FIG. 4 is organized into two parts. The first part represents attributes of the DO while the second part represents JAVA methods used to obtain information related to the nature of the DO. For example, the volume group DO 402 has an attributes portion 414 and a JAVA methods portion 416. Similarly, the logical volume 404 has an attributes portion 418 and a JAVA methods portion 420. The LSB 406 has an attributes portion 422 and a JAVA methods portion 424. The PSB DO 408 has an attributes portion 426 and a JAVA methods portion 428. And the LUN DO 410 has an attributes portion 430 and JAVA methods portion 432.

The attributes portion of the DOs 402, 404, 406, 408 and 410 will have a variety of information that depends upon the circumstances of the SAN+Resources 102 in which the set of data objects 400 is concerned. Similarly, the JAVA methods portion of the DOs 402, 404, 406, 408 and 410 will have varying sense of methods depending upon the circumstances of the SAN+Resources 102 in which the data objects at 400 is concerned.

At the end of the description are example JAVA documents that populate the attributes sections and methods sections of the DOs 402, 404, 406, 408 and 410. As an example, for the JAVA document referred to as class LogicalStoragePool (corresponding to the volume group DO 402 of FIG. 4), the attributes portion 414 of the volume group DO 402 is elaborated upon, e.g., in the following Field Summary section and the Field Detail section. The JAVA methods portion 416 is elaborated upon, e.g., in the Methods Summary section, the Constructor Summary section, the Constructor Detail section and the Methods Detail section.

The methods listed within the JAVA methods portion, e.g., 416 of volume group DO 402, are determined as follows. Depending upon the circumstances of the source+resources 102 to which the manage host 204 is connected, a user of the SAM 220 will prepare a heavily-patterned JAVA source file (as known as a class) and submit it to a tool that generates corresponding methods. Such a tool is described in three copending applications, having U.S. patent application Ser. Nos. 10/232,000, 10/231,947 and 10/231,693, each of which was filed on Aug. 30, 2002, the entirety of each of which is hereby incorporated by reference. The heavily patterned JAVA source file is also known as a template. Sample templates are provided at the end of this description. The sample templates are interspersed with the corresponding JAVA documents.

A SAM 220 can work with a variety of volume managers 128, e.g., the brand of volume manager made available by VERITAS (referred to as VxVM) or by the HEWLETT-PACKARD Company (referred to as LVM). Each of the volume managers typically can operate on a variety of operating systems, e.g., the versions of Unix made available by the SUN MICROSYSTEMS Corporation (known as SOLARIS), the versions of Unix made available by the HEWLETT-PACKARD COMPANY (known as HPUX), the windowing family of operating systems made available by the MICROSOFT CORPORATION, e.g., WINDOWS 2000 and WINDOWS NT (collectively referred to as W2K/NT), and the versions of Unix made available by the IBM corporation (referred to as AIX).

For example, consider the circumstances in which the SAM 220 should interact with versions of VxVM running on SOLARIS, HPUX and W2K/NT, and with LVM running on AIX and EPUX. In effect, the number of volume managers with which the SAM 220 must interact in the example is not merely two but is five because of the variations conferred by the different operating systems. As such, when the volume manager 128 provides the volume group details at action 314, the nature and format of the details will depend upon the brand of the volume manager as well as the operating system upon which the volume manager 128 runs. Accordingly, the data getter 240 processes the volume group details into a standardized set of data at action 316.

Alternatively, the standardization capability could be incorporated into the harvester 242, but that would complicate the harvester 242. Plus, as interaction with additional volume managers is accommodated by the harvester 242, the harvester 242 would continually need to be revised to handle the variations in the data set return by the volume manager. Locating the standardization capability in the data getter 240 can simplify the process of making a harvester 242 compatible with additional volume manager 128 because the necessary data transformations/standardizations for a given volume manager 128 and its respective operating systems can be handled by the data getter 240 rather than the harvester 242. The successive development of several smaller less complex data getters can be simpler to achieve than repeated revision of a larger, more complicated harvester 242.

As noted, each data getter 240 can generate an XML file which will include information about the groups under the control of the volume manager 128. The following discusses example configuration of the XML file. Initially, the tags in the file are discussed in general. That discussion is followed by some example file configurations.

<VG>

| | |
|---|---|
| type | Volume Manager that manages the group, e.g., LVM, VxVM, |
| | etc . . . |
| name | Name of the volume/disk group |

<SC>

| | |
|---|---|
| name | Name of a logical volume in the volume/disk group (Should |
| | have a relationship with file systems as reported by the |
| | volume gatherer) |
| size | The total number of blocks |
| blockSize | The total size of the block. It is in the unit of bytes. |

<LSB>

| | |
|---|---|
| name | An identifier that represents a slice or, in situations where |
| | there are multiple transformations of the data (e.g. mirroring |
| | and striping) a subslice of the storage consumer. |
| type | The type of relationship between the components that make |
| | up this block e.g., mirror, stripe, direct, raid. |
| typeCount | The number of components that make up the block. |

<PSB>

| | |
|---|---|
| name | An identifier that represents a slice of a LUN that has been |
| | used to create a storage consumer. |
| size | The size of the slice in blocks |
| blockSize | The block size in the unit of bytes. |
| Lun | The device file for the LUN that the slice is carved from |

<Lun>

| | |
|---|---|
| name | The device file that connects to a LUN |
| size | The size of the LUN in extents |
| extentSize | The extent size. It is in the unit of bytes. |

An example of an XML file or data set where the volume manager 128 is LVM running upon operating system (OS) HPUX would be:

```
<VG type=“LVM” name=“/dev/vg00” >
  <SC name=“/dev/vg00/lvol1” size=“64” blockSize=“1048576”>
  <LSB name=“lvol1” type=“direct” typeCount=“1”>
    <PSB name=“lvol1-01” size=“64” blockSize=“1048576”
    lun=“/dev/dsk/c0t6d0” >
    </PSB>
  </LSB>
  </SC>
  <SC name=“/dev/vg00/lvol2” size=“768” blockSize=“1048576”>
  <LSB name=“lvol2” type=“stripe” typeCount=“2”>
    <PSB name=“lvol2-01” size=“384” blockSize=“1048576”
lun=“/dev/dsk/c0t6d0”>
    </PSB>
    <PSB name=“lvol2-02” size=“384” blockSize=“1048576”
lun=“/dev/dsk/c0t6d1”>
    </PSB>
  </LSB>
  </SC>
  <SC name=“/dev/vg00/lvol3” size=“2000” blockSize=“1048576”>
  <LSB name=“/dev/vg00/lvol3” type=“mirror” typeCount=“2”>
    <PSB name=“lvol3-01” size=“2000” blockSize=“1048576”
    lun=“/dev/dsk/c0t6d0”
>
    </PSB>
    <PSB name=“lvol3-02” size=“2000” blockSize=“1048576”
lun=“/dev/dsk/c0t6d1” >
    </PSB>
  </LSB>
  </SC>
  <hostluns>
  <Lun name=“/dev/dsk/c0t6d0” size=“18000” extentSize=“1048576”>
</Lun>
<Lun name=“/dev/dsk/c0t6d1” size=“7000” extentSize=“1048576”>
</Lun>
  </hostluns>
</VG>
```

An example of an XML data set where the volume manager 128 is VxVM running upon the OS HPUX would be:

```
<VG type=“VxVM” name=“rootdg”>
  <hostluns>
  <Lun name=“/dev/dsk/c3t3d0” size=“2081484” extentSize=“1024”>
  </Lun>
  </hostluns>
</VG>
<VG type=“VxVM” name=“builderdg”>
  <SC name=“/dev/builderdg/vol01” size=“10000” blockSize=“1024”>
  <LSB name=“vol01-01” type=“direct” typeCount=“1”>
    <PSB name=“builder01-01” size=“10000” blockSize=“1024”
lun=“/dev/dsk/c3t4d0”>
    </PSB>
  </LSB>
  </SC>
  <SC name=“/dev/builderdg/vol02” size=“20000” blockSize=“1024”>
  <LSB name=“vol02-01” type=“stripe” typeCount=“2”>
    <PSB name=“builder01-01” size=“10000” blockSize=“1024”
lun=“/dev/dsk/c3t4d0”>
    </PSB>
    <PSB name=“builder01-02” size=“10000” blockSize=“1024”
lun=“ldev/dsk/c3t4d1”>
    </PSB>
  </LSB>
  </SC>
  <SC name=“/dev/builderdg/vol03” size=“3000” blockSize=“1024”>
  <LSB name=“vol03-01” type=“mirror” typeCount=“3”>
    <PSB name=“dg0203-01” size=“3000” blockSize=“1024”
    lun=“/dev/dsk/c8t8d0”>
    </PSB>
    <PSB name=“dg0201-02” size=“3000” blockSize=“1024”
    lun=“/dev/dsk/c8t9d0”>
    </PSB>
    <PSB name=“dg0205-02” size=“3000” blockSize=“1024”
    lun=“/dev/dsk/c8t7d0”>
    </PSB>
  </LSB>
  </SC>
  <hostluns>
  <Lun name=“/dev/dsk/c3t4d0” size=“4193005” extentSize=“1024”>
</Lun>
<Lun name=“/dev/dsk/c3t4d1” size=“6450000” extentSize=“1024”>
</Lun>
  <Lun name=“/dev/dsk/c8t8d0” size=“17782088” extentsize=“1024”>
</Lun>
  <Lun name=“/dev/dsk/c8t9d0” size=“17782088” extentSize=“1024”>
</Lun>
  <Lun name=“/dev/dsk/c8t7d0” size=“17782088” extentSize=“1024”>
</Lun>
  </hostluns>
</VG>
```

The LVM data and VxVM data can be combined into a single XML data set by the harvester 242. Such an example data set would be:

<managedgroups>

.... Lvm xml data
... vxvm xml data

</managedgroups>

Logical Storage Blocks (LSBs) are a representation of the complicated mapping performed by volume managers between logical volumes and physical volumes. An LSB represents the aggregation of a number of storage blocks (physical or logical) with a particular relationship to create a logical piece of storage (or storage resource) for a consumer of store (or storage, a storage consumer) or to create another logical storage block.

LUNs are organized or sliced into physical storage blocks (PSBs). PSBs are contiguous blocks of physical memory device, e.g., a disk drive or a tape drive. Logical storage blocks are logical mappings of other storage blocks using one of several simple mapping techniques (e.g., direct, striped, mirrored etc.). Logical storage blocks can map PSBs into a single logical grouping. Logical storage blocks can also map other LSBs together but should not combine PSBs and LSBs. Logical volumes (also known as storage consumers) include one or more LSBs.

| Logical Volume configuration | Objects that could exist |
|---|---|
| Simple contiguous volume | 1 Physical Storage Block (PSB) that |
| on a single LUN | points at the LUN |
| | 1 LSB that points at the PSB with |
| | type = “direct” and type |
| | count = 1 |
| | The storage consumer would point |
| | at the LSB. |
| Contiguous volume made up | n PSBs that point at the appropriate |
| of slices of multiple LUNs | LUNs the slices reside upon |
| | 1 LSB that points at the PSBs with |
| | type = “direct” and type |
| | count = n |
| | The storage consumer would point at |
| | the LSB. |
| A logical volume striped | 4 PSBs that point at the appropriate |
| across slices of 4 LUNs | LUNs the slices reside upon. |
| | 1 LSB that points at the PSBs with |
| | type = “stripe” and type |
| | count = 4 |
| | The storage consumer would point at |
| | the LSB. |
| A logical volume mirrored | 4 PSBs that point at the appropriate |
| across slices of 4 LUNs | LUNs the slices reside upon. |
| | 1 LSB that points at the PSBs with |
| | type = “mirror” and type |
| | count = 4 |
| | The storage consumer would point at |
| | the LSB. |
| A logical volume striped | 8 PSBs that point at the appropriate |
| (4) and mirrored (2) across | LUNS the slices reside upon. |
| slices of 8 LUNS (we will | 2 LSBs that each point at 4 PSBs with |
| consider striping as lower | type = “striped” and type |
| level than mirroring in | count = 4 |
| our model of the mapping - | 1 LSB that points at the 2 LSBs with |
| this shouldn't be an issue | type = “mirror” and type |
| as you end up with the same | count = 2 |
| lun usage whichever way you | The storage consumer would point at |
| look at the mapping i.e. | the parent LSB. |
| 6 slices of data and 2 | The storage consumer would point at |
| slices of parity) A logical | multiple parent LSBs which would have |
| volume which has been | the same structure of children i.e. |
| extended after creation. | the same number of LSBs and PSBs with |
| | the same types and type counts. |

Examples of JAVA documents corresponding to the DOs 402, 404, 406, 408 and 410 follow. Interspersed with the example JAVA documents are corresponding examples of templates (used with the tool that generates JAVA methods mentioned in the JAVA documents).

Immediately following is a JAVA document (referred to as class LogicalStoragePool) corresponding to the volume group DO 402 of FIG. 4. Again, the attributes portion 414 of the volume group DO 402 is elaborated upon, e.g., in the following Field Summary section and the Field Detail section. The JAVA methods portion 416 is elaborated upon, e.g., in the Methods Summary section, the Constructor Summary section, the Constructor Detail section and the Methods Detail section.

com.hp.sanmgr.model

Class LogicalStoragePool

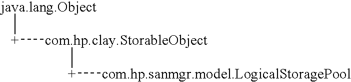

Public Final class LogicalStoragePool Extends StorableObject

Abstraction of a group/pool of storage resources. This can be mapped to a VolumeGroup or some other entity depending on which logical file system package, such as LVM, VxVM, LDM, etc. is being used.

Field Summary

| | |
|---|---|
| static String | DEFAULT |
| | The name of the default logical storage pool for |
| | LUNs not associated with a typical volume group. |
| static int | DIRECT_FILE_SYSTEM |
| protected | hostLogicalUnits |
| StorableMap | The HostLogicalUnits that is associated with |
| | this LogicalStoragePool. |
| static int | LDM |
| static String | LOGICALSTORAGEPOOL_ID_FIELD |
| | Constant representing the name of the |
| | LogicalStoragePool field. |
| static int | LVM |
| protected | name |
| String | Name of the storage pool. |
| static String | NAME_FIELD |
| | Constant representing the name of the name field. |
| protected | sizeHostLogicalUnits |
| double | The total size of all host logical units associated |
| | with this logical storage pool. |
| static String | SIZEHOSTLOGICALUNITS_FIELD |
| | Constant representing the name of the |
| | sizeHostLogicalUnits field. |
| protected | sizeStorageConsumers |
| double | The total size of all storage consumers associated |
| | with this logical storage pool. |
| static String | SIZESTORAGECONSUMERS_FIELD |
| | Constant representing the name of the |
| | sizeStorageConsumers field. |
| protected | storageConsumers |
| StorableMap | The StorageConsumers that is associated with |
| | this LogicalStoragePool. |
| protected | systemDevice |
| SystemDevice | The system device to which this logical storage |
| | pool is associated with. |
| static String | SYSTEMDEVICE_FIELD |
| | Constant representing the name of the systemDevice |
| | field. |
| protected int | totalHostLogicalUnits |
| | The total number of host logical units associated |
| | with this logical storage pool. |
| static String | TOTALHOSTLOGICALUNITS_FIELD |
| | Constant representing the name of the |
| | totalHostLogicalUnits field. |
| protected int | totalStorageConsumers |
| | The total number of storage consumers associated |
| | with this logical storage pool. |
| static String | TOTALSTORAGECONSUMERS_FIELD |
| | Constant representing the name of the |
| | totalStorageConsumers field. |
| protected int | type |
| | The type of this storage consumer. |
| static String | TYPE_FIELD |
| | Constant representing the name of the type field. |
| static int | UNKNOWN |
| | Used as a type designation when the actual type is |
| | unknown. |
| static int | UPM |
| protected | usedHostLogicalUnits |
| double | The total size used by storage consumers on all host |
| | logical units associated with this logical storage pool. |
| static String | USEDHOSTLOGICALUNITS_FIELD |
| | Constant representing the name of the |
| | usedHostLogicalUnits field. |
| protected | usedPercentHostLogicalUnits |
| double | The total percent used space by storage consumers |
| | on host logical units associated with this logical storage |
| | pool. |
| static String | USEDPERCENTHOSTLOGICALUNITS_FIELD |
| | Constant representing the name of the |
| | usedPercentHostLogicalUnits field. |
| static int | VXVM |

Fields inherited from class com.hp.clay.StorableObject

b1Writable, CACHED_OBJECTS,
NON_STORABLE_MASK,
NOT_STORED, PACKAGE_PREFIX,
ROOT_CLASS_NAME,
ROOT_CLASS_PREFIX, STORED_AS_BOOLEAN,
STORED_AS_COLLECTION, STORED_AS_DATE,
STORED_AS_DOUBLE,
STORED_AS_FLOAT, STORED_AS_INTEGER,
STORED_AS_LONG,
STORED_AS_REFERENCE, STORED_AS_STRING,
STORED_AS_TRANSIENT_COLLECTION,
STORED_OBJECTS,
XML_ATTRIBUTES_AS_ATTRIBUTES,
XML_EXPAND_AGGREGATE_REFERENCES,
XML_EXPAND_ATTRIBUTE_REFERENCES,
XML_EXPAND_SINGULAR_REFERENCES,
XML_ID_AS_ENTITIES,
XML_INCLUDE_REFERENCED_OBJECTS,
XML_SUPPRESS_ID_ATTRIBUTES,
XML_SUPPRESS_XREF_ATTRIBUTES,
XML_USE_TYPE_SPECIFIC_ENTITIES

Constructor Summary

| | |
|---|---|
| | LogicalStoragePool ( ) |
| | Default constructor. |
| protected | LogicalStoragePool (Dbid dbid) |
| | Constructor used internally for loading. |
| | LogicalStoragePool (String name, SystemDevice |
| | systemDevice, int type) |
| | Constructs a new infrastructure device with the given |
| | parameters. |

Method Summary

| | |
|---|---|
| void | addHostLogicalUnit (HostLogicalUnit |
| | hostLogicalUnit) |
| | Adds the specified HostLogicalUnit to the |
| | collection of HostLogicalUnit objects for |
| | this LogicalStoragePool. |
| void | addStorageConsumer (StorageConsumer |
| | storageConsumer) |
| | Adds the specified StorageConsumer to the |
| | collection of StorageConsumer objects for |
| | this LogicalStoragePool. |
| void | clearHostLogicalUnits ( ) |
| | Clears the collection of HostLogicalUnit |
| | objects for this LogicalStoragePool. |
| void | clearStorageConsumers ( ) |
| | Clears the collection of StorageConsumer |
| | objects for this LogicalStoragePool. |
| static | getBySystemDevice (SystemDevice |
| StorableList | systemDevice) |
| | Deprecated. Returns the LogicalStoragePool |
| | which has the systemDevice of the |
| | specified value. |
| HostLogicalUnit | getHostLogicalUnit (Dbid id) |
| | Returns the HostLogicalUnit with the |
| | specified ID in the collection of |
| | HostLogicalUnit objects for this |
| | LogicalStoragePool. |
| StorableMap | getHostLogicalUnits ( ) |
| | Returns the collection of HostLogicalUnit |
| | objects for this LogicalStoragePool. |
| StorableIterator | getHostLogicalUnitsIterator ( ) |
| | Returns the collection of HostLogicalUnit |
| | objects for this LogicalStoragePool. |
| StorableIterator | getHostLogicalUnitsIterator (String |
| | sortFieldName, boolean isAscending) |
| | Returns the collection of HostLogicalUnit |
| | objects for this LogicalStoragePool. |
| static | getLogicalStoragePoolListBySystemDevice |
| StorableList | (SystemDevice systemDevice) |
| | Returns a list, sorted in no particular |
| | order, of LogicalStoragePool objects |
| | which have the systemDevice of the |
| | specified value. |
| String | getName ( ) |
| | Returns the value of the name property. |
| StorableList | getPhysicalStorageBlocks ( ) |
| | Gets all of the physical storage blocks |
| | associated with this logical storage pool. |
| double | getSizeHostLogicalUnits ( ) |
| | Returns the value of the |
| | sizeHostLogicalUnits property. |
| double | getSizePhysicalStorageBlocks ( ) |
| | Gets the total size of all physical |
| | storage blocks associated with this |
| | logical storage pool. |
| double | getSizeStorageConsumers ( ) |
| | Returns the value of the |
| | sizeStorageConsumers property. |
| StorageConsumer | getStorageConsumer (Dbid id) |
| | Returns the StorageConsumer with the |
| | specified ID in the collection of |
| | StorageConsumer objects for this |
| | LogicalStoragePool. |
| StorableMap | getStorageConsumers ( ) |
| | Returns the collection of StorageConsumer |
| | objects for this LogicalStoragePool. |
| StorableIterator | getStorageConsumersIterator ( ) |
| | Returns the collection of StorageConsumer |
| | objects for this LogicalStoragePool. |
| StorableIterator | getStorageConsumersIterator (String |
| | sortFieldName, boolean isAscending) |
| | Returns the collection of StorageConsumer |
| | objects for this LogicalStoragePool. |
| SystemDevice | getSystemDevice ( ) |
| | Returns the value of the systemDevice |
| | property. |
| int | getTotalHostLogicalUnits ( ) |
| | Returns the value of the |
| | totalHostLogicalUnits property. |
| int | getTotalStorageConsumers ( ) |
| | Returns the value of the |
| | totalStorageConsumers property. |
| int | getType ( ) |
| | Returns the value of the type property. |
| double | getUsedHostLogicalUnits ( ) |
| | Returns the value of the |
| | usedHostLogicalUnits property. |
| double | getUsedPercentHostLogicalUnits ( ) |
| | Returns the value of the |
| | usedPercentHostLogicalUnits |
| | property. |
| StorableMap | loadHostLogicalUnits ( ) |
| | Loads and returns the collection of |
| | HostLogicalUnit objects for this |
| | LogicalStoragePool. |
| StorableMap | loadStorageConsumers ( ) |
| | Loads and returns the collection of |
| | StorageConsumer objects for this |
| | LogicalStoragePool. |
| protected | prepareDelete (ConnectionContext |
| CachedPreparedStatement | context) |
| | This method must be provided in order |
| | for the LogicalStoragePool object to |
| | become storable, i.e. |
| protected | prepareInsert (ConnectionContext |
| CachedPreparedStatement | context) |
| | This method must be provided in order |
| | for the LogicalStoragePool object to |
| | become storable, i.e. |
| protected | prepareSelect (ConnectionContext |
| CachedPreparedStatement | context) |
| | This method must be provided in order |
| | for the LoogicalStoragePool object to |
| | become storable, i.e. |
| void | removeHostLogicalUnit (HostLogicalUnit |
| | hostLogicalUnit) |
| | Removes the specified HostLogicalUnit |
| | from the collection of HostLogicalUnit |
| | objects for this LogicalStoragePool. |
| void | removeStorageConsumer (StorageConsumer |
| | storageConsumer) |
| | Removes the specified StorageConsumer |
| | from the collection of StorageConsumer |
| | objects for this |
| | LogicalStoragePool. |
| void | setName (String name) |
| | Sets the Name property to the specified |
| | value. |
| void | setSizeHostLogicalUnits (double |
| | sizeHostLogicalUnits) |
| | Sets the SizeHostLogicalUnits property to |
| | the specified value. |
| void | setSizeStorageConsumers (double |
| | sizeStorageConsumers) |
| | Sets the SizeStorageConsumers property to |
| | the specified value. |
| void | setSystemDevice (SystemDevice |
| | systemDevice) |
| | Sets the SystemDevice property to the |
| | specified value. |
| void | setTotalHostLogicalUnits (int |
| | totalHostLogicalUnits) |
| | Sets the TotalHostLogicalUnits property |
| | to the specified value. |
| void | setTotalStorageConsumers (int |
| | totalStorageConsumers) |
| | Sets the TotalStorageConsumers property |
| | to the specified value. |
| void | setType (int type) |
| | Sets the Type property to the specified |
| | value. |
| void | setUsedHostLogicalUnits (double |
| | usedHostLogicalUnits) |
| | Sets the UsedHostLogicalUnits property |
| | to the specified value. |
| void | setUsedPercentHostLogicalUnits (double |
| | usedPercentHostLogicalUnits) |
| | Sets the UsedPercentHostLogicalUnits |
| | property to the specified value. |
| String | toDebugString ( ) |
| | Returns a string image of the the |
| | specified LogicalStoragePool. |
| String | toDebugString (String indent) |
| | Returns the debug string image of the |
| | object indented using the specified |
| | indent string. |
| String | toDebugString (String indent, Vector |
| | callTree) |
| | Returns an indented string image of |
| | the the specified LogicalStoragePool. |
| String | toString ( ) |
| | Returns the string image of this object. |

Methods inherited from class com.hp.clay.StorableObject

http://srmlab.rose.hp.com/java-api/sanmgr/com/hp/clay/
StorableObject.html -
<clinit>( ), addAttribute, addDependentObjects,
attributesLoaded, cacheOnly, decode, delete, delete,
deleteDependentObjects, deleteObject,
deleteThisObjectFromCacheUnderPenaltyOfDeath,
enableZombieMonitor, encode, equals, error, error, error,
error, executeQuery, flushAttributes,
getAbstractModelClasses, getAttribute, getAttributeCount,
getAttributes, getAttributesLike, getByAttribute,
getByAttribute, getByAttribute, getClassLoader,
getConcreteModelClasses, getCount, getCount, getCount,
getDbid, getDirtyFields, getFindOrCreateLock,
getFromCache, getFromCache, getFromCache, getLock,
getLock, getModelClasses, getObjectClass,
getReferringObjectsIterator, getRelationshipIterator,
getResourceBundle, getSum, getSum, getSum, getSum,
getSum, getTransientAttributes, hashCode, isDirty,
isFieldDirty, isLoaded, isModelClass, isZombie, load.
load, load, load, load, loadAll, loadAll, loadAll,
loadAll, loadAllAttributes, loadAllIterator,
loadAllIterator, loadAttributes, loadModelClassCatalogue,
loadReferringObjects, loadRelationship, putIntoCache,
releaseFindOrCreateLock, releaseLock,
removeAllAttributes, removeAllTransientAttributes,
removeAttribute, removeAttribute, removeFromCache,
setAccessible, setAttributesDirty, setClassLoader,
setClean, setDirty, setFieldDirty, setFieldDirty,
setResourceBundle, settingDbidUnderPenaltyOfDeath,
setWasCreated, store, storeAttributes,
storeClassSpecifics, storeDirtyObjects, toString,
wasCreated, writeXML, writeXML, writeXML, writeXML

Methods inherited from class java.lang.Object

clone, finalize, getClass, notify, notifyAll, wait, wait,
wait

Field Detail

name

protected String name

Name of the storage pool.

DEFAULT

public static final String DEFAULT

The name of the default logical storage pool for LUNs not associated with a typical volume group. This is used for providing the association of LUN to volume for volumes that directly map to a LUN.

UNKNOWN

public static final int UNKNOWN

Used as a type designation when the actual type is unknown.

DIRECT_FILE_SYSTEM

public static final int DIRECT_FILE_SYSTEM

LVM public static final int LVM

VXVM public static final int VXVM

LDM public static final int LDM

UPM public static final int UPM

type protected int type The type of this storage consumer.

systemDevice protected SystemDevice systemDevice The system device to which this logical storage pool is associated with.

storageConsumers protected StorableMap storageConsumers The StorageConsumers that is associated with this LogicalStoragePool.

hostLogicalUnits protected StorableMap hostLogicalUnits The HostLogicalUnits that is associated with this LogicalStoragePool.

totalHostLogicalUnits protected int totalHostLogicalUnits The total number of host logical units associated with this logical storage pool.

totalStorageConsumers protected int totalStorageConsumers The total number of storage consumers associated with this logical storage pool.

sizeStorageConsumers protected double sizeStorageConsumers The total size of all storage consumers associated with this logical storage pool.

sizeHostLogicalUnits protected double sizeHostLogicalUnits The total size of all host logical units associated with this logical storage pool.

usedHostLogicalUnits protected double usedHostLogicalUnits The total size used by storage consumers on all host logical units associated with this logical storage pool.

usedPercentHostLogicalUnits protected double usedPercentHostLogicalUnits The total percent used space by storage consumers on host logical units associated with this logical storage pool.

LOGICALSTORAGEPOOL_ID_FIELD public static final String LOGICALSTORAGEPOOL_ID_FIELD Constant representing the name of the LogicalStoragePool field.

NAME_FIELD public static final String NAME_FIELD Constant representing the name of the name field.

TYPE_FIELD public static final String TYPE_FIELD Constant representing the name of the type field.

SYSTEMDEVICE_FIELD public static final String SYSTEMDEVICE_FIELD Constant representing the name of the systemDevice field.

TOTALHOSTLOGICALUNITS_FIELD public static final String TOTALHOSTLOGICALUNITS_FIELD Constant representing the name of the totalHostLogical Units field.

TOTALSTORAGECONSUMERS_FIELD public static final String TOTALSTORAGECONSUMERS_FIELD Constant representing the name of the totalStorageConsumers field.

SIZESTORAGECONSUMERS_FIELD public static final String SIZESTORAGECONSUMERS_FIELD Constant representing the name of the sizeStorageConsumers field.

SIZEHOSTLOGICALUNITS_FIELD public static final String SIZEHOSTLOGICALUNITS_FIELD Constant representing the name of the sizeHostLogicalUnits field.

USEDHOSTLOGICALUNITS_FIELD public static final String USEDHOSTLOGICALUNITS_FIELD Constant representing the name of the usedHostLogicalUnits field.

USEDPERCENTHOSTLOGICALUNITS_FIELD public static final String USEDPERCENTHOSTLOGICALUNITS_FIELD

Constant representing the name of the usedPercentHostLogical Units field.

LogicalStoragePool public LogicalStoragePool( ) Default constructor.

LogicalStoragePool protected LogicalStoragePool(Dbid dbid) Constructor used internally for loading.

LogicalStoragePool public LogicalStoragePool (String name, SystemDevice systemDevice, int type) Constructs a new infrastructure device with the given parameters. Method Detail

toString public String toString( ) Returns the string image of this object.

Overrides:

toString in class StorableObject

getPhysicalStorageBlocks public StorableList getPhysicalStorageBlocks( ) Gets all of the physical storage blocks associated with this logical storage pool.

Returns:

A list of PhysicalStorageBlock associated with this logical storage pool.

getSizePhysicalStorageBlocks public double getSizePhysicalStorageBlocks( ) Gets the total size of all physical storage blocks associated with this logical storage pool.

prepareInsert protected CachedPreparedStatement prepareInsert(ConnectionContext context) throws SQLException This method must be provided in order for the LogicalStoragePool object to become storable, i.e. so it can be added to the database.

Overrides:

prepareInsert in class StorableObject

prepareDelete protected CachedPreparedStatement prepareDelete(ConnectionContext context) throws SQLException This method must be provided in order for the LogicalStoragePool object to become storable, i.e. so it can be deleted from the database.

Overrides:

prepareDelete in class StorableObject

prepareSelect protected CachedPreparedStatement prepareSelect(ConnectionContext context) throws SQLException This method must be provided in order for the LogicalStoragePool object to become storable, i.e. so it can be retrieved from the database.

Overrides:

prepareSelect in class StorableObject

getName public String getName( ) Returns the value of the name property.

setName public void setName(String name) Sets the Name property to the specified value.

getType public int getType( ) Returns the value of the type property.

setType public void setType(int type) Sets the Type property to the specified value.

getSystemDevice public SystemDevice getSystemDevice( ) Returns the value of the systemDevice property.

setSystemDevice public void setSystemDevice(SystemDevice systemDevice) Sets the SystemDevice property to the specified value. Note that this should not be used as a means to add this object to the list of children of the SystemDevice parent. An appropriate call to addLogicalStoragePool, if available, should be made on the systemDevice parent object instead.

getTotalHostLogicalUnits public int getTotalHostLogicalUnits( ) Returns the value of the totalHostLogicalUnits property.

setTotalHostLogicalUnits public void setTotalHostLogicalUnits(int totalHostLogicalUnits) Sets the TotalHostLogicalUnits property to the specified value.

getTotalStorageConsumers public int getTotalStorageConsumers( ) Returns the value of the totalStorageConsumers property.

setTotalStorageConsumers public void setTotalStorageConsumers(int totalStorageConsumers) Sets the TotalStorageConsumers property to the specified value.

getSizeStorageConsumers public double getSizeStorageConsumers( ) Returns the value of the sizeStorageConsumers property.

setSizeStorageConsumers public void setSizeStorageConsumers (double sizeStorageConsumers) Sets the SizeStorageConsumers property to the specified value.

getSizeHostLogicalUnits public double getSizeHostLogicalUnits( ) Returns the value of the sizeHostLogicalUnits property.

setSizeHostLogicalUnits public void setSizeHostLogicalUnits (double sizeHostLogicalUnits) Sets the SizeHostLogicalUnits property to the specified value.

getUsedHostLogicalUnits public double getUsedHostLogicalUnits( ) Returns the value of the usedHostLogicalUnits property.

setUsedHostLogicalUnits public void setUsedHostLogicalUnits (double usedHostLogicalUnits) Sets the UsedHostLogicalUnits property to the specified value.

getUsedPercentHostLogicalUnits public double getUsedPercentHostLogicalUnits( ) Returns the value of the usedPercentHostLogicalUnits property. setUsedPercentHostLogicalUnits public void setUsedPercentHostLogicalUnits(double usedPercentHostLogicalUnits) Sets the UsedPercentHostLogicalUnits property to the specified value.

toDebugString public String toDebugString( ) Returns a string image of the the specified LogicalStoragePool.

Overrides:

toDebugString in class StorableObject

toDebugString public String toDebugString(String indent) Description copied from class: StorableObject Returns the debug string image of the object indented using the specified indent string.

Overrides:

toDebugString in class StorableObject

toDebugString public String toDebugString(String indent, Vector callTree) Returns an indented string image of the the specified LogicalStoragePool.

Overrides:

toDebugString in class StorableObject

loadStorageConsumers public StorableMap loadStorageConsumers( ) Loads and returns the collection of StorageConsumer objects for this LogicalStoragePool.

getStorageConsumers public StorableMap getStorageConsumers( ) Returns the collection of StorageConsumer objects for this LogicalStoragePool.

getStorageConsumersIterator public StorableIterator getStorageConsumersIterator( ) Returns the collection of StorageConsumer objects for this LogicalStoragePool. getStorageConsumersIterator public StorableIterator getStorageConsumersIterator(String sortFieldName, boolean isAscending) Returns the collection of StorageConsumer objects for this LogicalStoragePool.

clearStorageConsumers public void clearStorageConsumers( ) Clears the collection of StorageConsumer objects for this LogicalStoragePool.

Provided to allow applications to explicitely drop references to child StorageConsumer objects. Please note that subsequent invocations of get/load/add/remove methods will reload the collection.

addStorageConsumer public void addStorageConsumer(StorageConsumer storageConsumer) Adds the specified StorageConsumer to the collection of StorageConsumer objects for this LogicalStoragePool.

removeStorageConsumer public void removeStorageConsumer(StorageConsumer storageConsumer) Removes the specified StorageConsumer from the collection of StorageConsumer objects for this LogicalStoragePool.

getStorageConsumer public StorageConsumer getStorageConsumer(Dbid id) Returns the StorageConsumer with the specified ID in the collection of StorageConsumer objects for this LogicalStoragePool.

loadHostLogicalUnits public StorableMap loadHostLogicalUnits( ) Loads and returns the collection of HostLogicalUnit objects for this LogicalStoragePool.

getHostLogicalUnits public StorableMap getHostLogicalUnits( ) Returns the collection of HostLogicalUnit objects for this LogicalStoragePool.

getHostLogicalUnitsIterator public StorableIterator getHostLogicalUnitsIterator( ) Returns the collection of HostLogicalUnit objects for this LogicalStoragePool.

getHostLogicalUnitsIterator public StorableIterator getHostLogicalUnitsIterator(String sortFieldName, boolean isAscending) Returns the collection of HostLogicalUnit objects for this LogicalStoragePool.

clearHostLogicalUnits public void clearHostLogicalUnits( ) Clears the collection of HostLogicalUnit objects for this LogicalStoragePool.

Provided to allow applications to explicitely drop references to child HostLogicalUnit objects. Please note that subsequent invocations of get/load/add/remove methods will reload the collection.

addHostLogicalUnit public void addHostLogicalUnit(HostLogicalUnit hostLogicalUnit) Adds the specified HostLogicalUnit to the collection of HostLogicalUnit objects for this LogicalStoragePool.

removeHostLogicalUnit public void removeHostLogicalUnit(HostLogicalUnit hostLogicalUnit) Removes the specified HostLogicalUnit from the collection of HostLogicalUnit objects for this LogicalStoragePool.

getHostLogicalUnit public HostLogicalUnit getHostLogicalUnit(Dbid id) Returns the HostLogicalUnit with the specified ID in the collection of HostLogicalUnit objects for this LogicalStoragePool.

getLogicalStoragePoolListBySystemDevice public static StorableList getLogicalStoragePoolListBySystemDevice(SystemDevice systemDevice) Returns a list, sorted in no particular order, of LogicalStoragePool objects which have the systemDevice of the specified value.

getBySystemDevice public static StorableList getBySystemDevice(SystemDevice systemDevice) Deprecated. Returns the LogicalStoragePool which has the systemDevice of the specified value.

Immediately following is a sample template related to the volume group DO 402 of FIG. 4, and corresponding to the immediately preceding JAVA document (class LogicalStoragePool).

//------------------------------------------------------------------------------
// Copyright 1999-2002 Hewlett-Packard Co., All Rights Reserved.
//------------------------------------------------------------------------------
/**
* Abstraction of a group/pool of storage resources. This can be
mapped to a
* VolumeGroup or some other entity depending on which logical file
system
* package, such as LVM, VxVM, LDM, etc. is being used.
*/
public final class LogicalStoragePool extends StorableObject {

/** Name of the storage pool. */
protected String name;
/**
* The name of the default logical storage pool for LUNs not

associated

* with a typical volume group. This is used for providing the

association

* of LUN to volume for volumes that directly map to a LUN.
*/
public static final String DEFAULT = “dEfAuLtVoLuMeGrOuP”;
/** Used as a type designation when the actual type is unknown.

*/

public static final int UNKNOWN = 0;
// Some well-known enumerations of storage pool types. */
public static final int DIRECT_FILE_SYSTEM = 1;
public static final int LVM = 2;
public static final int VXVM = 3;
public static final int LDM = 4;
public static final int UPM = 5;
/** The type of this storage consumer. */
protected int type;
/**
* The system device to which this logical storage pool is associated
* with.
*/
// ::getBy unsorted systemDevice
protected SystemDevice systemDevice;
/**
* The {@link StorageConsumer StorageConsumers} that is

associated

* with this LogicalStoragePool.
*/
// ::relate LogicalStoragePool StorageConsumers StorageConsumer

logicalStoragePools

protected StorableMap StorageConsumers;
/**
* The {@link HostLogicalUnit HostLogicalUnits} that is associated
* with this LogicalStoragePool.
*/
// ::relate LogicalStoragePool hostLogicalUnits HostLogicalUnit

logicalStoragePools

protected StorableMap hostLogicalUnits;
/**
* The total number of host logical units associated with this logical
* storage pool.
*/
protected int totalHostLogicalUnits;
/**
* The total number of storage consumers associated with this

logical

* storage pool.
*/
protected int totalStorageConsumers;
/**
* The total size of all storage consumers associated with this logical
* storage pool.
*/
protected double sizeStorageConsumers;
/**
* The total size of all host logical units associated with this
* logical storage pool.
*/
protected double sizeHostLogicalUnits;
/**
* The total size used by storage consumers on all host logical units
* associated with this logical storage pool.
*/
protected double usedHostLogicalUnits;
/**
* The total percent used space by storage consumers on host

logical

* units associated with this logical storage pool.
*/
protected double usedPercentHostLogicalUnits;
/** Constructs a new infrastructure device with thegiven

parameters. */

public LogicalStoragePool (String name, SystemDevice

systemDevice,

int type) {

super ( );
this, name = name;
this.systemDevice = systemDevice;
this.type = type;
this.totalHostLogicalUnits = 0;
this.totalStorageConsumers = 0;
this.sizeStorageConsumers = 0;
this.sizeHostLogicalUnits = 0;
this.usedHostLogicalUnits = 0;
this.usedPercentHostLogicalUnits = 0;
/* ::post-compile
if (systemDevice != null) {

systemDevice.addLogicalStoragePool(this);

}
::post-compile */

} // LogicalStoragePool
/** Returns the string image of this object. */
/* ::post-compile
public String toString ( ) {

return “storage pool” + getName( );

} // toString
::post-compile */
/**
* Gets all of the physical storage blocks associated with this
* logical storage pool.
*
* @return A list of {@link PhysicalStorageBlock

PhysicalStorageBlock}

* associated with this logical storage pool.
*/
/* ::post-compile
public StorableList getPhysicalStorageBlocks( ) {

StorableList physicalBlocks = new StorableList( );
Iterator hostLuns = loadHostLogicalUnits( ).iterator( );
while(hostLuns.hasNext( )) {

HostLogicalUnit hostLun =
(HostLogicalUnit)hostLuns.next( );

physicalBlocks.importCollection(hostLun.getPhysicalStorageBlocks( ));

}
return physicalBlocks;

}
::post-compile */
/**
* Gets the total size of all physical storage blocks associated
* with this logical storage pool.
*/
/* ::post-compile
public doublegetSizePhysicalStorageBlocks( ) {

double size = 0;
Iterator iteration =
getPhysicalStorageBlocks( ).iterator( );
while(iteration.hasNext( )) {

PhysicalStorageBlock physicalBlock =

(PhysicalStorageBlock)iteration.next( );

size += physicalBlock.getSize( );

}
return size;

}
::post-compile */

Immediately following is a JAVA document (referred to as class StorageConsumer) corresponding to the logical volume DO 404 of FIG. 4.

com.hp.sanmgr.model

Class StorageConsumer

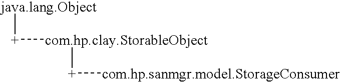

public final class StorageConsumer extends StorableObject

Abstraction of a software layer (file-system) that utilizes the storage resources that were allocated to a system device, i.e a Host or a NASDevice. Besides of file systems, this can also represent swap-space, dump-space and any raw storage spaces allocated for use by database software, etc.

Field Summary

| | |
|---|---|
| protected | availableCapacity |
| double | The available capacity for this storage |
| | consumer. |
| static | AVAILABLECAPACITY_FIELD |
| String | Constant representing the name of the |
| | availableCapacity field. |
| protected | consumptionBlocks |
| StorableMap | List of all consumption blcoks within this |
| | partition. |
| protectedString | deviceFile |
| | Device file on which this storage consumer |
| | draws for storage. Note that this is essentially |
| | redundant with the storageBlock, but provides a |
| | loose link to the underlying storage block. |
| static | DEVICEFILE_FIELD |
| String | Constant representing the name of the deviceFile |
| | field. |
| protected | hasFileSystem |
| boolean | If this logical volume has a file system. |
| static | HASFILESYSTEM_FIELD |
| String | Constant representing the name of the |
| | hasFileSystem field. |
| protected | logicalStorageBlocks |
| StorableMap | Logical storage block from which this storage |
| | consumer draws storage resources. |
| protected | logicalStoragePools |
| StorableMap | The LogicalStoragePools that are associated |
| | with this StorageConsumer. |
| protected | managedDirectories |
| StorableMap | List of all managed directories within this |
| | partition. |
| protected | mountPoint |
| String | Host-specific mount point, /usr, /home, |
| | /tmp, for example. |
| static | MOUNTPOINT_FIELD |
| String | Constant representing the name of the |
| | mountPoint field. |
| static | STORAGECONSUMER_ID_FIELD |
| String | Constant representing the name of the |
| | StorageConsumer field. |
| static | SWAP |
| String | Value used as a type of swap space. |
| protected | systemDevice |
| SystemDevice | System device, i.e Host or NASDevice, to |
| | which this storage consumer belongs. |
| static | SYSTEMDEVICE_FIELD |
| String | Constant representing the name of the |
| | systemDevice field. |
| protected | totalCapacity |
| double | The total capacity for this storage consumer. |
| static | TOTALCAPACITY_FIELD |
| String | Constant representing the name of the |
| | totalCapacity field. |
| protected | totalSize |
| double | The total size of the logical volume. |
| static | TOTALSIZE_FIELD |
| String | Constant representing the name of the |
| | totalSize field. |
| protected | type |
| String | The type of this storage consumer as |
| | obtained from the native platform. |
| static | TYPE_FIELD |
| String | Constant representing the name of the |
| | type field. |
| static | UNKNOWN |
| String | Value used as a type of an unknown storage |
| | consumer/volume. |
| protected | usedCapacity |
| double | The used capacity for this storage consumer. |
| static | USEDCAPACITY_FIELD |
| String | Constant representing the name of the |
| | usedCapacity field. |
| protected | usedPercent |
| double | The percentage of used capacity. |
| static | USEDPERCENT_FIELD |
| String | Constant representing the name of the |
| | usedPercent field. |

Fields inherited from class com.hp.clay.StorableObject

b1Writable, CACHED_OBJECTS,
NON_STORABLE_MASK,
NOT_STORED, PACKAGE_PREFIX,
ROOT_CLASS_NAME,
ROOT_CLASS_PREFIX, STORED_AS_BOOLEAN,
STORED_AS_COLLECTION, STORED_AS_DATE,
STORED_AS_DOUBLE,
STORED_AS_FLOAT, STORED_AS_INTEGER,
STORED_AS_LONG,
STORED_AS_REFERENCE, STORED_AS_STRING,
STORED_AS_TRANSIENT_COLLECTION,
STORED_OBJECTS,
XML_ATTRIBUTES_AS_ATTRIBUTES,
XML_EXPAND__AGGREGATE_REFERENCES,
XML_EXPAND_ATTRIBUTE_REFERENCES,
XML_EXPAND_SINGULAR_REFERENCES,
XML_ID_AS_ENTITIES,
XML_INCLUDE_REFERENCED_OBJECTS,
XML_SUPPRESS_ID_ATTRIBUTES,
XML_SUPPRESS_XREF_ATTRIBUTES,
XML_USE_TYPE_SPECIFIC_ENTITIES

Constructor Summary

| | |
|---|---|
| | StorageConsumer( ) |
| | Default constructor. |
| protected | StorageConsumer(Dbid dbid) |
| | Constructor used internally for loading. |
| | StorageConsumer(String mountPoint, String |
| | deviceFile, String type, double totalCapacity, |
| | double usedCapacity, double availableCapacity) |
| | Constructs a new storage consumer as a local |
| | file system on the that is not associated with |
| | a system device. |
| | StorageConsumer(SystemDevice systemDevice, |
| | String type, String mountPoint, String |
| | deviceFile, double totalCapacity, double |
| | usedCapacity, double availableCapacity) |
| | Constructs a new storage consumer as a local |
| | file system on the specified system device. |
| | StorageConsumer(SystemDevice systemDevice, |
| | String type, String mountPoint, String |
| | deviceFile, double totalSize, double |
| | totalCapacity, double usedCapacity, double |
| | availableCapacity) |
| | Constructs a new storage consumer as a local |
| | file system on the specified system device. |

Method Summary

| | |
|---|---|
| void | addConsumptionBlock(ConsumptionBlock |
| | consumptionBlock) |
| | Adds the specified ConsumptionBlock to |
| | the collection of ConsumptionBlock objects |
| | for this StorageConsumer. |
| void | addLogicalStorageBlock(LogicalStorageBlock |
| | logicalStorageBlock) |
| | Adds the specified LogicalStorageBlock to |
| | the collection of LogicalStorageBlock objects |
| | for this StorageConsumer. |
| void | addLogicalStoragePool(LogicalStoragePool |
| | logicalStoragePool) |
| | Adds the specified LogicalStoragePool to |
| | the collection of LogicalStoragePool objects for |
| | this StorageConsumer. |
| void | addManagedDirectory(ManagedDirectory |
| | managedDirectory) |
| | Adds the specified ManagedDirectory to the |
| | collection of ManagedDirectory objects for this |
| | StorageConsumer. |
| void | clearConsumptionBlocks( ) |
| | Clears the collection of ConsumptionBlock |
| | objects for this StorageConsumer. |
| void | clearLogicalStorageBlocks( ) |
| | Clears the collection of |
| | LogicalStorageBlock objects for this |
| | StorageConsumer. |
| void | clearLogicalStoragePools( ) |
| | Clears the collection of LogicalStoragePool |
| | objects for this StorageConsumer. |
| void | clearManagedDirectories( ) |
| | Clears the collection of ManagedDirectory |
| | objects for this StorageConsumer. |
| double | getAvailableCapacity( ) |
| | Returns the value of the availableCapacity |
| | property. |
| double | getAvailablePercent( ) |
| | Returns the percentage of available |
| | capacity. |
| static | getBySystemDevice(SystemDevice |
| StorableList | systemDevice) |
| | Deprecated. Returns the StorageConsumer |
| | which has the systemDevice of the |
| | specified value. |
| Consumption- | getConsumptionBlock(Dbid id) |
| Block | Returns the ConsumptionBlock with the |
| | specified ID in the collection of |
| | ConsumptionBlock objects for this |
| | StorageConsumer. |
| StorableMap | getConsumptionBlocks( ) |
| | Returns the collection of |
| | ConsumptionBlock objects for this |
| | StorageConsumer. |
| Storable- | getConsumptionBlocksIterator( ) |
| Iterator | Returns the collection of |
| | ConsumptionBlock objects for this |
| | StorageConsumer. |
| Storable- | getConsumptionBlocksIterator(String |
| Iterator | sortFieldName, boolean isAscending) |
| | Returns the collection of |
| | ConsumptionBlock objects for this |
| | StorageConsumer. |
| String | getDeviceFile( ) |
| | Returns the value of the deviceFile |
| | property. |
| boolean | getHasFileSystem( ) |
| | Returns the value of the hasFileSystem |
| | property. |
| Logical- | getLogicalStorageBlock(Dbid id) |
| Storage- | Returns the LogicalStorageBlock with the |
| Block | specified ID in the collection of |
| | LogicalStorageBlock objects for this |
| | StorageConsumer. |
| StorableMap | getLogicalStorageBlocks( ) |
| | Returns the collection of |
| | LogicalStorageBlock objects for this |
| | StorageConsumer. |
| Storable- | getLogicalStorageBlocksIterator( ) |
| Iterator | Returns the collection of |
| | LogicalStorageBlock objects for this |
| | StorageConsumer. |
| Storable- | getLogicalStorageBlocksIterator(String |
| Iterator | sortFieldName, boolean isAscending) |
| | Returns the collection of |
| | LogicalStorageBlock objects for this |
| | StorageConsumer. |
| Logical- | getLogicalStoragePool(Dbid id) |
| StoragePool | Returns the LogicalStoragePool with the |
| | specified ID in the collection of |
| | LogicalStoragePool objects for this |
| | StorageConsumer. |
| StorableMap | getLogicalStoragePools( ) |
| | Returns the collection of |
| | LogicalStoragePool objects for this |
| | StorageConsumer. |
| Storable- | getLogicalStoragePoolsIterator( ) |
| Iterator | Returns the collection of |
| | LogicalStoragePool objects for this |
| | StorageConsumer. |
| Storable- | getLogicalStoragePoolsIterator(String |
| Iterator | sortFieldName, boolean isAscending) |
| | Returns the collection of |
| | LogicalStoragePool objects for this |
| | StorageConsumer. |
| StorableMap | getManagedDirectories( ) |
| | Returns the collection of ManagedDirectory |
| | objects for this StorageConsumer. |
| Storable- | getManagedDirectoriesIterator( ) |
| Iterator | Returns the collection of ManagedDirectory |
| | objects for this StorageConsumer. |
| Storable- | getManagedDirectoriesIterator(String |
| Iterator | sortFieldName, boolean isAscending) |
| | Returns the collection of ManagedDirectory |
| | objects for this StorageConsumer. |
| Managed- | getManagedDirectory(Dbid id) |
| Directory | Returns the ManagedDirectory with the |
| | specified ID in the collection of ManagedDirectory |
| | objects for this StorageConsumer. |
| String | getMountPoint( ) |
| | Returns the value of the mountPoint |
| | property. |
| StorableMap | getPhysicalStorageBlocks( ) |
| | Retrieves all of the PhysicalStorageBlocks |
| | associated with a particular StorageConsumer. |
| static | getStorageConsumerListBySystemDevice |
| Storable- | (SystemDevice systemDevice) |
| List | Returns a list, sorted in no particular order, |
| | of StorageConsumer objects which have the |
| | systemDevice of the specified value. |
| System- | getSystemDevice( ) |
| Device | Returns the value of the systemDevice |
| | property. |
| double | getTotalCapacity( ) |
| | Returns the value of the totalCapacity |
| | property. |
| double | getTotalSize( ) |
| | Returns the value of the totalSize property. |
| String | getType( ) |
| | Returns the value of the type property. |
| double | getUsedCapacity( ) |
| | Returns the value of the usedCapacity |
| | property. |
| double | getUsedPercent( ) |
| | Returns the value of the usedPercent |
| | property. |
| StorableMap | loadConsumptionBlocks( ) |
| | Loads and returns the collection of |
| | ConsumptionBlock objects for this |
| | StorageConsumer. |
| StorableMap | loadLogicalStorageBlocks( ) |
| | Loads and returns the collection of |
| | LogicalStorageBlock objects for this |
| | StorageConsumer. |
| StorableMap | loadLogicalStoragePools( ) |
| | Loads and returns the collection of |
| | LogicalStoragePool objects for this |
| | StorageConsumer. |
| StorableMap | loadManagedDirectories( ) |
| | Loads and returns the collection of |
| | ManagedDirectory objects for this |
| | StorageConsumer. |
| protected | prepareDelete(ConnectionContext |
| Cached- | context) |
| Prepared- | This method must be provided in order for |
| Statement | the StorageConsumer object to become storable, |
| | i.e. |
| protected | prepareInsert(ConnectionContext |
| Cached- | context) |
| Prepared- | This method must be provided in order for |
| Statement | the StorageConsumer object to become storable, |
| | i.e. |
| protected | prepareSelect(ConnectionContext |
| Cached- | context) |
| Prepared- | This method must be provided in order for |
| Statement | the StorageConsumer object to become storable, |
| | i.e. |
| void | removeConsumptionBlock(ConsumptionBlock |
| | consumptionBlock) |
| | Removes the specified ConsumptionBlock |
| | from the collection of ConsumptionBlock objects |
| | for this StorageConsumer. |
| void | removeLogicalStorageBlock(LogicalStorageBlock |
| | logicalStorageBlock) |
| | Removes the specified |
| | LogicalStorageBlock from the collection of |
| | LogicalStorageBlock objects for this |
| | StorageConsumer. |
| void | removeLogicalStoragePool(LogicalStoragePool |
| | logicalStoragePool) |
| | Removes the specified LogicalStoragePool |
| | from the collection of LogicalStoragePool objects |
| | for this StorageConsumer. |
| void | removeManagedDirectory(ManagedDirectory |
| | managedDirectory) |
| | Removes the specified ManagedDirectory |
| | from the collection of ManagedDirectory objects |
| | for this StorageConsumer. |
| void | setAvailableCapacity(double |
| | availableCapacity) |
| | Sets the AvailableCapacity property to the |
| | specified value. |
| void | setDeviceFile(String deviceFile) |
| | Sets the DeviceFile property to the |
| | specified value. |
| void | setHasFileSystem(boolean |
| | hasFileSystem) |
| | Sets the HasFileSystem property to the |
| | specified value. |
| void | setMountPoint(String mountPoint) |
| | Sets the MountPoint property to the |
| | specified value. |
| void | setSystemDevice(SystemDevice |
| | systemDevice) |
| | Sets the SystemDevice property to the |
| | specified value. |
| void | setTotalCapacity(double |
| | totalCapacity) |
| | Sets the TotalCapacity property to the |
| | specified value. |
| void | setTotalSize(double totalSize) |
| | Sets the TotalSize property to the specified |
| | value. |
| void | setType(String type) |
| | Sets the Type property to the specified |
| | value. |
| void | setUsedCapacity(double |
| | usedCapacity) |
| | Sets the UsedCapacity property to the |
| | specified value. |
| void | setUsedPercent(double usedPercent) |
| | Sets the UsedPercent property to the |
| | specified value. |
| String | toDebugString( ) |
| | Returns a string image of the the specified |
| | StorageConsumer. |
| String | toDebugString(String indent) |
| | Returns the debug string image of the object |
| | indented using the specified indent string. |
| String | toDebugString(String indent, |
| | Vector callTree) |
| | Returns an indented string image of the the |
| | specified StorageConsumer. |
| String | toString( ) |
| | Returns the string image of this object. |

Methods inherited from class com.hp.clay.StprableObject

http://srmlab.rose.hp.com/java-api/sanmgr/com/hp/clay/
StorableObject.html -
<clinit>( ), addAttribute, addDependentObjects,
attributesLoaded, cacheOnly, decode, delete, delete,
deleteDependentObjects, deleteObject,
deleteThisObjectFromCacheUnderPenaltyOfDeath,
enableZombieMonitor, encode, equals, error, error, error,
error, executeQuery, flushAttributes,
getAbstractModelClasses, getAttribute, getAttributeCount,
getAttributes, getAttributesLike, getByAttribute,
getByAttribute, getByAttribute, getClassLoader,
getConcreteModelClasses, getCount, getCount, getCount,
getDbid, getDirtyFields, getFindOrCreateLock,
getFromCache, getFromCache, getFromCache, getLock,
getLock, getModelClasses, getObjectClass,
getReferringObjectsIterator, getRelationshipIterator,
getResourceBundle, getSum, get Sum, getSum, getSum,
getSum, getTransientAttributes, hashCode, isDirty,
isFieldDirty, isLoaded, isModelClass, isZombie, load,
load, load, load, load, loadAll, loadAll, loadAll,
loadAll, loadAllAttributes, loadAllIterator,
loadAllIterator, loadAttributes, loadModelClassCatalogue,
loadReferringObjects, loadRelationship, putIntoCache,
releaseFindOrCreateLock, releaseLock,
removeAllAttributes, removeAllTransientAttributes,
removeAttribute, removeAttribute, removeFromCache,
setAccessible, setAttributesDirty, setClassLoader,
setClean, setDirty, setFieldDirty, setFieldDirty,
setResourceBundle, settingDbidUnderPenaltyOfDeath,
setWasCreated, store, storeAttributes,
storeClassSpecifics, storeDirtyObjects, toString,
wasCreated, writeXML, writeXML, writeXML, writeXML

Methods inherited from class java.lang.Object

clone, finalize, getClass, notify, notifyAll, wait, wait,
wait

Field Detail mountPoint protected String mountPoint Host-specific mount point, /usr, /home, /tmp, for example.

deviceFile protected String deviceFile Device file on which this storage consumer draws for storage. Note that this is essentially redundant with the storageBlock, but provides a loose link to the underlying storage block.

logicalStoragePools protected StorableMap logicalStoragePools The LogicalStoragePools that are associated with this StorageConsumer.

logicalStorageBlocks protected transient StorableMap logicalStorageBlocks Logical storage block from which this storage consumer draws storage resources.

managedDirectories protected transient StorableMap managedDirectories List of all managed directories within this partition.

consumptionBlocks protected transient StorableMap consumptionBlocks List of all consumption blcoks within this partition.

type protected String type The type of this storage consumer as obtained from the native platform.

UNKNOWN public static final String UNKNOWN Value used as a type of an unknown storage consumer/volume.

SWAP public static final String SWAP Value used as a type of swap space.

totalSize protected double totalSize The total size of the logical volume.

hasFileSystem protected boolean hasFileSystem If this logical volume has a file system.

totalCapacity protected double totalCapacity The total capacity for this storage consumer.

availableCapacity protected double availableCapacity The available capacity for this storage consumer.

usedCapacity protected double usedCapacity The used capacity for this storage consumer.

usedPercent protected double usedPercent The percentage of used capacity. The formula used to calculate the percentage is (used*100)/(used+available).

systemDevice protected SystemDevice systemDevice System device, i.e Host or NASDevice, to which this storage consumer belongs.

STORAGECONSUMER_ID_FIELD public static final String STORAGECONSUMER_ID_FIELD Constant representing the name of the StorageConsumer field.

MOUNTPOINT_FIELD public static final String MOUNTPOINT_FIELD Constant representing the name of the mountPoint field.

DEVICEFILE_FIELD public static final String DEVICEFILE_FIELD Constant representing the name of the deviceFile field.

TYPE_FIELD public static final String TYPE_FIELD Constant representing the name of the type field.

TOTALSIZE_FIELD public static final String TOTALSIZE_FIELD Constant representing the name of the totalSize field.

HASFILESYSTEM_FIELD public static final String HASFILESYSTEM_FIELD Constant representing the name of the hasFileSystem field.

TOTALCAPACITY_FIELD public static final String TOTALCAPACITY_FIELD Constant representing the name of the totalCapacity field.

AVAILABLECAPACITY_FIELD public static final String AVAILABLECAPACITY_FIELD Constant representing the name of the availableCapacity field.

USEDCAPACITY_FIELD public static final String USEDCAPACITY_FIELD Constant representing the name of the usedCapacity field.

USEDPERCENT_FIELD public static final String USEDPERCENT_FIELD Constant representing the name of the usedPercent field.

SYSTEMDEVICE_FIELD public static final String SYSTEMDEVICE_FIELD Constant representing the name of the systemDevice field.

Constructor Detail

StorageConsumer public StorageConsumer( ) Default constructor.

StorageConsumer protected StorageConsumer(Dbid dbid) Constructor used internally for loading.

StorageConsumer public StorageConsumer(String mountPoint, String deviceFile, String type, double totalCapacity, double usedCapacity, double availableCapacity) Constructs a new storage consumer as a local file system on the that is not associated with a system device.

Parameters:

systemDevice-The system device on which this storage consumer is located. type-The type of file system. mountPoint-The mount point of the file system. deviceFile-The device file of this file system. totalCapacity-The total capacity on this file system. This measurement is stored in bytes. usedCapacity-The used capacity on this file system. This measurement is stored in bytes. availableCapacity-The available capacity on this file system. This measurement is stored in bytes.

StorageConsumer public StorageConsumer(SystemDevice systemDevice, String type, String mountPoint, String deviceFile, double totalCapacity, double usedCapacity, double availableCapacity) Constructs a new storage consumer as a local file system on the specified system device. Note that this constructor adds the new instance to the list of device's storage consumers.

Parameters:

systemDevice-The system device on which this storage consumer is located. type-The type of file system. mountPoint-The mount point of the file system. deviceFile-The device file of this file system. totalCapacity-The total capacity on this file system. This measurement is stored in bytes. usedCapacity-The used capacity on this file system. This measurement is stored in bytes. availableCapacity-The available capacity on this file system. This measurement is stored in bytes.

StorageConsumer public StorageConsumer(SystemDevice systemDevice, String type, String mountPoint, String deviceFile, double totalSize, double totalCapacity, double usedCapacity, double availableCapacity) Constructs a new storage consumer as a local file system on the specified system device. Note that this constructor adds the new instance to the list of device's storage consumers.

Parameters:

systemDevice-The system device on which this storage consumer is located. type-The type of file system. mountPoint-The mount point of the file system. deviceFile-The device file of this file system. totalSize-The total size of the logical volume. This measurement is in bytes. totalCapacity-The total capacity on this file system. This measurement is stored in bytes. usedCapacity-The used capacity on this file system. This measurement is stored in bytes. availableCapacity-The available capacity on this file system. This measurement is stored in bytes.

Method Detail

getAvailablePercent public double getAvailablePercent( ) Returns the percentage of available capacity. The formula used to calculate the percentage is (used*100)/(used+available).

getPhysicalStorageBlocks public StorableMap getPhysicalStorageBlocks( ) Retrieves all of the PhysicalStorageBlocks associated with a particular StorageConsumer. This includes not only physical blocks directly associated with child LogicalStorageBlocks of the StorageConsumer, but also there child LogicalStorageBlocks's associated PhysicalStorageBlocks. Returns:

A map of all of the physical blocks associated with this logical block.

toString public String toString( ) Returns the string image of this object.

Overrides:

toString in class StorableObject

prepareInsert protected CachedPreparedStatement prepareInsert(ConnectionContext context) throws SQLException This method must be provided in order for the StorageConsumer object to become storable, i.e. so it can be added to the database.

Overrides:

prepareInsert in class StorableObject

prepareDelete protected CachedPreparedStatement prepareDelete(ConnectionContext context) throws SQLException This method must be provided in order for the StorageConsumer object to become storable, i.e. so it can be deleted from the database.

Overrides:

prepareDelete in class StorableObject

prepareSelect protected CachedPreparedStatement prepareSelect(ConnectionContext context) throws SQLException This method must be provided in order for the StorageConsumer object to become storable, i.e. so it can be retrieved from the database.

Overrides:

prepareSelect in class StorableObject

getMountPoint public String getMountPoint( ) Returns the value of the mountPoint property.

setMountPoint public void setMountPoint(String mountPoint) Sets the mountPoint property to the specified value.

getDeviceFile public String getDeviceFile( ) Returns the value of the deviceFile property.

setDeviceFile public void setDeviceFile(String deviceFile) Sets the DeviceFile property to the specified value.

getType public String getType( ) Returns the value of the type property.

setType public void setType(String type) Sets the Type property to the specified value.

getTotalSize public double getTotalSize( ) Returns the value of the totalSize property.

setTotalSize public void setTotalSize(double totalSize) Sets the TotalSize property to the specified value.

getHasFileSystem public boolean getHasFileSystem( ) Returns the value of the hasFileSystem property.

setHasFileSystem public void setHasFileSystem(boolean hasFileSystem) Sets the HasFileSystem property to the specified value.

getTotalCapacity public double getTotalCapacity( ) Returns the value of the totalCapacity property.

setTotalCapacity public void setTotalCapacity(double totalCapacity) Sets the totalCapacity property to the specified value.

getAvailableCapacity public double getAvailableCapacity( ) Returns the value of the availableCapacity property.

setAvailableCapacity public void setAvailableCapacity(double availableCapacity) Sets the AvailableCapacity property to the specified value.

getUsedCapacity public double getUsedCapacity( ) Returns the value of the usedCapacity property.

setUsedCapacity public void setUsedCapacity(double usedCapacity) Sets the UsedCapacity property to the specified value.

getUsedPercent public double getUsedPercent( ) Returns the value of the usedPercent property.

setUsedPercent public void setUsedPercent(double usedPercent) Sets the UsedPercent property to the specified value.

getSystemDevice public SystemDevice getSystemDevice( ) Returns the value of the systemDevice property.

setSystemDevice public void setSystemDevice(SystemDevice systemDevice) Sets the SystemDevice property to the specified value. Note that this should not be used as a means to add this object to the list of children of the SystemDevice parent. An appropriate call to addStorageConsumer, if available, should be made on the SystemDevice parent object instead.

toDebugString public String toDebugString( ) Returns a string image of the the specified StorageConsumer.

Overrides:

toDebugString in class StorableObject

toDebugString public String toDebugString(String indent) Description copied from class: StorableObject Returns the debug string image of the object indented using the specified indent string.

Overrides:

toDebugString in class StorableObject

toDebugString public String toDebugString(String indent, Vector callTree) Returns an indented string image of the the specified StorageConsumer.

Overrides:

toDebugString in class StorableObject

loadLogicalStoragePools public StorableMap loadLogicalStoragePools( ) Loads and returns the collection of LogicalStoragePool objects for this StorageConsumer.

getLogicalStoragePools public StorableMap getLogicalStoragePools( ) Returns the collection of LogicalStoragePool objects for this StorageConsumer.

getLogicalStoragePoolsIterator public StorableIterator getLogicalStoragePoolsIterator( ) Returns the collection of LogicalStoragePool objects for this StorageConsumer.

getLogicalStoragePoolsIterator public StorableIterator getLogicalStoragePoolsIterator(String sortFieldName, boolean isAscending) Returns the collection of LogicalStoragePool objects for this StorageConsumer.

clearLogicalStoragePools public void clearLogicalStoragePools( ) Clears the collection of LogicalStoragePool objects for this StorageConsumer.

Provided to allow applications to explicitely drop references to child LogicalStoragePool objects. Please note that subsequent invocations of get/load/add/remove methods will reload the collection.

addLogicalStoragePool public void addLogicalStoragePool(LogicalStoragePool logicalStoragePool) Adds the specified LogicalStoragePool to the collection of LogicalStoragePool objects for this StorageConsumer.

removeLogicalStoragePool public void removeLogicalStoragePool(LogicalStoragePool logicalStoragePool) Removes the specified LogicalStoragePool from the collection of LogicalStoragePool objects for this StorageConsumer.

getLogicalStoragePool public LogicalStoragePool getLogicalStoragePool(Dbid id) Returns the LogicalStoragePool with the specified ID in the collection of LogicalStoragePool objects for this StorageConsumer.

loadLogicalStorageBlocks public StorableMap loadLogicalStorageBlocks( ) Loads and returns the collection of LogicalStorageBlock objects for this StorageConsumer.

getLogicalStorageBlocks public StorableMap getLogicalStorageBlocks( ) Returns the collection of LogicalStorageBlock objects for this StorageConsumer.

getLogicalStoragePoolsIterator public StorableIterator getLogicalStorageBlocksIterator( ) Returns the collection of LogicalStorageBlock objects for this StorageConsumer.

getLogicalStoragePoolsIterator public StorableIterator getLogicalStoragePoolsIterator(String sortFieldName, boolean isAscending) Returns the collection of LogicalStorageBlock objects for this StorageConsumer.

clearLogicalStorageBlocks public void clearLogicalStorageBlocks( ) Clears the collection of LogicalStorageBlock objects for this StorageConsumer. Provided to allow applications to explicitely drop references to child LogicalStorageBlock objects. Please note that subsequent invocations of get/load/add/remove methods will reload the collection.

addLogicalStorageBlock public void addLogicalStorageBlock(LogicalStorageBlock logicalStorageBlock) Adds the specified LogicalStorageBlock to the collection of LogicalStorageBlock objects for this StorageConsumer.

removeLogicalStorageBlock public void removeLogicalStorageBlock(LogicalStorageBlock logicalStorageBlock) Removes the specified LogicalStorageBlock from the collection of LogicalStorageBlock objects for this StorageConsumer.

getLogicalStorageBlock public LogicalStorageBlock getLogicalStorageBlock(Dbid id) Returns the LogicalStorageBlock with the specified ID in the collection of LogicalStorageBlock objects for this StorageConsumer.

loadManagedDirectories public StorableMap loadManagedDirectories( ) Loads and returns the collection of ManagedDirectory objects for this StorageConsumer.

getManagedDirectories public StorableMap getManagedDirectories( ) Returns the collection of ManagedDirectory objects for this StorageConsumer.

getManagedDirectoriesIterator public StorableIterator getManagedDirectoriesIterator( ) Returns the collection of ManagedDirectory objects for this StorageConsumer

getManagedDirectoriesIterator public StorableIterator

getManagedDirectoriesIterator (String sortFieldName, boolean isAscending) Returns the collection of ManagedDirectory objects for this StorageConsumer.

clearManagedDirectories public void clearManagedDirectories( ) Clears the collection of ManagedDirectory objects for this StorageConsumer.

Provided to allow applications to explicitely drop references to child ManagedDirectory objects. Please note that subsequent invocations of get/load/add/remove methods will reload the collection.

addManagedDirectory public void addManagedDirectory (ManagedDirectory managedDirectory) Adds the specified ManagedDirectory to the collection of ManagedDirectory objects for this StorageConsumer.

removeManagedDirectory public void removeManagedDirectory (ManagedDirectory managedDirectory) Removes the specified ManagedDirectory from the collection of ManagedDirectory objects for this StorageConsumer.

getManagedDirectory public ManagedDirectory getManagedDirectory (Dbid id) Returns the ManagedDirectory with the specified ID in the collection of ManagedDirectory objects for this StorageConsumer.

loadConsumptionBlocks public StorableMap loadConsumptionBlocks( ) Loads and returns the collection of ConsumptionBlock objects for this StorageConsumer.

getConsumptionBlocks public StorableMap getConsumptionBlocks( ) Returns the collection of ConsumptionBlock objects for this StorageConsumer.

getConsumptionBlocksIterator public StorableIterator getConsumptionBlocksIterator( ) Returns the collection of ConsumptionBlock objects for this StorageConsumer.

getConsumptionBlocksIterator public StorableIterator

getConsumptionBlocksIterator (String sortFieldName, boolean isAscending) Returns the collection of ConsumptionBlock objects for this StorageConsumer.

clearConsumptionBlocks public void clearConsumptionBlocks( ) Clears the collection of ConsumptionBlock objects for this StorageConsumer.

Provided to allow applications to explicitely drop references to child ConsumptionBlock objects. Please note that subsequent invocations of get/load/add/remove methods will reload the collection.

addConsumptionBlock public void addConsumptionBlock(ConsumptionBlock consumptionBlock) Adds the specified ConsumptionBlock to the collection of ConsumptionBlock objects for this StorageConsumer.

removeConsumptionBlock public void removeConsumptionBlock(ConsumptionBlock consumptionBlock) Removes the specified ConsumptionBlock from the collection of ConsumptionBlock objects for this StorageConsumer.

getConsumptionBlock public ConsumptionBlock getConsumptionBlock(Dbid id) Returns the ConsumptionBlock with the specified ID in the collection of ConsumptionBlock objects for this StorageConsumer.

getStorageConsumerListBySystemDevice public static StorableList

getStorageConsumerListBySystemDevice (SystemDevice systemDevice) Returns a list, sorted in no particular order, of StorageConsumer objects which have the systemDevice of the specified value.

getBySystemDevice public static StorableList getBySystemDevice(SystemDevice systemDevice) Deprecated. Returns the StorageConsumer which has the systemDevice of the specified value.

Immediately following is a sample template related to the logical volume DO 404 of FIG. 4, and corresponding to the immediately preceding JAVA document (class StorageConsumer).

```
//--------------------------------------------------------------------------
// Copyright 1999-2002 Hewlett-Packard Co., All Rights Reserved.
//--------------------------------------------------------------------------
/**
* Abstraction of a software layer (file-system) that utilizes the storage
* resources that were allocated to a system device, e.g., a {@link Host}
or a
* {@link NASDevice}. Besides file systems, this can also represent
* swap-space, dump-space and any raw storage spaces allocated for
use by
* database software, etc.
*/
public final class StorageConsumer extends StorableObject {
  /** Host-specific mount point, /usr, /home, /tmp, for example. */
  protected String mountPoint;
  /**
    * Device file on which this storage consumer draws for
storage.&nbsp;
    * Note that this is essentially redundant with the storageBlock,
but
    * provides a loose link to the underlying storage block.
    */
  protected String deviceFile;
  /**
    * The {@link LogicalStoragePool LogicalStoragePools} that are
associated
    * with this StorageConsumer.
    */
  // ::relate StorageConsumer logicalStoragePools LogicalStoragePool
storageConsumers
  protected StorableMap logicalStoragePools;
  /**
    * Logical storage block from which this storage consumer draws
storage
    * resources.
    */
  // ::relate StorageConsumer logicalStorageBlocks
LogicalStorageBlock rootStorageConsumer
  protected transient StorableMap logicalStorageBlocks = null;
  /** List of all managed directories within this partition. */
  // ::relate StorageConsumer managedDirectories ManagedDirectory
storageConsumer
  protected transient StorableMap managedDirectories = null;
  /** List of all consumption blocks within this partition. */
  // ::relate StorageConsumer consumptionBlocks
ConsumptionBlock StorageConsumer
  protected transient StorableMap consumptionBlocks = null;
  /**
    * The type of this storage consumer as obtained from the native
    * platform.
    */
  protected String type;
  /** Value used as a type of an unknown storage consumer/volume.
*/
  public static final String UNKNOWN = “unknown”;
  /** Value used as a type of swap space. */
  public static final String SWAP = “swap”;
  /** The total size of the logical volume. */
  protected double totalSize;
  /** If this logical volume has a file system. */
  protected boolean hasFileSystem;
  /** The total capacity for this storage consumer. */
  protected double totalCapacity;
  /** The available capacity for this storage consumer. */
  protected double availableCapacity;
  /** The used capacity for this storage consumer. */
  protected double usedCapacity;
  /**
    * The percentage of used capacity. The formula used to calculate
the
    * percentage is (used * 100) / (used + available).
    */
  protected double usedPercent;
  /**
    * System device, e.g., {@link Host} or {@link NASDevice}, to which
this
    * storage consumer belongs.
    */
  // ::getBy unsorted systemDevice
  protected SystemDevice systemDevice;
  /**
    * Constructs a new storage consumer as a local file system on the
that is not
    * associated with a system device.
    *
    * @param systemDevice The system device on which this storage
consumer is
    * located.
    * @param type The type of file system.
    * @param mountPoint The mount point of the file system.
    * @param deviceFile The device file of this file system.
    * @param totalCapacity The total capacity on this file system. This
    * measurement is stored in bytes.
    * @param usedCapacity The used capacity on this file system. This
measurement
    * is stored in bytes.
    * @param availableCapacity The available capacity on this file
system. This
    * measurement is stored in bytes.
    */
  public StorageConsumer (String mountPoint, String deviceFile,
String type,
```

double totalCapacity,
double usedCapacity, double availableCapacity) {

super ( );
this.type = type;
this.mountPoint = mountPoint;
this.deviceFile = deviceFile;
this.totalCapacity = totalCapacity;
this.usedCapacity = usedCapacity;
this.availableCapacity = availableCapacity;

```
  }
  /**
    * Constructs a new storage consumer as a local file system on the
    * specified system device. Note that this constructor adds the new
    * instance to the list of device's storage consumers.
    *
    * @param systemDevice The system device on which this storage
consumer is located.
    * @param type The type of file system.
    * @param mountPoint The mount point of the file system.
    * @param deviceFile The device file of this file system.
    * @param totalCapacity The total capacity on this file system. This
measurement
    * is stored in bytes.
    * @param usedCapacity The used capacity on this file system. This
measurement
    * is stored in bytes.
    * @param availableCapacity The available capacity on this file
system. This measurement
    * is stored in bytes.
    */
  public StorageConsumer (SystemDevice systemDevice, String type,
```

String mountPoint, String deviceFile,
double totalCapacity,
double usedCapacity, double availableCapacity) {

super ( );
this.type = type;
this.mountPoint = mountPoint;
this.deviceFile = deviceFile;
this.totalCapacity = totalCapacity;
this.usedCapacity = usedCapacity;
this.availableCapacity = availableCapacity;
/* ::post-compile
if (systemDevice != null) {
systemDevice.addStorageConsumer (this);
}
::post-compile */

```
  }
  /**
    * Constructs a new storage consumer as a local file system on the
    * specified system device. Note that this constructor adds the new
    * instance to the list of device's storage consumers.
    *
    * @param systemDevice The system device on which this storage
consumer is located.
    * @param type The type of file system.
    * @param mountPoint The mount point of the file system.
    * @param deviceFile The device file of this file system.
    * @param totalSize The total size of the logical volume. This
    * measurement is in bytes.
    * @param totalCapacity The total capacity on this file system. This
measurement
    * is stored in bytes.
    * @param usedCapacity The used capacity on this file system. This
measurement
    * is stored in bytes.
    * @param availableCapacity The available capacity on this file
system. This measurement
    * is stored in bytes.
    */
  public StorageConsumer (SystemDevice systemDevice, String type,
```

String mountPoint, String deviceFile,
double totalSize, double totalCapacity,
double usedCapacity, double availableCapacity) {

super ( );
this.type = type;
this.mountPoint = mountPoint;
this.deviceFile = deviceFile;
this.totalSize = totalSize;
this.totalCapacity = totalCapacity;
this.usedCapacity = usedCapacity;
this.availableCapacity = availableCapacity;
/* ::post-compile
if (systemDevice != null) {
systemDevice.addStorageConsumer (this);
}
::post-compile */

```
  }
  /**
    * Returns the percentage of available capacity. The formula used to
calculate
    * the percentage is (used * 100) / (used + available).
    */
  public double getAvailablePercent ( ) {
```

return 0; /* ::post-compile
return (getAvailableCapacity( ) * 100.0) /

(getUsedCapacity( ) + getAvailableCapacity( ));

::post-compile */

```
  }
  /**
    * Retrieves all of the PhysicalStorageBlocks associated with a
particular
    * StorageConsumer. This includes not only physical blocks directly
    * associated with child LogicalStorageBlocks of the
StorageConsumer,
    * but also there child LogicalStorageBlocks's associated
    * PhysicalStorageBlocks.
    *
    * @return A map of all of the physical blocks associated with this
    * logical block.
    */
  /* ::post-compile
  public StorableMap getPhysicalStorageBlocks( ) {
```

StorableMap physicalBlocks = new StorableMap( );
Iterator logicalBlocks = getLogicalStorageBlocks( ).iterator( );
while(logicalBlocks.hasNext( )) {
StorableMap childPhysicalBlocks =

getPhysicalBlocks((LogicalStorageBlock)logicalBlocks.next( ));

physicalBlocks.importCollection(childPhysicalBlocks);
}
return physicalBlocks;

```
  }
  ::post-compile */
  /**
    * Recursive call that gets all of the PhysicalStorageBlocks
associated
    * with a particular LogicalStorageBlock. This includes no only
physical
    * blocks directly associated with the LogicalStorageBlock but also
    * associated with any child logical storage blocks.
    *
    * @param logicalBlock The logical storage block for which all
physical
    * storage blocks should be retreived. This must be a non-null
value.
    *
    * @return A map of all of the physical blocks associated with this
    * logical block.
    *
    * @throws NullPointerException If the given logical block is a null.
    */
  /* ::post-compile
  private StorableMap getPhysicalBlocks (LogicalStorageBlock
logicalBlock) {
```

```
StorableMap physicalBlocks = new StorableMap ( );
Iterator childLogicalBlocks =
  logicalBlock.getLogicalStorageBlocks( ).iterator( );
while(childLogicalBlocks.hasNext( )) {
  StorableMap childPhysicalBlocks =
```

getPhysicalBlocks((LogicalStorageBlock)

childLogicalBlocks.next( ));

physicalBlocks.importCollection(childPhysicalBlocks);
}
physicalBlocks.importCollection(logicalBlock.

getPhysicalStorageBlocks( ));

return physicalBlocks;

```
  }
  ::post-compile */
  /** Returns the string image of this object. */
  /* ::post-compile
  public String toString( ) {
```

return “volume ” + getDeviceFile( ) + “ mounted on ” +

getMountPoint( ) +

“ from ” + getSystemDevice( );

```
  }
  ::post-compile */
}
```

Immediately following is a JAVA document (referred to as class LogicalStorageBlock) corresponding to the LSB DO 406 of FIG. 4.

com.hp.sanmgr.model Class LogicalStorageBlock

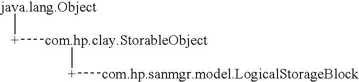

public final class LogicalStorageBlock extends StorableObject

LogicalStorageBlocks are an OVSAM concept that represents the complex mapping performed by volume managers between the logical and physical volumes. An LogicalStorageBlock represents the aggregation of a number of storage blocks (physical or logical) with a particular relationship to create a logical piece of storage which can be used to create a storage consumer or to create another logical storage block. This representation facilitates modeling of different configurations that are possible under different logical volume managers, such as LVM, VxVM, LDM, etc.

Field Summary

| | |
|---|---|
| protected | capacity |
| double | Total storage capacity of this logical storage |
| | block. |
| static | CAPACITY_FIELD |
| String | Constant representing the name of the capacity |
| | field. |
| static int | DIRECT |
| | A logical storage block type that indicates the |
| | block is neither mirrored or striped. |
| static | LOGICALSTORAGEBLOCK_ID_FIELD |
| String | Constant representing the name of the |
| | LogicalStorageBlock field. |
| protected | logicalStorageBlocks |
| StorableMap | Logical storage blocks that are contained within |
| | this storage block. |
| static int | MIRROR |
| | A logical storage block type that indicates the |
| | block is mirrored. |
| protected | name |
| String | The name associated with this logical storage |
| | block by the volume manager. |
| static | NAME_FIELD |
| String | Constant representing the name of the name |
| | field. |
| protected | physicalStorageBlocks |
| StorableMap | The physical storage block's associated with the |
| | logical storage block. |
| static int | RAID_5 |
| | A logical storage block type that indicates the |
| | block is RAID-5. |
| protected | rootLogicalStorageBlock |
| Logical- | Parent LogicalStorageBlock. |
| Storage- | |
| Block | |
| static | ROOTLOGICALSTORAGEBLOCK_FIELD |
| String | Constant representing the name of the |
| | rootLogicalStorageBlock field. |
| protected | rootStorageConsumer |
| Storage- | The StorageConsumer parent of this |
| Consumer | LogicalStorageBlock. |
| static | ROOTSTORAGECONSUMER_FIELD |
| String | Constant representing the name of the |
| | rootStorageConsumer field. |
| static int | STRIPE |
| | A logical storage block type that indicates the |
| | block is striped. |
| protected | type |
| int | The method used to organize and store data on |
| | the LogicalStorageBlock. |
| static | TYPE_FIELD |
| String | Constant representing the name of the type field. |
| protected | typeCount |
| int | Any count information associated with a type. |
| static | TYPECOUNT_FIELD |
| String | Constant representing the name of the typeCount |
| | field. |
| static int | UNKNOWN |
| | A logical storage block type that indicates it |
| | exists in some ‘unknown’ state in regards to how data is |
| | stored. |

Fields inherited from class com.hp.clay.StorableObject

blWritable, CACHED_OBJECTS,
NON_STORABLE_MASK,
NOT_STORED, PACKAGE_PREFIX,
ROOT_CLASS_NAME,
ROOT_CLASS_PREFIX, STORED_AS_BOOLEAN,
STORED_AS_COLLECTION, STORED_AS_DATE,
STORED_AS_DOUBLE,
STORED_AS_FLOAT, STORED_AS_INTEGER,
STORED_AS_LONG,
STORED_AS_REFERENCE, STORED_AS_STRING,
STORED_AS_TRANSIENT_COLLECTION,
STORED_OBJECTS,
XML_ATTRIBUTES_AS_ATTRIBUTES,
XML_EXPAND_AGGREGATE_REFERENCES,
XML_EXPAND_ATTRIBUTE_REFERENCES,
XML_EXPAND_SINGULAR_REFERENCES,
XML_ID_AS_ENTITIES,
XML_INCLUDE_REFERENCED_OBJECTS,
XML_SUPPRESS_ID_ATTRIBUTES,
XML_SUPPRESS_XREF_ATTRIBUTES,
XML_USE_TYPE_SPECIFIC_ENTITIES

Constructor Summary

| | |
|---|---|
| | LogicalStorageBlock( ) |
| | Default constructor. |
| protected | LogicalStorageBlock(Dbid dbid) |
| | Constructor used internally for loading. |
| | LogicalStorageBlock(String name, double |
| | capacity, int type, int typeCount) |
| | Creates a logical storage block that is not |
| | associated with either a storage consumer or |
| | a logical storage block. |
| | LogicalStorageBlock(String name, |
| | LogicalStorageBlock logicalStorageBlock, double |
| | capacity, int type, int typeCount) |
| | Creates a logical storage block which will |
| | represent a leaf-node of a logical storage |
| | block tree hierarchy. |
| | LogicalStorageBlock(String name, |
| | StorageConsumer storageConsumer, double |
| | capacity, int type, int typeCount) |
| | Creates a logical storage block which will |
| | represent the root of a logical storage |
| | block tree hierarchy. |

Method Summary

| | |
|---|---|
| void | addLogicalStorageBlock |
| | (LogicalStorageBlock |
| | logicalStorageBlock) |
| | Adds the specified |
| | LogicalStorageBlock |
| | to the collection of |
| | LogicalStorageBlock objects |
| | for this LogicalStorageBlock. |
| void | addPhysicalStorageBlock |
| | (PhysicalStorageBlock |
| | physicalStorageBlock) |
| | Adds the specified |
| | PhysicalStorageBlock |
| | to the collection of |
| | PhysicalStorageBlock objects |
| | for this LogicalStorageBlock. |
| void | clearLogicalStorageBlocks( ) |
| | Clears the collection of |
| | LogicalStorageBlock objects |
| | for this |
| | LogicalStorageBlock. |
| void | clearPhysicalStorageBlocks( ) |
| | Clears the collection of |
| | PhysicalStorageBlock objects |
| | for this |
| | LogicalStorageBlock. |
| StorableMap | getAllPhysicalStorageBlocks( ) |
| | Retrieves all of the |
| | PhysicalStorageBlocks |
| | associated with a |
| | particular LogicalStorageBlock. |
| static StorableList | getByRootLogicalStorageBlock |
| | (LogicalStorageBlock |
| | rootLogicalStorageBlock) |
| | Deprecated. Returns the |
| | LogicalStorageBlock which has |
| | the rootLogicalStorageBlock |
| | of the specified value. |
| static StorableList | getByRootStorageConsumer |
| | (StorageConsumer |
| | rootStorageConsumer) |
| | Deprecated. Returns the |
| | LogicalStorageBlock which |
| | has the rootStorageConsumer |
| | of the specified value. |
| double | getCapacity( ) |
| | Returns the value of the |
| | capacity property. |
| LogicalStorageBlock | getLogicalStorageBlock(Dbid id) |
| | Returns the LogicalStorageBlock |
| | with the specified ID in the |
| | collection of |
| | LogicalStorageBlock objects for |
| | this LogicalStorageBlock. |
| static StorableList | getLogicalStorageBlockListBy- |
| | RootLogicalStorageBlock |
| | (LogicalStorageBlock |
| | rootLogicalStorageBlock) |
| | Returns a list, sorted in no |
| | particular order, of |
| | LogicalStorageBlock objects |
| | which have the |
| | rootLogicalStorageBlock of the |
| | specified value. |
| static StorableList | getLogicalStorageBlockListBy- |
| | RootStorageConsumer |
| | (StorageConsumer |
| | rootStorageConsumer) |
| | Returns a list, sorted in no |
| | particular order, of |
| | LogicalStorageBlock objects |
| | which have the |
| | rootStorageConsumer of the |
| | specified value. |
| StorableMap | getLogicalStorageBlocks( ) |
| | Returns the collection of |
| | LogicalStorageBlock objects for |
| | this LogicalStorageBlock. |
| StorableIterator | getLogicalStorageBlocks- |
| | Iterator( ) |
| | Returns the collection of |
| | LogicalStorageBlock objects for |
| | this LogicalStorageBlock. |
| StorableIterator | getLogicalStorageBlocks- |
| | Iterator(String |
| | sortFieldName, boolean |
| | isAscending) |
| | Returns the collection of |
| | LogicalStorageBlock objects for |
| | this LogicalStorageBlock. |
| String | getName( ) |
| | Returns the value of the name |
| | property. |
| PhysicalStorageBlock | getPhysicalStorageBlock |
| | (Dbid id) |
| | Returns the |
| | PhysicalStorageBlock with |
| | the specified ID in the |
| | collection of |
| | PhysicalStorageBlock objects |
| | for this LogicalStorageBlock. |
| StorableMap | getPhysicalStorageBlocks( ) |
| | Returns the collection of |
| | PhysicalStorageBlock objects for |
| | this LogicalStorageBlock. |
| StorableIterator | getPhysicalStorageBlocks- |
| | Iterator( ) |
| | Returns the collection of |
| | PhysicalStorageBlock objects for |
| | this LogicalStorageBlock. |
| StorableIterator | getPhysicalStorageBlocks- |
| | Iterator(String |
| | sortFieldName, boolean |
| | isAscending) |
| | Returns the collection of |
| | PhysicalStorageBlock objects for |
| | this LogicalStorageBlock. |
| LogicalStorageBlock | getRootLogicalStorageBlock( ) |
| | Returns the value of the |
| | rootLogicalStorageBlock |
| | property. |
| StorageConsumer | getRootStorageConsumer( ) |
| | Returns the value of the |
| | rootStorageConsumer property. |
| int | getType( ) |
| | Returns the value of the |
| | type property. |
| int | getTypeCount( ) |
| | Returns the value of the |
| | typeCount property. |
| StorableMap | loadLogicalStorageBlocks( ) |
| | Loads and returns the |
| | collection of |
| | LogicalStorageBlock objects for |
| | this LogicalStorageBlock. |
| StorableMap | loadPhysicalStorageBlocks( ) |
| | Loads and returns the |
| | collection of |
| | PhysicalStorageBlock objects for |
| | this LogicalStorageBlock. |
| protected | prepareDelete |
| CachedPreparedStatement | (ConnectionContext context) |
| | This method must be provided |
| | in order for the |
| | LogicalStorageBlock object to |
| | become storable, i.e. |
| protected | prepareInsert |
| CachedPreparedStatement | (ConnectionContext context) |
| | This method must be provided |
| | in order for the |
| | LogicalStorageBlock object to |
| | become storable, i.e. |
| protected | prepareSelect |
| CachedPreparedStatement | (ConnectionContext context) |
| | This method must be provided |
| | in order for the |
| | LogicalStorageBlock object to |
| | become storable, i.e. |
| void | removeLogicalStorageBlock |
| | (LogicalStorageBlock |
| | logicalStorageBlock) |
| | Removes the specified |
| | LogicalStorageBlock from |
| | the collection of |
| | LogicalStorageBlock objects for |
| | this LogicalStorageBlock. |
| void | removePhysicalStorageBlock |
| | (PhysicalStorageBlock |
| | physicalStorageBlock) |
| | Removes the specified |
| | PhysicalStorageBlock from |
| | the collection of |
| | PhysicalStorageBlock objects for |
| | this LogicalStorageBlock. |
| void | setCapacity(double capacity) |
| | Sets the Capacity property |
| | to the specified value. |
| void | setName(String name) |
| | Sets the Name property to |
| | the specified value. |
| void | setRootLogicalStorageBlock |
| | (LogicaiStorageBlock |
| | rootLogicalStorageBlock) |
| | Sets the RootLogicalStorageBlock |
| | property to the specified value. |
| void | setRootStorageConsumer |
| | (StorageConsumer |
| | rootStorageConsumer) |
| | Sets the RootStorageConsumer |
| | property to the specified value. |
| void | setType(int type) |
| | Sets the Type property to |
| | the specified value. |
| void | setTypeCount(int typeCount) |
| | Sets the TypeCount property |
| | to the specified value. |
| String | toDebugString( ) |
| | Returns a string image |
| | of the the specified |
| | LogicalStorageBlock. |
| String | toDebugString(String indent) |
| | Returns the debug string image |
| | of the object indented using |
| | the specified indent string. |
| String | toDebugString(String indent, |
| | Vector callTree) |
| | Returns an indented string |
| | image of the the specified |
| | LogicalStorageBlock. |
| String | toString( ) |
| | Returns the string image |
| | of this object. |

Methods inherited from class com.hp.clay.StorableObject

http://srmlab.rose.hp.com/java-api/sanmgr/com/hp/
clay/StorableObject.html -
<clinit>( ), addAttribute, addDependentObjects,
attributesLoaded, cacheOnly, decode, delete, delete,
deleteDependentObjects, deleteObject,
deleteThisObjectFromCacheUnderPenaltyOfDeath,
enableZombieMonitor, encode, equals, error, error, error,
error, executeQuery, flushAttributes,
getAbstractModelClasses, getAttribute, getAttributeCount,
getAttributes, getAttributesLike, getByAttribute,
getByAttribute, getByAttribute, getClassLoader,
getConcreteModelClasses, getCount, getCount, getCount,
getDbid, getDirtyFields, getFindOrCreateLock,
getFromCache, getFromCache, getFromCache, getLock,
getLock, getModelClasses, getObjectClass,
getReferringObjectsIterator, getRelationshipIterator,
getResourceBundle, getSum, getSum, getSum, getSum,
getSum, getTransientAttributes, hashCode, isDirty,
isFieldDirty, isLoaded, isModelClass, isZombie, load,
load, load, load, load, loadAll, loadAll, loadAll,
loadAll, loadAllAttributes, loadAllIterator,
loadAllIterator, loadAttributes, loadModelClassCatalogue,
loadReferringObjects, loadRelationship, putIntoCache,
releaseFindOrCreateLock, releaseLock,
removeAllAttributes, removeAllTransientAttributes,
removeAttribute, removeAttribute, removeFromCache,
setAccessible, setAttributesDirty, setClassLoader,
setClean, setDirty, setFieldDirty, setFieldDirty,
setResourceBundle, settingDbidUnderPenaltyOfDeath,
setWasCreated, store, storeAttributes,
storeClassSpecifics, storeDirtyObjects, toString,
wasCreated, writeXML, writeXML, writeXML, writeXML

Methods inherited from class java.lang.Object

clone, finalize, getClass, notify, notifyAll, wait, wait,
wait

Field Direct

DIRECT public static final int DIRECT A logical storage block type that indicates the block is neither mirrored or striped.

MIRROR public static final int MIRROR A logical storage block type that indicates the block is mirrored.

STRIPE public static final int STRIPE A logical storage block type that indicates the block is striped.

RAID_5 public static final int RAID_5 A logical storage block type that indicates the block is RAID-5.

UNKNOWN public static final int UNKNOWN A logical storage block type that indicates it exists in some ‘unknown’ state in regards to how data is stored.

type protected int type The method used to organize and store data on the LogicalStorageBlock. This may correspond to one of three values: DIRECT, MIRROR, AND DIRECT.

typeCount protected int typeCount Any count information associated with a type. Typically the number of mirrors or the level or RAID.

name protected String name The name associated with this logical storage block by the volume manager.

capacity protected double capacity Total storage capacity of this logical storage block. Note that this will be equal or less than the sum of the children logical storage blocks or physical storage blocks total storage capacity.

rootStorageConsumer protected StorageConsumer rootStorageConsumer The StorageConsumer parent of this LogicalStorageBlock. This will be null if the parent of this LogicalStorageBlock is another LogicalStorageBlock.

physicalStorageBlocks protected transient StorableMap physicalStorageBlocks The physical storage block's associated with the logical storage block.

logicalStorageBlocks protected transient StorableMap logicalStorageBlocks Logical storage blocks that are contained within this storage block.

rootLogicalStorageBlock protected LogicalStorageBlock rootLogicalStorageBlock Parent LogicalStorageBlock. Used when logical storage blocks comprised of several other logical storage blocks. This will be null if the parent of this LogicalStorageBlock is a StorageConsumer.

LOGICALSTORAGEBLOCK_ID_FIELD public static final String LOGICALSTORAGEBLOCK_ID_FIELD Constant representing the name of the LogicalStorageBlock field.

TYPE_FIELD public static final String TYPE_FIELD Constant representing the name of the type field.

TYPECOUNT_FIELD public static final String TYPECOUNT_FIELD Constant representing the name of the typeCount field.

NAME_FIELD public static final String NAME_FIELD Constant representing the name of the name field.

CAPACITY_FIELD public static final String CAPACITY_FIELD Constant representing the name of the capacity field.

ROOTSTORAGECONSUMER_FIELD public static final String ROOTSTORAGECONSUMER_FIELD Constant representing the name of the rootStorageConsumer field.

ROOTLOGICALSTORAGEBLOCK_FIELD public static final String ROOTLOGICALSTORAGEBLOCK_FIELD Constant representing the name of the rootLogicalStorageBlock field.

LogicalStorageBlock public LogicalStorageBlock( ) Default constructor.

LogicalStorageBlock protected LogicalStorageBlock(Dbid dbid) Constructor used internally for loading.

LogicalStorageBlock public LogicalStorageBlock(String name, double capacity, int type, int typeCount) Creates a logical storage block that is not associated with either a storage consumer or a logical storage block.

Parameters:

name-The name used by the volume manager to refer to this logical storage block. capacity-The capacity in bytes of this logical storage block. type-The type associated with this logical storage block corresponding to one of the type constants defined with this class. typeCount-The total number associated with the type. For example if the type is MIRROR the type count would correspond to the total number of mirrors, or if the type was RAID the type could would correspond to the RAID level.

LogicalStorageBlock public LogicalStorageBlock(String name, LogicalStorageBlock logicalStorageBlock, double capacity, int type, int typeCount) Creates a logical storage block which will represent a leaf-node of a logical storage block tree hierarchy.

Parameters: name-The name used by the volume manager to refer to this logical storage block. logicalStorageBlock-The parent of this logical storage block. capacity-The capacity in bytes of this logical storage block. type-The type associated with this logical storage block corresponding to one of the type constants defined with this class. typeCount-The total number associated with the type. For example if the type is MIRROR the type count would correspond to the total number of mirrors, or if the type was RAID the type could would correspond to the RAID level.

LogicalStorageBlock public LogicalStorageBlock(String name, StorageConsumer storageconsumer, double capacity, int type, int typeCount) Creates a logical storage block which will represent the root of a logical storage block tree hierarchy.

Parameters:

name-The name used by the volume manager to refer to this logical storage block. storageConsumer-The parent storage consumer for this logical storage block. capacity-The capacity in bytes of this logical storage block. type-The type associated with this logical storage block corresponding to one of the type constants defined with this class. typeCount-The total number associated with the type. For example if the type is MIRROR the type count would correspond to the total number of mirrors, or if the type was RAID the type could would correspond to the RAID level.

Method Detail .

getAllPhysicalStorageBlocks public StorableMap getAllPhysicalStorageBlocks( ) Retrieves all of the PhysicalStorageBlocks associated with a particular LogicalStorageBlock. This includes not only physical blocks directly associated with child LogicalStorageBlocks of the StorageConsumer, but also there child LogicalStorageBlocks's associated PhysicalStorageBlocks.

Returns:

A map of all of the physical blocks associated with this logical block.

toString public String toString( ) Returns the string image of this object.

Overrides:

toString in class StorableObject

prepareInsert protected CachedPreparedStatement prepareInsert(ConnectionContext context) throws SQLException This method must be provided in order for the LogicalStorageBlock object to become storable, i.e. so it can be added to the database.

Overrides:

prepareInsert in class StorableObject

prepareDelete protected CachedPreparedStatement prepareDelete(ConnectionContext context) throws SQLException This method must be provided in order for the LogicalStorageBlock object to become storable, i.e. so it can be deleted from the database.

Overrides:

prepareDelete in class StorableObject

prepareSelect protected CachedPreparedStatement prepareSelect(ConnectionContext context) throws SQLException This method must be provided in order for the LogicalStorageBlock object to become storable, i.e. so it can be retrieved from the database.

Overrides:

prepareSelect in class StorableObject

getType public int getType( ) Returns the value of the type property.

setType public void setType(int type) Sets the Type property to the specified value.

getTypeCount public int getTypeCount( ) Returns the value of the typeCount property.

setTypeCount public void setTypeCount(int typeCount) Sets the TypeCount property to the specified value.

getName public String getName( ) Returns the value of the name property.

setName public void setName(String name) Sets the Name property to the specified value.

getCapacity public double getCapacity( ) Returns the value of the capacity property.

setCapacity public void setCapacity(double capacity) Sets the Capacity property to the specified value.

getRootStorageConsumer public StorageConsumer getRootStorageConsumer( ) Returns the value of the rootStorageConsumer property.

setRootStorageConsumer public void setRootStorageConsumer(StorageConsumer rootStorageConsumer) Sets the RootStorageConsumer property to the specified value. Note that this should not be used as a means to add this object to the list of children of the RootStorageConsumer parent. An appropriate call to addLogicalStorageBlock , if available, should be made on the RootStorageConsumer parent object instead.

getRootLogicalStorageBlock public LogicalStorageBlock getRootLogicalStorageBlock( ) Returns the value of the rootLogicalStorageBlock property.

setRootLogicalStorageBlock public void setRootLogicalStorageBlock(LogicalStorageBlock rootLogicalStorageBlock) Sets the RootLogicalStorageBlock property to the specified value. Note that this should not be used as a means to add this object to the list of children of the RootLogicalStorageBlock parent. An appropriate call to addLogicalStorageBlock, if available, should be made on the RootLogicalStorageBlock parent object instead.

toDebugString public String toDebugString( ) Returns a string image of the the specified LogicalStorageBlock.

Overrides:

toDebugString in class StorableObject

toDebugString public String toDebugString(String indent) Description copied from class: StorableObject Returns the debug string image of the object indented using the specified indent string.

Overrides:

toDebugString in class StorableObject

toDebugString public String toDebugString(String indent, Vector callTree) Returns an indented string image of the the specified LogicalStorageBlock.

Overrides:

toDebugString in class StorableObject

loadPhysicalStorageBlocks public StorableMap loadPhysicalStorageBlocks( ) Loads and returns the collection of Physical StorageBlock objects for this LogicalStorageBlock.

getPhysicalStorageBlocks public StorableMap getPhysicalStorageBlocks( ) Returns the collection of PhysicalStorageBlock objects for this LogicalStorageBlock.

getPhysicalStorageBlocksIterator public StorableIterator getPhysicalStorageBlocksIterator( ) Returns the collection of PhysicalStorageBlock objects for this LogicalStorageBlock.

getPhysicalStorageBlocksIterator public StorableIterator getPhysicalStorageBlocksIterator(String sortFieldName, boolean isAscending) Returns the collection of PhysicalStorageBlock objects for this LogicalStorageBlock.

clearPhysicalStorageBlocks public void clearPhysicalStorageBlocks( ) Clears the collection of PhysicalStorageBlock objects for this LogicalStorageBlock. Provided to allow applications to explicitely drop references to child PhysicalStorageBlock objects. Please note that subsequent invocations of get/load/add/remove methods will reload the collection.

addPhysicalStorageBlock public void addPhysicalStorageBlock(PhysicalStorageBlock physicalStorageBlock) Adds the specified PhysicalStorageBlock to the collection of PhysicalStorageBlock objects for this LogicalStorageBlock.

removePhysicalStorageBlock public void removePhysicalStorageBlock(PhysicalStorageBlock physicalStorageBlock) Removes the specified PhysicalStorageBlock from the collection of PhysicalStorageBlock objects for this LogicalStorageBlock.

getPhysicalStorageBlock public PhysicalStorageBlock getPhysicalStorageBlock(Dbid id) Returns the PhysicalStorageBlock with the specified ID in the collection of PhysicalStorageBlock objects for this LogicalStorageBlock.

loadLogicalStorageBlocks public StorableMap loadLogicalStorageBlocks( ) Loads and returns the collection of LogicalStorageBlock objects for this LogicalStorageBlock.

getLogicalStorageBlocks public StorableMap getLogicalStorageBlocks( ) Returns the collection of LogicalStorageBlock objects for this LogicalStorageBlock.

getLogicalStoragePoolsIterator public StorableIterator getLogicalStorageBlocksIterator( ) Returns the collection of LogicalStorageBlock objects for this LogicalStorageBlock.

getLogicalStoragePoolsIterator public StorableIterator getLogicalStoragePoolsIterator(String sortFieldName, boolean isAscending) Returns the collection of LogicalStorageBlock objects for this LogicalStorageBlock.

clearLogicalStorageBlocks public void clearLogicalStorageBlocks( ) Clears the collection of LogicalStorageBlock objects for this Logical StorageBlock. Provided to allow applications to explicitely drop references to child LogicalStorageBlock objects. Please note that subsequent invocations of get/load/add/remove methods will reload the collection.

addLogicalStorageBlock public void addLogicalStorageBlock(LogicalStorageBlock logicalStorageBlock) Adds the specified LogicalStorageBlock to the collection of LogicalStorageBlock objects for this LogicalStorageBlock.

removeLogicalStorageBlock public void removeLogicalStorageBlock(LogicalStorageBlock logicalStorageBlock) Removes the specified LogicalStorageBlock from the collection of LogicalStorageBlock objects for this LogicalStorageBlock.

getLogicalStorageBlock public LogicalStorageBlock getLogicalStorageBlock(Dbid id) Returns the LogicalStorageBlock with the specified ID in the collection of LogicalStorageBlock objects for this LogicalStorageBlock.

getLogicalStorageBlockListByRootStorageConsumer public static StorableList getLogicalStorageBlockListByRootStorageConsumer(StorageCo nsumer rootStorageConsumer) Returns a list, sorted in no particular order, of LogicalStorageBlock objects which have the rootStorageConsumer of the specified value.

getByRootStorageConsumer public static StorableList getByRootStorageConsumer(StorageConsumer rootStorageConsumer) Deprecated. Returns the LogicalStorageBlock which has the rootStorageConsumer of the specified value.

getLogicalStorageBlockListByRootLogicalStorageBlock public static StorableList getLogicalStorageBlockListByRootLogicalStorageBlock(Logic alStorageBlock rootLogicalStorageBlock) Returns a list, sorted in no particular order, of LogicalStorageBlock objects which have the rootLogicalStorageBlock of the specified value.

getByRootLogicalStorageBlock public static StorableList getByRootLogicalStorageBlock(LogicalStorageBlock rootLogicalStorageBlock) Deprecated. Returns the LogicalStorageBlock which has the rootLogicalStorageBlock of the specified value.

Immediately following is a sample template related to the LSB DO 406 of FIG. 4, and corresponding to the immediately preceding JAVA document (class LogicalStorageBlock).

```
//--------------------------------------------------------------------------
// Copyright 1999-2002 Hewlett-Packard Co., All Rights Reserved.
//--------------------------------------------------------------------------
/**
* LogicalStorageBlocks are an OVSAM concept that represents the
complex mapping
* performed by volume managers between the logical and physical
volumes. An
* LogicalStorageBlock represents the aggregation of a number of
storage blocks
* (physical or logical) with a particular relationship to create a logical
piece
* of storage which can be used to create a storage consumer or to
create another
* logical storage block. This representation facilitates modeling of
different
* configurations that are possible under different logical volume
managers,
* such as LVM, VxVM, LDM, etc.
*/
public final class LogicalStorageBlock extends StorableObject {
  /**
    * A logical storage block type that indicates the block is neither
mirrored
    * or striped.
    */
  public static final int DIRECT = 1;
  /** A logical storage block type that indicates the block is mirrored.
*/
  public static final int MIRROR = 2;
  /** A logical storage block type that indicates the block is striped.
*/
  public static final int STRIPE = 3;
  /**
    * A logical storage block type that indicates the block is RAID-5.
    */
  public static final int RAID_5 = 4;
  /**
    * A logical storage block type that indicates it exists in some
‘unknown’
    * state in regards to how data is stored.
    */
  public static final int UNKNOWN = 0;
  /**
    * The method used to organize and store data on the
LogicalStorageBlock.
    * This may correspond to one of three values: DIRECT, MIRROR,
AND DIRECT.
    */
  protected int type;
  /**
    * Any count information associated with a type. Typically the
number of mirrors
    * or the level or RAID.
    */
  protected int typeCount;
  /**
    * The name associated with this logical storage block by the
volume
    * manager.
    */
  protected String name;
  /**
    * Total storage capacity of this logical storage block. Note that this
    * will be equal or less than the sum of the children logical storage
blocks
    * or physical storage blocks total storage capacity.
    */
  protected double capacity;
  /** The {@link StorageConsumer StorageConsumer} parent of this
LogicalStorageBlock.
    * This will be null if the parent of this LogicalStorageBlock is
another
    * LogicalStorageBlock.
    */
  // ::getBy unsorted rootStorageConsumer
  protected StorageConsumer rootStorageConsumer;
  /** The physical storage block's associated with the logical storage
block.*/
  // ::relate LogicalStorageBlock physicalStorageBlocks
PhysicalStorageBlock logicalStorageBlock
  protected transient StorableMap physicalStorageBlocks;
  /** Logical storage blocks that are contained within this storage
block. */
  // ::relate LogicalStorageBlock logicalStorageBlocks
LogicalStorageBlock rootLogicalStorageBlock
  protected transient StorableMap logicalStorageBlocks = null;
  /**
    * Parent {@link LogicalStorageBlock LogicalStorageBlock}. Used
when logical storage
    * blocks comprised of several other logical storage blocks. This will
be null if
    * the parent of this LogicalStorageBlock is a
    * {@link StorageConsumer StorageConsumer}.
    */
  // ::getBy unsorted rootLogicalStorageBlock
  protected LogicalStorageBlock rootLogicalStorageBlock;
  /**
    * Creates a logical storage block that is not associated with either
    * a storage consumer or a logical storage block.
    *
    * @param name The name used by the volume manager to refer to
this logical
    * storage block.
    * @param capacity The capacity in bytes of this logical storage
block.
    * @param type The type associated with this logical storage block
corresponding
    * to one of the type constants defined with this class.
    * @param typeCount The total number associated with the type.
For example if
    * the type is MIRROR the type count would correspond to the total
number of
    * mirrors, or if the type was RAID the type could would correspond
to the
    * RAID level.
    */
  public LogicalStorageBlock(String name, double capacity, int type,
```

int typeCount) {
super( );
this.name = name;
this.rootLogicalStorageBlock = null;
this.rootStorageConsumer = null;
this.capacity = capacity;
this.type = type;
this.typeCount = typeCount;

```
  }
  /**
    * Creates a logical storage block which will represent a leaf-node of
a
    * logical storage block tree hierarchy.
    *
    * @param name The name used by the volume manager to refer to
this logical
    * storage block.
    * @param logicalStorageBlock The parent of this logical storage
block.
    * @param capacity The capacity in bytes of this logical storage
block.
    * @param type The type associated with this logical storage block
corresponding
    * to one of the type constants defined with this class.
    * @param typeCount The total number associated with the type.
For example if
    * the type is MIRROR the type count would correspond to the total
number of
    * mirrors, or if the type was RAID the type could would correspond
to the
    * RAID level.
    */
  public LogicalStorageBlock (String name, LogicalStorageBlock
logicalStorageBlock,
```

double capacity, int type, int typeCount) {

super( );
this.name = name;
this.rootLogicalStorageBlock = logicalStorageBlock;
this.rootStorageConsumer = null;
this.capacity = capacity;
this.type = type;
this.typeCount = typeCount;
/* ::post-compile
if (logicalStorageBlock != null) {
logicalStorageBlock. addLogicalStorageBlock(this);
}
::post-compile */

```
  }
  /**
    * Creates a logical storage block which will represent the root of a
    * logical storage block tree hierarchy.
    *
    * @param name The name used by the volume manager to refer to
this logical
    * storage block.
    * @param storageConsumer The parent storage consumer for this
logical storage
    * block.
    * @param capacity The capacity in bytes of this logical storage
block.
    * @param type The type associated with this logical storage block
corresponding
    * to one of the type constants defined with this class.
    * @param typeCount The total number associated with the type.
For example if
    * the type is MIRROR the type count would correspond to the total
number of
    * mirrors, or if the type was RAID the type could would correspond
to the
    * RAID level.
    */
  public LogicalStorageBlock (String name, StorageConsumer
storageConsumer,
```

double capacity, int type, int typeCount) {

super( );
this.name = name;
this.rootLogicalStorageBlock = null;
this.rootStorageConsumer = storageConsumer;
this.capacity = capacity;
this.type = type;
this.typeCount = typeCount;
/* ::post-compile
if (storageConsumer != null) {
storageConsumer.addLogicalStorageBlock(this);
}
::post-compile */

```
  }
  /**
    * Retrieves all of the PhysicalStorageBlocks associated with a
particular
    * LogicalStorageBlock. This includes not only physical blocks
directly
    * associated with child LogicalStorageBlocks of the
StorageConsumer,
    * but also there child LogicalStorageBlocks's associated
    * PhysicalStorageBlocks.
    *
    * @return A map of all of the physical blocks associated with this
    * logical block.
    */
  /* ::post-compile
  public StorableMap getAllPhysicalStorageBlocks( ) {
```

return getAllPhysicalBlocks(this);

```
  }
  ::post-compile */
  /**
    * Recursive call that gets all of the PhysicalStorageBlocks
associated
    * with a particular LogicalStorageBlock. This includes no only
physical
    * blocks directly associated with the LogicalStorageBlock but also
    * associated with any child logical storage blocks.
    *
    * @param logicalBlock The logical storage block for which all
physical
    * storage blocks should be retreived. This must be a non-null
value.
    *
    * @return A map of all of the physical blocks associated with this
    * logical block.
    *
    * @throws NullPointerException If the given logical block is a null.
    */
  /* ::post-compile
  private StorableMap getAllPhysicalBlocks(LogicalStorageBlock
logicalBlock) {
```

```
StorableMap physicalBlocks = new StorableMap( );
Iterator childLogicalBlocks =
  logicalBlock.getLogicalStorageBlocks( ).iterator( );
while(childLogicalBlocks.hasNext( )) {
  StorableMap childPhysicalBlocks =
```

getAllPhysicalBlocks((LogicalStorageBlock)

childLogicalBlocks.next( ));

physicalBlocks.ImportCollection(childPhysicalBlocks);
}
physicalBlocks.importCollection(logicalBlock.

getPhysicalStorageBlocks( ));

return physicalBlocks;

```
  }
  ::post-compile */
  /** Returns the string image of this object. */
  /* ::post-compile
  public String toString( ) {
```

return “logical storage block ” + getName( );

```
  } // toString
  ::post-compile */
} // LogicalStorageBlock
```

Immediately following is a JAVA document (referred to as class PhysicalStorageBlock) corresponding to the PSB DO 408 of FIG. 4.

com.hp.sanmgr.model Class PhysicalStorageBlock

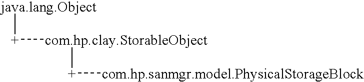

public final class PhysicalStorageBlock extends StorableObject

The physical portion of a slice of storage on a LUN that is the physical component of a logical volume managed by a volume manager. Physical storage blocks are contiguous blocks of physical extents that reside on a HostLogicalUnit. PhysicalStorageBlocks comprise a LogicalStorageBlock which is a virtualization of storage makes up a StorageConsumer.

Field Summary

| | |
|---|---|
| protected | hostLogicalUnit |
| HostLogicalUnit | The host logical unit that this block is a part of. |
| static String | HOSTLOGICALUNIT_FIELD |
| | Constant representing the name of the |
| | hostLogicalUnit field. |
| protected | logicalStorageBlock |
| LogicalStorageBlock | The logical storage block |
| static String | LOGICALSTORAGEBLOCK_FIELD |
| | Constant representing the name of the |
| | logicalStorageBlock field. |
| protected String | name |
| | The name associated with this physical storage |
| | block by the volume manager. |
| static String | NAME_FIELD |
| | Constant representing the name of the name |
| | field. |
| static String | PHYSICALSTORAGEBLOCK_ID_FIELD |
| | Constant representing the name of the |
| | PhysicalStorageBlock field. |
| protected double | size |
| | The physical capacity of the slice on a LUN that |
| | this the storage block represents. |
| static String | SIZE_FIELD |
| | Constant representing the name of the size field. |

Fields inherited from class com.hp.clay.StorableObject

blWritable, CACHED_OBJECTS,
NON_STORABLE_MASK,
NOT_STORED, PACKAGE_PREFIX,
ROOT_CLASS_NAME,
ROOT_CLASS_PREFIX, STORED_AS_BOOLEAN,
STORED_AS_COLLECTION, STORED_AS_DATE,
STORED_AS_DOUBLE,
STORED_AS_FLOAT, STORED_AS_INTEGER,
STORED_AS_LONG,
STORED_AS_REFERENCE, STORED_AS_STRING,
STORED_AS_TRANSIENT_COLLECTION,
STORED_OBJECTS,
XML_ATTRIBUTES_AS_ATTRIBUTES,
XML_EXPAND_AGGREGATE_REFERENCES,
XML_EXPAND_ATTRIBUTE_REFERENCES,
XML_EXPAND_SINGULAR_REFERENCES,
XML_ID_AS_ENTITIES,
XML_INCLUDE_REFERENCED_OBJECTS,
XML_SUPPRESS_ID_ATTRIBUTES,
XML_SUPPRESS_XREF_ATTRIBUTES,
XML_USE_TYPE_SPECIFIC_ENTITIES

Constructor Summary

| | |
|---|---|
| | PhysicalStorageBlock( ) |
| | Default constructor. |
| protected | PhysicalStorageBlock(Dbid dbid) |
| | Constructor used internally for loading. |
| | PhysicalStorageBlock(HostLogicalUnit |
| | hostLogicalUnit, double size) |
| | Creates a new PhysicalStorageBlock that |
| | is not associated with any logical storage |
| | unit initially. |
| | PhysicalStorageBlock(HostLogicalUnit |
| | hostLogicalUnit, LogicalStorageBlock |
| | logicalStorageBlock, String name, double size) |
| | Creates a new PhysicalStorageBlock associated |
| | with the given host logical unit and logical |
| | storage block. |

Method Summary

| | |
|---|---|
| static | getByHostLogicalUnit(HostLogicalUnit |
| StorableList | hostLogicalUnit) |
| | Deprecated. Returns the |
| | PhysicalStorageBlock which has the hostLogicalUnit |
| | of the specified value. |
| static | getByLogicalStorageBlock(LogicalStorageBlock |
| StorableList | logicalStorageBlock) |
| | Deprecated. Returns the |
| | PhysicalStorageBlock which has the |
| | logicalStorageBlock of the specified value. |
| Host- | getHostLogicalUnit( ) |
| LogicalUnit | Returns the value of the hostLogicalUnit |
| | property. |
| Logical- | getLogicalStorageBlock( ) |
| Storage- | Returns the value of the logicalStorageBlock |
| Block | property. |
| String | getName( ) |
| | Returns the value of the name property. |
| static | getPhysicalStorageBlockListByHostLogicalUnit |
| StorableList | (HostLogicalUnit hostLogicalUnit) |
| | Returns a list, sorted in no particular order, of |
| | PhysicalStorageBlock objects which have the |
| | hostLogicalUnit of the specified value. |
| static | getPhysicalStorageBlockListByLogicalStorageBlock |
| StorableList | (LogicalStorageBlock logicalStorageBlock) |
| | Returns a list, sorted in no particular order, of |
| | PhysicalStorageBlock objects which have the |
| | logicalStorageBlock of the specified value. |
| double | getSize( ) |
| | Returns the value of the size property. |
| protected | prepareDelete(ConnectionContext |
| Cached- | context) |
| Prepared- | This method must be provided in order for the |
| Statement | PhysicalStorageBlock object to become storable, i.e. |
| protected | prepareInsert(ConnectionContext |
| Cached- | context) |
| Prepared- | This method must be provided in order for the |
| Statement | PhysicalStorageBlock object to become storable, i.e. |
| protected | prepareSelect(ConnectionContext |
| Cached- | context) |
| Prepared- | This method must be provided in order for the |
| Statement | PhysicalStorageBlock object to become storable, i.e. |
| void | setHostLogicalUnit(HostLogicalUnit |
| | hostLogicalUnit) |
| | Sets the HostLogicalUnit property to the |
| | specified value. |
| void | setLogicalStorageBlock(LogicalStorageBlock |
| | logicalStorageBlock) |
| | Sets the LogicalStorageBlock property to the |
| | specified value. |
| void | setName(String name) |
| | Sets the Name property to the specified value. |
| void | setSize(double size) |
| | Sets the Size property to the specified value. |
| String | toDebugString( ) |
| | Returns a string image of the the specified |
| | PhysicalStorageBlock. |
| String | toDebugString(String indent) |
| | Returns the debug string image of the object |
| | indented using the specified indent string. |
| String | toDebugString(String indent, Vector |
| | callTree) |
| | Returns an indented string image of the the |
| | specified PhysicalStorageBlock. |
| String | toString( ) |
| | Returns the string image of this object. |

Methods inherited from class com.hp.clay.StorableObject

http://srmlab.rose.hp.com/java-api/sanmgr/com/hp/
clay/StorableObject.html -
<clinit>( ), addAttribute, addDependentObjects,
attributesLoaded, cacheOnly, decode, delete, delete,
deleteDependentObjects, deleteObject,
deleteThisObjectFromCacheUnderPenaltyOfDeath,
enableZombieMonitor, encode, equals, error, error, error,
error, executeQuery, flushAttributes,
getAbstractModelClasses, getAttribute, getAttributeCount,
getAttributes, getAttributesLike, getByAttribute,
getByAttribute, getByAttribute, getClassLoader,
getConcreteModelClasses, getCount, getCount, getCount,
getDbid, getDirtyFields, getFindOrCreateLock,
getFromCache, getFromCache, getFromCache, getLock,
getLock, getModelClasses, getObjectClass,
getReferringObjectsIterator, getRelationshipIterator,
getResourceBundle, getSum, getSum, getSum, getSum,
getSum, getTransientAttributes, hashCode, isDirty,
isFieldDirty, isLoaded, isModelClass, isZombie, load,
load, load, load, load, loadAll, loadAll, loadAll,
loadAll, loadAllAttributes, loadAllIterator,
loadAllIterator, loadAttributes, loadModelClassCatalogue,
loadReferringObjects, loadRelationship, putIntoCache,
releaseFindOrCreateLock, releaseLock,
removeAllAttributes, removeAllTransientAttributes,
removeAttribute, removeAttribute, removeFromCache,
setAccessible, setAttributesDirty, setClassLoader,
setClean, setDirty, setFieldDirty, setFieldDirty,
setResourceBundle, settingDbidUnderPenaltyOfDeath,
setWasCreated, store, storeAttributes,
storeClassSpecifics, storeDirtyObjects, toString,
wasCreated, writeXML, writeXML, writeXML, writeXML

Methods inherited from class java.lang.Object

clone, finalize, getClass, notify, notifyAll, wait, wait,
wait

Field Detail

name protected String name The name associated with this physical storage block by the volume manager.

hostLogicalUnit protected HostLogicalUnit hostLogicalUnit The host logical unit that this block is a part of.

logicalStorageBlock protected LogicalStorageBlock logicalStorageBlock The logical storage block

size protected double size The physical capacity of the slice on a LUN that this the storage block represents. This value is in bytes.

PHYSICALSTORAGEBLOCK_ID_FIELD public static final String PHYSICALSTORAGEBLOCK_ID_FIELD Constant representing the name of the PhysicalStorageBlock field.

NAME_FIELD public static final String NAME_FIELD Constant representing the name of the name field.

HOSTLOGICALUNIT_FIELD public static final String HOSTLOGICALUNIT_FIELD Constant representing the name of the hostLogicalUnit field.

LOGICALSTORAGEBLOCK_FIELD public static final String LOGICALSTORAGEBLOCK_FIELD Constant representing the name of the logicalStorageBlock field.

SIZE_FIELD public static final String SIZE_FIELD Constant representing the name of the size field.

-Constructor Detail PhysicalStorageBlock public PhysicalStorageBlock( ) Default constructor.

PhysicalStorageBlock protected PhysicalStorageBlock(Dbid dbid) Constructor used internally for loading.

PhysicalStorageBlock public PhysicalStorageBlock(HostLogicalUnit hostLogicalUnit, LogicalStorageBlock logicalStorageBlock, String name, double size) Creates a new PhysicalStorageBlock associated with the given host logical unit and logical storage block.

Parameters:

hostLogicalUnit-The host logical unit that this physical storage block is associated with. logicalStorageBlock-The logical storage block that this physical storage block is associated with. name-The name that the volume manager uses to refer to this physical storage block. size-The physical capacity of the slice on a LUN that this physical storage block represents. This is value is in bytes.

PhysicalStorageBlock public PhysicalStorageBlock(HostLogicalUnit hostLogicalUnit, double size) Creates a new PhysicalStorageBlock that is not associated with any logical storage unit initially. The physical storage block must be added to the appropriate logical storage unit should be aassociated with the given host logical unit and logical storage block.

Parameters: nostLogicalUnit-The host logical unit that this physical storage block is associated with. logicalStorageBlock-The logical storage block that this physical storage block is associated with. size-The physical capacity of the slice on a LUN that this physical storage block represents. This is value is in bytes. UniqueId-The unique id of this physical storage block.

toString public String toString( ) Returns the string image of this object.

Overrides:

toString in class StorableObject

prepareInsert protected CachedPreparedStatement prepareInsert(ConnectionContext context) throws SQLException This method must be provided in order for the Physical StorageBlock object to become storable, i.e. so it can be added to the database.

Overrides:

prepareInsert in class StorableObject

prepareDelete protected CachedPreparedStatement prepareDelete(ConnectionContext context) throws SQLException This method must be provided in order for the PhysicalStorageBlock object to become storable, i.e. so it can be deleted from the database.

Overrides:

prepareDelete in class StorableObject

prepareSelect protected CachedPreparedStatement prepareSelect(ConnectionContext context) throws SQLException This method must be provided in order for the PhysicalStorageBlock object to become storable, i.e. so it can be retrieved from the database.

Overrides:

prepareSelect in class StorableObject

getName public String getName( ) Returns the value of the name property.

setName public void setName(String name) Sets the Name property to the specified value.

getHostLogicalUnit public HostLogicalUnit getHostLogicalUnit( ) Returns the value of the hostLogicalUnit property.

setHostLogicalUnit public void setHostLogicalUnit(HostLogicalUnit hostLogicalUnit) Sets the HostLogicalUnit property to the specified value. Note that this should not be used as a means to add this object to the list of children of the HostLogicalUnit parent. An appropriate call to addPhysicalStorageBlock, if available, should be made on the HostLogicalUnit parent object instead.

getLogicalStorageBlock public LogicalStorageBlock getLogicalStorageBlock( ) Returns the value of the logicalStorageBlock property.

setLogicalStorageBlock public void setLogicalStorageBlock(LogicalStorageBlock logicalStorageBlock) Sets the LogicalStorageBlock property to the specified value. Note that this should not be used as a means to add this object to the list of children of the LogicalStorageBlock parent. An appropriate call to addPhysicalStorageBlock, if available, should be made on the LogicalStorageBlock parent object instead.

getSize public double getSize( ) Returns the value of the size property.

setSize public void setSize(double size) Sets the Size property to the specified value.

toDebugString public String toDebugString( ) Returns a string image of the the specified PhysicalStorageBlock.

Overrides:

toDebugString in class StorableObject

toDebugString public String toDebugString(String indent) Description copied from class: StorableObject Returns the debug string image of the object indented using the specified indent string.

Overrides:

toDebugString in class StorableObject

toDebugString public String toDebugString(String indent, Vector callTree) Returns an indented string image of the the specified PhysicalStorageBlock.

Overrides:

toDebugString in class StorableObject

getPhysicalStorageBlockListByHostLogicalUnit public static StorableList getPhysicalStorageBlockListByHostLogicalUnit(HostLogicalU nit hostLogicalUnit) Returns a list, sorted in no particular order, of Physical StorageBlock objects which have the hostLogicalUnit of the specified value.

getByHostLogicalUnit public static StorableList getByHostLogicalUnit(HostLogicalUnit hostLogicalUnit) Deprecated. Returns the PhysicalStorageBlock which has the hostLogical Unit of the specified value.

getPhysicalStorageBlockListByLogicalStorageBlock public static StorableList getPhysicalStorageBlockListByLogicalStorageBlock(LogicalS torageBlock logicalStorageBlock) Returns a list, sorted in no particular order, of PhysicalStorageBlock objects which have the logicalStorageBlock of the specified value.

getByLogicalStorageBlock public static StorableList getByLogicalStorageBlock(LogicalStorageBlock logicalStorageBlock) Deprecated. Returns the PhysicalStorageBlock which has the logicalStorageBlock of the specified value.

Immediately following is a sample template related to the PSB DO 408 of FIG. 4, and corresponding to the immediately preceding JAVA document (class PhysicalStorageBlock).

```
//--------------------------------------------------------------------------
// Copyright 2002 Hewlett-Packard Co., All Rights Reserved.
//--------------------------------------------------------------------------
/**
* The physical portion of a slice of storage on a LUN that is the
physical
* component of a logical volume managed by a volume manager.
Physical
* storage blocks are contiguous blocks of physical extents that reside
* on a {@link HostLogicalUnit HostLogicalUnit}. PhysicalStorageBlocks
* comprise a {@link LogicalStorageBlock LogicalStorageBlock} which
is
* a virtualization of storage makes up a
* {@link StorageConsumer StorageConsumer}.
*/
public final class PhysicalStorageBlock extends StorableObject {
  /**
    * The name associated with this physical storage block by the
volume
    * manager.
    */
    protected String name;
    /** The host logical unit that this block is a part of. */
    // ::getBy unsorted hostLogicalUnit
    protected HostLogicalUnit hostLogicalUnit;
    /** The logical storage block */
    // ::getBy unsorted logicalStorageBlock
    protected LogicalStorageBlock logicalStorageBlock;
    /**
    * The physical capacity of the slice on a LUN that this the storage
block
    * represents. This value is in bytes.
    */
    protected double size;
    /**
    * Creates a new PhysicalStorageBlock associated with the
    * given host logical unit and logical storage block.
    *
    * @param hostLogicalUnit The host logical unit that this
    * physical storage block is associated with.
    * @param logicalStorageBlock The logical storage block that
    * this physical storage block is associated with.
    * @param name The name that the volume manager uses to refer
to this
    * physical storage block.
    * @param size The physical capacity of the slice on a LUN that
    * this physical storage block represents. This is value is in
    * bytes.
    */
    public PhysicalStorageBlock(HostLogicalUnit hostLogicalUnit,
```

LogicalStorageBlock logicalStorageBlock,
String name,
double size) {

```
super( );
this.hostLogicalUnit = hostLogicalUnit;
this.logicalStorageBlock = logicalStorageBlock;
this.name = name;
this.size = size;
/* ::post-compile
if (logicalStorageBlock != null) {
    logicalStorageBlock.addPhysicalStorageBlock(this);
}
::post-compile */
/* ::post-compile
if (hostLogicalUnit != null) {
    hostLogicalUnit.addPhysicalStorageBlock(this);
}
::post-compile */
```

```
    }
    /**
    * Creates a new PhysicalStorageBlock that is not associated with
    * any logical storage unit initially. The physical storage block
    * must be added to the appropriate logical storage unit
    * should be associated with the
    * given host logical unit and logical storage block.
    *
    * @param hostLogicalUnit The host logical unit that this
    * physical storage block is associated with.
    * @param logicalStorageBlock The logical storage block that
    * this physical storage block is associated with.
    * @param size The physical capacity of the slice on a LUN that
    * this physical storage block represents. This is value is in
    * bytes.
    * @param uniqueId The unique id of this physical storage block.
    */
    public PhysicalStorageBlock(HostLogicalUnit hostLogicalUnit,
double size) {
```

super( );
this.hostLogicalUnit = hostLogicalUnit;
this.logicalStorageBlock = null;
this.name = null;
this.size = size;
/* ::post-compile
if(hostLogicalUnit != null) {
hostLogicalUnit.addPhysicalStorageBlock(this);
}
::post-compile */

```
    }
    /** Returns the string image of this object. */
    /* ::post-compile
    public String toString( ) {
```

return “physical storage block ” + getName( );

```
    } // toString
    ::post-compile */
}
```

Immediately following is a JAVA document (referred to as class HostLogicalUnit) corresponding to the PSB DO 410 of FIG. 4.

com.hp.sanmgr.model Class HostLogicalUnit

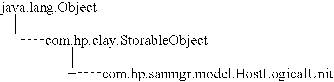

All Implemented Interfaces:

ManagementPathIF public final class HostLogicalUnit extends StorableObject implements ManagementPathIF

Class representing Host's view of a logical unit (LUN). It is associated with an actual logical unit and has properties which characterize how the host sees that LUN. Those properties include hardware path, device file, etc.

Field Summary

| | |
|---|---|
| static int | ALLOCATER_LU_ASSIGNED |
| static int | ALLOCATER_LU_NOT_ASSIGNED |
| static int | ALLOCATER_LU_NOT_CONTROLLED |
| | Values returned from allocaterLunStatus which |
| | describes the allocater filtering state of this |
| | particular host-lu visibility relationship |
| static int | ALLOCATER_UNDEFINED |
| static int | ARRAY_CONTROLLER |
| static int | CDROM_DEVICE |
| static int | COMM_DEVICE |
| protected | deviceFile |
| String | The host-specific device file for this LUN. |
| static String | DEVICEFILE_FIELD |
| | Constant representing the name of the deviceFile |
| | field. |
| static int | DIRECT_ACCESS_DEVICE |
| static int | ENCLOSURE_SERVICES |
| static int | FC_SCSI_MUX |
| static int | FC_SWITCH |
| protected | hbaName |
| String | The hba name that this associated with this LUN |
| static String | HBANAME_FIELD |
| | Constant representing the name of the hbaName |
| | field. |
| static String | HOSTLOGICALUNIT_ID_FIELD |
| | Constant representing the name of the |
| | HostLogicalUnit field. |
| protected | hwPath |
| String | The hardware-path (HBA, Port, etc) encoding. |
| static String | HWPATH_FIELD |
| | Constant representing the name of the hwPath |
| | field. |
| protected | links |
| StorableMap | |
| protected | logicalStoragePools |
| StorableMap | The LogicalStoragePools that are |
| | associated with this HostLogicalUnit. |
| protected | logicalUnit |
| LogicalUnit | The logical unit with which this view is |
| | associated. |
| static String | LOGICALUNIT_FIELD |
| | Constant representing the name of the |
| | logicalUnit field. |
| protected | logicalUnitProvider |
| LogicalUnit- | |
| Provider | |
| static String | LOGICALUNITPROVIDER_FIELD |
| | Constant representing the name of the |
| | logicalUnitProvider field. |
| static int | MEDIUM_CHANGER_DEVICE |
| protected | node |
| Node | The node through which the HLU is |
| | associated with |
| static String | NODE_FIELD |
| | Constant representing the name of the node field. |
| static int | OPTICAL_MEMORY_DEVICE |
| protected | path |
| String | Path to hold non-standard formatted path string, |
| | ie other than: SCSI \| hostname \| devicefile |
| static String | PATH_FIELD |
| | Constant representing the name of the path field. |
| protected int | pathStatus |
| | The path status |
| static String | PATHSTATUS_FIELD |
| | Constant representing the name of the pathStatus |
| | field. |
| protected | physicalStorageBlocks |
| StorableMap | The physical storage block's associated with the |
| | host logical unit. |
| static int | PRINTER_DEVICE |
| protected int | priority |
| | The path priority |
| static String | PRIORITY_FIELD |
| | Constant representing the name of the priority |
| | field. |
| static int | PROCESSOR_DEVICE |
| static int | SCANNER_DEVICE |
| static int | SEQUENTIAL_ACCESS_DEVICE |
| protected | uniqueId |
| String | This is a unique ID |
| static String | UNIQUEID_FIELD |
| | Constant representing the name of the uniqueId |
| | field. |
| static int | UNKNOWN_DEVICE |
| | Some well-known enumerations of different |
| | Host Logical Unit types. |
| static int | WRITE_ONCE_DEVICE |

Fields inherited from class com.hp.clay.StorableObject

blWritable, CACHED_OBJECTS,
NON_STORABLE_MASK,
NOT_STORED, PACKAGE_PREFIX,
ROOT_CLASS_NAME,
ROOT_CLASS_PREFIX, STORED_AS_BOOLEAN,
STORED_AS_COLLECTION, STORED_AS_DATE,
STORED_AS_DOUBLE,
STORED_AS_FLOAT, STORED_AS_INTEGER,
STORED_AS_LONG,
STORED_AS_REFERENCE, STORED_AS_STRING,
STORED_AS_TRANSIENT_COLLECTION,
STORED_OBJECTS,
XML_ATTRIBUTES_AS_ATTRIBUTES,
XML_EXPAND_AGGREGATE_REFERENCES,
XML_EXPAND_ATTRIBUTE_REFERENCES,
XML_EXPAND_SINGULAR_REFERENCES,
XML_ID_AS_ENTITIES,
XML_INCLUDE_REFERENCED_OBJECTS,
XML_SUPPRESS_ID_ATTRIBUTES,
XML_SUPPRESS_XREF_ATTRIBUTES,
XML_USE_TYPE_SPECIFIC_ENTITIES

Fields inherited from interface com.hp.sanmgr.model.ManagementPathIF

DOWN, NOTAPPLICABLE, UNKNOWN, UP

Constructor Summary

| | |
|---|---|
| | HostLogicalUnit( ) |
| | Default constructor. |
| protected | HostLogicalUnit(Dbid dbid) |
| | Constructor used internally for loading. |
| | HostLogicalUnit(LogicalUnitProvider |
| | logicalUnitProvider, LogicalUnit logicalUnit, |
| | String deviceFile, String hwPath, Node node) |
| | Creates a new view of the given logical unit |
| | with the specified parameters. |

Method Summary

| | |
|---|---|
| void | addLink(Link link) |
| | Adds the specified Link to the |
| | collection of Link objects for this |
| | HostLogicalUnit. |
| void | addLogicalStoragePool(LogicalStoragePool |
| | logicalStoragePool) |
| | Adds the specified |
| | LogicalStoragePool to the collection of |
| | LogicalStoragePool objects for this |
| | HostLogicalUnit. |
| void | addPhysicalStorageBlock(PhysicalStorageBlock |
| | physicalStorageBlock) |
| | Adds the specified |
| | PhysicalStorageBlock to the collection |
| | of PhysicalStorageBlock objects for this |
| | HostLogicalUnit. |
| int | allocaterLunStatus( ) |
| | Provides the allocater filtering |
| | status for this particular Host-LU |
| | visibility relationship |
| void | clearLinks( ) |
| | Clears the collection of Link |
| | objects for this HostLogicalUnit. |
| void | clearLogicalStoragePools( ) |
| | Clears the collection of |
| | LogicalStoragePool objects for this |
| | HostLogicalUnit. |
| void | clearPhysicalStorageBlocks( ) |
| | Clears the collection of |
| | PhysicalStorageBlock objects for this |
| | HostLogicalUnit. |
| static | findOrCreate(String |
| Host- | uniqueId) |
| LogicalUnit | Deprecated. Returns an |
| | instance of the HostLogicalUnit class. |
| | The object is either found using either of |
| | the specified unique parameters or is |
| | created using all of those unique |
| | parameters. This is performed as an |
| | atomic operation within the bounds of |
| | the same connection context. |
| static | findOrCreateHostLogicalUnit(String uniqueId) |
| Host- | Returns an instance of the |
| LogicalUnit | HostLogicalUnit class. |
| static | getByDeviceFile(String |
| StorableList | deviceFile) |
| | Deprecated. Returns the |
| | HostLogicalUnit which has the |
| | deviceFile of the specified value. |
| static | getByHbaName(String |
| StorableList | hbaName) |
| | Deprecated. Returns the |
| | HostLogicalUnit which has the |
| | hbaName of the specified value. |
| static | getByLogicalUnit(LogicalUnit |
| StorableList | logicalUnit) |
| | Deprecated. Returns the |
| | HostLogicalUnit which has the |
| | logicalUnit of the specified value. |
| static | getByLogicalUnitProvider(LogicalUnitProvider |
| StorableList | logicalUnitProvider) |
| | Deprecated. Returns the |
| | HostLogicalUnit which has the |
| | logicalUnitProvider of the specified |
| | value. |
| static | getByUniqueId(String |
| Host- | uniqueId) |
| LogicalUnit | Deprecated. Returns the |
| | HostLogicalUnit which has the |
| | uniqueId of the specified value. |
| Device | getDevice( ) |
| | Helper method that will return |
| | the Device referencing this |
| String | getDeviceFile( ) |
| | Returns the value of the |
| | deviceFile property. |
| String | getHbaName( ) |
| | Returns the value of the |
| | hbaName property. |
| Host | getHost( ) |
| | Helper method that will retrieve |
| | the Host via the Node |
| static | getHostLogicalUnit(SystemDevice |
| Host- | device, String deviceFile) |
| LogicalUnit | Gets the HostLogicalUnit for the |
| | given system device and device file. |
| static | getHostLogicalUnitByUniqueId(String |
| Host- | uniqueId) |
| LogicalUnit | Returns the HostLogicalUnit |
| | which has the uniqueId of the specified |
| | value. |
| static | getHostLogicalUnitListByDeviceFile |
| StorableList | (String deviceFile) |
| | Returns a list, sorted in no |
| | particular order, of HostLogicalUnit |
| | objects which have the deviceFile of the |
| | specified value. |
| static | getHostLogicalUnitListByHbaName |
| StorableList | (String hbaName) |
| | Returns a list, sorted in no |
| | particular order, of HostLogicalUnit |
| | objects which have the hbaName of the |
| | specified value. |
| static | getHostLogicalUnitListByLogicalUnit |
| StorableList | (LogicalUnit logicalUnit) |
| | Returns a list, sorted in no |
| | particular order, of HostLogicalUnit |
| | objects which have the logicalUnit of |
| | the specified value. |
| static | getHostLogicalUnitListByLogicalUnitProvider |
| StorableList | (LogicalUnitProvider logicalUnit Provider) |
| | Returns a list, sorted in no |
| | particular order, of HostLogicalUnit |
| | objects which have the |
| | logicalUnitProvider of the specified |
| | value. |
| String | getHwPath( ) |
| | Returns the value of the hwPath |
| | property. |
| Link | getLink(Dbid id) |
| | Returns the Link with the |
| | specified ID in the collection of Link |
| | objects for this HostLogicalUnit. |
| StorableMap | getLinks( ) |
| | Returns the collection of Link |
| | objects for this HostLogicalUnit. |
| Storable- | getLinksIterator( ) |
| Iterator | Returns the collection of Link |
| | objects for this HostLogicalUnit. |
| Storable- | getLinksIterator(String |
| Iterator | sortFieldName, boolean |
| | isAscending) |
| | Returns the collection of Link |
| | objects for this HostLogicalUnit. |
| Logical- | getLogicalStoragePool(Dbid |
| StoragePool | id) |
| | Returns the LogicalStoragePool |
| | with the specified ID in the collection of |
| | LogicalStoragePool objects for this |
| | HostLogicalUnit. |
| StorableMap | getLogicalStoragePools( ) |
| | Returns the collection of |
| | LogicalStoragePool objects for this |
| | HostLogicalUnit. |
| Storable- | getLogicalStoragePoolsIterator( ) |
| Iterator | Returns the collection of |
| | LogicalStoragePool objects for this |
| | HostLogicalUnit. |
| Storable- | getLogicalStoragePoolsIterator(String |
| Iterator | sortFieldName, boolean isAscending) |
| | Returns the collection of |
| | LogicalStoragePool objects for this |
| | HostLogicalUnit. |
| LogicalUnit | getLogicalUnit( ) |
| | Returns the value of the |
| | logicalUnit property. |
| LogicalUnit- | getLogicalUnitProvider( ) |
| Provider | Returns the value of the |
| | logicalUnitProvider property. |
| Node | getNode( ) |
| | Returns the value of the node |
| | property. |
| String | getPath( ) |
| | Returns the value of the path |
| | property. |
| int | getPathStatus( ) |
| | Returns the value of the |
| | pathStatus property. |
| Physical- | getPhysicalStorageBlock(Dbid id) |
| Storage- | Returns the |
| Block | PhysicalStorageBlock with the specified |
| | ID in the collection of |
| | PhysicalStorageBlock objects for this |
| | HostLogicalUnit. |
| StorableMap | getPhysicalStorageBlocks( ) |
| | Returns the collection of |
| | PhysicalStorageBlock objects for this |
| | HostLogicalUnit. |
| Storable- | getPhysicalStorageBlocksIterator( ) |
| Iterator | Returns the collection of |
| | PhysicalStorageBlock objects for this |
| | HostLogicalUnit. |
| Storable- | getPhysicalStorageBlocksIterator(String |
| Iterator | sortFieldName, boolean isAscending) |
| | Returns the collection of |
| | PhysicalStorageBlock objects for this |
| | HostLogicalUnit. |
| int | getPriority( ) |
| | Returns the value of the priority |
| | property. |
| String | getUniqueId( ) |
| | Returns the value of the |
| | uniqueId property. |
| StorableMap | loadLinks( ) |
| | Loads and returns the collection |
| | of Link objects for this |
| | HostLogicalUnit. |
| StorableMap | loadLogicalStoragePools( ) |
| | Loads and returns the collection |
| | of LogicalStoragePool objects for this |
| | HostLogicalUnit. |
| StorableMap | loadPhysicalStorageBlocks( ) |
| | Loads and returns the collection |
| | of PhysicalStorageBlock objects for this |
| | HostLogicalUnit. |
| protected | prepareDelete(ConnectionContext |
| Cached- | context) |
| Prepared- | This method must be provided in |
| Statement | order for the HostLogicalUnit object to |
| | become storable, i.e. |
| protected | prepareInsert(ConnectionContext |
| Cached- | context) |
| Prepared- | This method must be provided in |
| Statement | order for the HostLogicalUnit object to |
| | become storable, i.e. |
| protected | prepareSelect(ConnectionContext |
| Cached- | context) |
| Prepared- | This method must be provided in |
| Statement | order for the HostLogicalUnit object to |
| | become storable, i.e. |
| void | removeLink(Link link) |
| | Removes the specified Link |
| | from the collection of Link objects for |
| | this HostLogicalUnit. |
| void | removeLogicalStoragePool(LogicalStoragePool |
| | logicalStoragePool) |
| | Removes the specified |
| | LogicalStoragePool from the collection |
| | of LogicalStoragePool objects for this |
| | HostLogicalUnit. |
| void | removePhysicalStorageBlock(PhysicalStorageBlock |
| | PhysicalStorageBlock) |
| | Removes the specified |
| | PhysicalStorageBlock from the |
| | collection of PhysicalStorageBlock |
| | objects for this HostLogicalUnit. |
| void | setDeviceFile(String |
| | deviceFile) |
| | Sets the DeviceFile property to |
| | the specified value. |
| void | setHbaName(String hbaName) |
| | Sets the HbaName property to |
| | the specified value. |
| void | setHwPath(String hwPath) |
| | Sets the HwPath property to the |
| | specified value. |
| void | setLogicalUnit(LogicalUnit |
| | logicalUnit) |
| | Sets the LogicalUnit property to |
| | the specified value. |
| void | setLogicalUnitProvider(LogicalUnitProvider |
| | logicalUnitProvider) |
| | Sets the LogicalUnitProvider |
| | property to the specified value. |
| void | setNode(Node node) |
| | Sets the Node property to the |
| | specified value. |
| void | setPath(String path) |
| | Sets the Path property to the |
| | specified value. |
| void | setPathStatus(int pathStatus) |
| | Sets the PathStatus property to |
| | the specified value. |
| void | setPriority(int priority) |
| | Sets the Priority property to the |
| | specified value. |
| void | setUniqueId(String |
| | uniqueId) |
| | Sets the UniqueId property to |
| | the specified value. |
| String | toDebugString( ) |
| | Returns a string image of the the |
| | specified HostLogicalUnit. |
| String | toDebugString(String |
| | indent) |
| | Returns the debug string image |
| | of the object indented using the |
| | specified indent string. |
| String | toDebugString(String |
| | indent, Vector callTree) |
| | Returns an indented string image |
| | of the the specified HostLogicalUnit. |
| String | toString( ) |
| | Returns the string image of this |
| | object. |

Methods inherited from class com.hp.clay.StorableObject

http://srmlab.rose.hp.com/java-api/sanmgr/com/hp/clay/StorableObject.html -
<clinit>( ), addAttribute, addDependentObjects,
attributesLoaded, cacheOnly, decode, delete, delete,
deleteDependentObjects, deleteObject,
deleteThisObjectFromCacheUnderPenaltyOfDeath,
enableZombieMonitor, encode, equals, error, error, error,
error, executeQuery, flushAttributes,
getAbstractModelClasses, getAttribute, getAttributeCount,
getAttributes, getAttributesLike, getByAttribute,
getByAttribute, getByAttribute, getClassLoader,
getConcreteModelClasses, getCount, getCount, getCount,
getDbid, getDirtyFields, getFindOrCreateLock,
getFromCache, getFromCache, getFromCache, getLock,
getLock, getModelClasses, getObjectClass,
getReferringObjectsIterator, getRelationshipIterator,
getResourceBundle, getSum, getSum, getSum, getSum,
getSum, getTransientAttributes, hashCode, isDirty,
isFieldDirty, isLoaded, isModelClass, isZombie, load,
load, load, load, load, loadAll, loadAll, loadAll,
loadAll, loadAllAttributes, loadAllIterator,
loadAllIterator, loadAttributes, loadModelClassCatalogue,
loadReferringObjects, loadRelationship, putIntoCache,
releaseFindOrCreateLock, releaseLock,
removeAllAttributes, removeAllTransientAttributes,
removeAttribute, removeAttribute, removeFromCache,
setAccessible, setAttributesDirty, setClassLoader,
setClean, setDirty, setFieldDirty, setFieldDirty,
setResourceBundle, settingDbidUnderPenaltyOfDeath,
setWasCreated, store, storeAttributes,
storeClassSpecifics, storeDirtyObjects, toString,
wasCreated, writeXML, writeXML, writeXML, writeXML

Methods inherited from class java.lang.Object

clone, finalize, getClass, notify, notifyAll, wait, wait,
wait

Field Detail

UNKNOWN_DEVICE public static final int UNKNOWN_DEVICE Some well-known enumerations of different Host Logical Unit types. These names are taken from the Dial External Interface Doc for DeviceType setting of the LunEntity.

DIRECT_ACCESS_DEVICE public static final int DIRECT_ACCESS_DEVICE

SEQUENTIAL_ACCESS_DEVICE public static final int SEQUENTIAL_ACCESS_DEVICE

PRINTER_DEVICE public static final int PRINTER_DEVICE

PROCESSOR_DEVICE public static final int PROCESSOR_DEVICE

WRITE_ONCE_DEVICE public static final int WRITE_ONCE_DEVICE

CDROM_DEVICE public static final int CDROM_DEVICE

SCANNER_DEVICE public static final int SCANNER_DEVICE

OPTICAL_MEMORY_DEVICE public static final int OPTICAL_MEMORY_DEVICE

MEDIUM_CHANGER_DEVICE public static final int MEDIUM_CHANGER_DEVICE

COMM_DEVICE public static final int COMM_DEVICE

ARRAY_CONTROLLER public static final int ARRAY-CONTROLLER

ENCLOSURE_SERVICES public static final int ENCLOSURE_SERVICES

FC_SCSI_MUX public static final int FC_SCSI_NUX

FC_SWITCH public static final int FC_SWITCH

ALLOCATER_LU_NOT_CONTROLLED public static final int ALLOCATER_LU_NOT_CONTROLLED Values returned from allocaterLunStatus which describes the allocater filtering state of this particular host-lu visibility relationship

ALLOCATER_LU_ASSIGNED public static final int ALLOCATER_LU_ASSIGNED

ALLOCATER_LU_NOT_ASSIGNED public static final int ALLOCATER_LU_NOT_ASSIGNED

ALLOCATER_UNDEFINED public static final int ALLOCATER_UNDEFINED

logicalUnit protected LogicalUnit logicalUnit The logical unit with which this view is associated.

logicalUnitProvider protected LogicalUnitProvider logicalUnitProvider

links protected StorableMap links

uniqueId protected String UniqueId This is a unique ID

hbaName protected String hbaName The hba name that this associated with this LUN

deviceFile protected String deviceFile The host-specific device file for this LUN.

hwPath protected String hwPath The hardware-path (HBA, Port, etc) encoding.

node protected Node node The node through which the HLU is associated with

pathStatus protected int pathStatus The path status

priority protected int priority The path priority

path protected String path Path to hold non-standard formatted path string, ie other than: SCSI l hostname devicefile

logicalStoragePools protected StorableMap logicalStoragePools The LogicalStoragePools that are associated with this HostLogicalUnit.

physicalStorageBlocks protected transient StorableMap physicalStorageBlocks The physical storage block's associated with the host logical unit.

HOSTLOGICALUNIT_ID_FIELD public static final String HOSTLOGICALUNIT_ID_FIELD Constant representing the name of the HostLogical Unit field.

LOGICALUNIT_FIELD public static final String LOGICALUNIT_FIELD Constant representing the name of the logical Unit field.

LOGICALUNITPROVIDER_FIELD public static final String LOGICALUNITPROVIDER_FIELD Constant representing the name of the logicalUnitProvider field.

UNIQUEID_FIELD public static final String UNIQUEID_FIELD Constant representing the name of the uniqueId field.

HBANAME_FIELD public static final String HBANAME_FIELD Constant representing the name of the hbaName field.

DEVICEFILE_FIELD public static final String DEVICEFILE_FIELD Constant representing the name of the deviceFile field.

HWPATH_FIELD public static final String HWPATH_FIELD Constant representing the name of the hwPath field.

NODE_FIELD public static final String NODE_FIELD Constant representing the name of the node field.

PATHSTATUS_FIELD public static final String PATHSTATUS_FIELD Constant representing the name of the pathStatus field.

PRIORITY-FIELD public static final String PRIORITY_FIELD Constant representing the name of the priority field.

PATH_FIELD public static final String PATH_FIELD Constant representing the name of the path field.

HostLogicalUnit public HostLogicalUnit( ) Default constructor.

HostLogicalUnit protected HostLogicalUnit(Dbid dbid) Constructor used internally for loading.

HostLogicalUnit public HostLogicalUnit(LogicalUnitProvider logicalUnitProvider, LogicalUnit logicalUnit, String deviceFile, String hwPath, Node node) Creates a new view of the given logical unit with the specified parameters.

getHost public Host getHost( ) Helper method that will retrieve the Host via the Node

getDevice public Device getDevice( ) Helper method that will return the Device referencing this Specified by:

getDevice in interface ManagementPathIF

getHostLogicalUnit public static HostLogicalUnit getHostLogicalUnit(SystemDevice device, String deviceFile) Gets the HostLogicalUnit for the given system device and device file. If no such host logial unit exists it will return a null.

Parameters:

device-The system device for which a host logical unit should be retrieved. deviceFile-The device file for the host logical unit to retrieve.

Returns:

The host logical lun associated with the given system device and identified on that system device by the given device file. If no such host logical unit can be found anull will be returned.

toString public String toString( ) Returns the string image of this object.

Overrides:

toString in class StorableObject

allocaterLunStatus public int allocaterLunStatus( ) Provides the allocater filtering status for this particular Host-LU visibility relationship

getPath public String getPath( ) Returns the value of the path property.

Specified by:

getPath in interface ManagementPathIF

prepareInsert protected CachedPreparedStatement prepareInsert(ConnectionContext context) throws SQLException This method must be provided in order for the HostLogicalUnit object to become storable, i.e. so it can be added to the database.

Overrides:

prepareInsert in class StorableObject

prepareDelete protected CachedPreparedStatement prepareDelete(ConnectionContext context) throws SQLException This method must be provided in order for the HostLogicalUnit object to become storable, i.e. so it can be deleted from the database.

Overrides:

prepareDelete in class StorableObject

prepareSelect protected CachedPreparedStatement prepareSelect(ConnectionContext context) throws SQLException This method must be provided in order for the HostLogicalUnit object to become storable, i.e. so it can be retrieved from the database.

Overrides:

prepareSelect in class StorableObject

getLogicalUnit public LogicalUnit getLogicalUnit( ) Returns the value of the logicalunit property.

setLogicalUnit public void setLogicalUnit(LogicalUnit logicalUnit) Sets the LogicalUnit property to the specified value. Note that this should not be used as a means to add this object to the list of children of the LogicalUnit parent. An appropriate call to addHostLogicalUnit, if available, should be made on the LogicalUnit parent object instead.

getLogicalUnitProvider public LogicalUnitProvider getLogicalUnitProvider( ) Returns the value of the logicalUnitProvider property.

setLogicalUnitProvider public void setLogicalUnitProvider(LogicalUnitProvider logicalUnitProvider) Sets the LogicalUnitProvider property to the specified value. Note that this should not be used as a means to add this object to the list of children of the LogicalUnitProvider parent. An appropriate call to addHostLogicalUnit, if available, should be made on the LogicalUnitProvider parent object instead.

getUniqueId public String getUniqueId Returns the value of the uniqueId property.

setUniqueId public void setUniqueId(String UniqueId) Sets the UniqueId property to the specified value.

getHbaName public String getHbaName( ) Returns the value of the hbaName property.

setHbaName public void setHbaName(String hbaName) Sets the HbaName property to the specified value.

getDeviceFile public String getDeviceFile( ) Returns the value of the deviceFile property.

setDeviceFile public void setDeviceFile(String deviceFile) Sets the DeviceFile property to the specified value.

getHwPath public String getHwPath( ) Returns the value of the hwPath property.

setHwPath public void setHwPath(String hwpath) Sets the HwPath property to the specified value.

getNode public Node getNode( ) Returns the value of the node property.

setNode public void setNode(Node node) Sets the Node property to the specified value. Note that this should not be used as a means to add this object to the list of children of the Node parent. An appropriate call to addHostLogical Unit, if available, should be made on the Node parent object instead.

getPathStatus public int getPathStatus( ) Returns the value of the pathStatus property.

Specified by:

getPathStatus in interface ManagementPathIF

setPathStatus public void setPathStatus(int pathStatus) Sets the PathStatus property to the specified value.

Specified by:

setPathStatus in interface ManagementPathIF

getPriority public int getPriority( ) Returns the value of the priority property.

Specified by:

getPriority in interface ManagementPathIF

setPriority public void setPriority(int priority) Sets the Priority property to the specified value.

Specified by:

setPriority in interface ManagementPathIF

setPath public void setPath(String path) Sets the Path property to the specified value.

toDebugString public String toDebugString( ) Returns a string image of the the specified HostLogicalUnit.

Overrides:

toDebugString in class StorableObject

toDebugString public String toDebugString(String indent) Description copied from class: StorableObject Returns the debug string image of the object indented using the specified indent string.

Overrides:

toDebugString in class StorableObject

toDebugString public String toDebugString(String indent, Vector callTree) Returns an indented string image of the the specified HostLogicalUnit.

Overrides:

toDebugString in class StorableObject

loadLinks public StorableMap loadLinks( ) Loads and returns the collection of Link objects for this HostLogicalUnit.

getLinks public StorableMap getLinks( ) Returns the collection of Link objects for this HostLogicalUnit.

getLinksIterator public StorableIterator getLinksIterator( ) Returns the collection of Link objects for this HostLogicalUnit.

getLinksIterator public StorableIterator getLinksIterator(String sortFieldName, boolean isAscending) Returns the collection of Link objects for this HostLogicalUnit.

clearLinks public void clearLinks( ) Clears the collection of Link objects for this HostLogicalUnit. Provided to allow applications to explicitely drop references to child Link objects. Please note that subsequent invocations of get/load/add/remove methods will reload the collection.

addLink public void addLink(Link link) Adds the specified Link to the collection of Link objects for this HostLogicalUnit.

removeLink public void removeLink(Link link) Removes the specified Link from the collection of Link objects for this HostLogicalUnit.

getLink public Link getLink(Dbid id) Returns the Link with the specified ID in the collection of Link objects for this HostLogicalUnit.

loadLogicalStoragePools public StorableMap loadLogicalStoragePools( ) Loads and returns the collection of LogicalStoragePool objects for this HostLogicalUnit.

getLogicalStoragePools public StorableMap getLogicalStoragePools( ) Returns the collection of LogicalStoragePool objects for this HostLogicalUnit.

getLogicalStoragePoolsIterator public StorableIterator getLogicalStoragePoolsIterator( ) Returns the collection of LogicalStoragePool objects for this HostLogicalUnit.

getLogicalStoragePoolsIterator public StorableIterator getLogicalStoragePoolsIterator(String sortFieldName, boolean isAscending) Returns the collection of LogicalStoragePool objects for this HostLogicalUnit.

clearLogicalStoragePools public void clearLogicalStoragePools( ) Clears the collection of LogicalStoragePool objects for this HostLogicalUnit.

Provided to allow applications to explicitely drop references to child LogicalStoragePool objects. Please note that subsequent invocations of get/load/add/remove methods will reload the collection.

addLogicalStoragePool public void addLogicalStoragePool(LogicalStoragePool logicalStoragePool) Adds the specified LogicalStoragePool to the collection of LogicalStoragePool objects for this HostLogicalUnit.

removeLogicalStoragePool public void removeLogicalStoragePool(LogicalStoragePool logicalStoragePool) Removes the specified LogicalStoragePool from the collection of LogicalStoragePool objects for this HostLogicalUnit.

getLogicalStoragePool public LogicalStoragePool getLogicalStoragePool(Dbid id) Returns the LogicalStoragePool with the specified ID in the collection of LogicalStoragePool objects for this HostLogicalUnit.

loadPhysicalStorageBlocks public StorableMap loadPhysicalStorageBlocks( ) Loads and returns the collection of PhysicalStorageBlock objects for this HostLogicalUnit.

getPhysicalStorageBlocks public StorableMap getPhysicalStorageBlocks( ) Returns the collection of PhysicalStorageBlock objects for this HostLogicalUnit.

getPhysicalStorageBlocksIterator public StorableIterator getPhysicalStorageBlocksIterator( ) Returns the collection of PhysicalStorageBlock objects for this HostLogicalUnit.

getPhysicalStorageBlocksIterator public StorableIterator getPhysicalStorageBlocksIterator(String sortFieldName, boolean isAscending) Returns the collection of PhysicalStorageBlock objects for this HostLogicalUnit.

clearPhysicalStorageBlocks public void clearPhysicalStorageBlocks( ) Clears the collection of PhysicalStorageBlock objects for this HostLogicalUnit. Provided to allow applications to explicitely drop references to child PhysicalStorageBlock objects. Please note that subsequent invocations of get/load/add/remove methods will reload the collection.

addPhysicalStorageBlock public void addPhysicalStorageBlock(PhysicalStorageBlock physicalStorageBlock) Adds the specified PhysicalStorageBlock to the collection of PhysicalStorageBlock objects for this HostLogicalUnit.

removePhysicalStorageBlock public void removePhysicalStorageBlock(PhysicalStorageBlock physicalStorageBlock) Removes the specified PhysicalStorageBlock from the collection of PhysicalStorageBlock objects for this HostLogicalUnit.

getPhysicalStorageBlock public PhysicalStorageBlock getPhysicalStorageBlock(Dbid id) Returns the PhysicalStorageBlock with the specified ID in the collection of PhysicalStorageBlock objects for this HostLogicalUnit.

getHostLogicalUnitListByLogicalUnit public static StorableList getHostLogicalUnitListByLogicalUnit(LogicalUnit logicalUnit) Returns a list, sorted in no particular order, of HostLogicalUnit objects which have the logicalunit of the specified value.

getByLogicalUnit public static StorableList getByLogicalUnit(LogicalUnit logicalUnit) Deprecated. Returns the HostLogicalUnit which has the logical Unit of the specified value.

getHostLogicalUnitListByLogicalUnitProvider public static StorableList getHostLogicalUnitListByLogicalUnitProvider(LogicalUnitPr ovider logicalUnitProvider) Returns a list, sorted in no particular order, of HostLogicalUnit objects which have the logicalUnitProvider of the specified value.

getByLogicalUnitProvider public static StorableList getByLogicalUnitProvider(LogicalUnitProvider logicalUnitProvider) Deprecated. Returns the HostLogical Unit which has the logicalUnitProvider of the specified value.

getHostLogicalUnitByUniqueld public static HostLogicalUnit getHostLogicalUnitByUniqueId(String uniqueId) Returns the HostLogicalUnit which has the uniqueId of the specified value.

getByUniqueId public static HostLogicalUnit getByUniqueId(String UniqueId) Deprecated. Returns the HostLogicalUnit which has the uniqueId of the specified value.

getHostLogicalUnitListByHbaName public static StorableList getHostLogicalUnitListByHbaName(String hbaName) Returns a list, sorted in no particular order, of HostLogicalUnit objects which have the hbaName of the specified value.

getByHbaName public static StorableList getByHbaName(String hbaName) Deprecated. Returns the HostLogicalUnit which has the hbaName of the specified value.

getHostLogicalUnitListByDeviceFile public static StorableList getHostLogicalUnitListByDeviceFile(String deviceFile) Returns a list, sorted in no particular order, of HostLogicalUnit objects which have the deviceFile of the specified value.

getByDeviceFile public static StorableList getByDeviceFile(String deviceFile) Deprecated. Returns the HostLogicalUnit which has the deviceFile of the specified value.

findOrCreateHostLogicalUnit public static HostLogicalUnit findOrCreateHostLogicalUnit(String UniqueId) Returns an instance of the HostLogicalUnit class. The object is either found using either of the specified unique parameters or is created using all of those unique parameters. This is performed as an atomic operation within the bounds of the same connection context.

findOrCreate public static HostLogicalUnit findOrCreate(String UniqueId) Deprecated. Returns an instance of the HostLogical Unit class. The object is either found using either of the specified unique parameters or is created using all of those unique parameters. This is performed as an atomic operation within the bounds of the same connection context.

Immediately following is a sample template related to the LUN DO 410 of FIG. 4, and corresponding to the immediately preceding JAVA document.

//------------------------------------------------------------------------------
// Copyright 1999-2002 Hewlett-Packard Co., All Rights Reserved.
//------------------------------------------------------------------------------
/**

Class representing Host's view of a logical unit (LUN). It is

associated

with an actual logical unit and has properties which characterize

how the

host sees that LUN. Those properties include hardware path,

device file,

etc.

*/
public final class HostLogicalUnit extends StorableObject implements
ManagementPathIF {

/** Some well-known enumerations of different Host Logical Unit

types.

These names are taken from the Dial External Interface Doc for
DeviceType setting of the LunEntity. */

| | |
|---|---|
| public static final int UNKNOWN_DEVICE | = 0; |

| | |
|---|---|
| public static final int DIRECT_ACCESS_DEVICE | = 1; |

| public static final int SEQUENTIAL_ACCESS_DEVICE = 2; | |
|---|---|
| public static final int PRINTER_DEVICE = 3; | |
| public static final int PROCESSOR_DEVICE = 4; | |
| public static final int WRITE_ONCE_DEVICE | = 5; |

| | |
|---|---|
| public static final int CDROM_DEVICE | = 6; |

| | |
|---|---|
| public static final int SCANNER_DEVICE | = 7; |

| | |
|---|---|
| public static final int OPTICAL_MEMORY_DEVICE | = 8; |
| public static final int MEDIUM_CHANGER_DEVICE | = 9; |

| | |
|---|---|
| public static final int COMM_DEVICE | = 10; |

| public static final int ARRAY_CONTROLLER =11; | |
|---|---|
| public static final int ENCLOSURE_SERVICES | = 12; |

| | |
|---|---|
| public static final int FC_SCSI_MUX | = 13; |

| | |
|---|---|
| public static final int FC_SWITCH | = 14; |

/**

Values returned from allocaterLunStatus which describes the
allocater filtering state of this particular host-lu visibility
relationship

*/
public static final int ALLOCATER_LU_NOT_CONTROLLED = 0;
public static final int ALLOCATER_LU_ASSIGNED = 1;
public static final int ALLOCATER_LU_NOT_ASSIGNED = 2;
public static final int ALLOCATER_UNDEFINED = 3; //set if

allocaterLunStatus encountered error

/** The logical unit with which this view is associated. */
// ::getBy unsorted logicalUnit
protected LogicalUnit logicalUnit;
//** The LogicalUnitProvider associated with the LogicalUnits */
// ::getBy unsorted logicalUnitProvider
protected LogicalUnitProvider logicalUnitProvider;
//** The collection of links that this hostlogical unit is part of */
// ::relate HostLogicalUnit links Link hostLogicalUnits
protected StorableMap links;
/** This is a unique ID ***/
// ::getBy unique uniqueId
protected String uniqueId;
/** The hba name that this associated with this LUN */
// ::getBy unsorted hbaName
protected String hbaName;
/** The host-specific device file for this LUN. */
// ::getBy unsorted deviceFile

protected String deviceFile;

/** The hardware-path (HBA, Port, etc) encoding. */
protected String hwPath;
/** The node through which the HLU is associated with */
protected Node node;
/** The path status */
protected int pathStatus;
/** The path priority */
protected int priority;
/** Path to hold non-standard formatted path string, i.e., other

than:

SCSI | hostname | devicefile */

protected String path;
/**
* The {@link LogicalStoragePool LogicalStoragePools} that are

associated

* with this HostLogicalUnit.
*/
// ::relate HostLogicalUnit logicalStoragePools LogicalStoragePool

hostLogicalUnits

protected StorableMap logicalStoragePools;
/** The physical storage block's associated with the host logical

unit.*/

// ::relate HostLogicalUnit physicalStorageBlocks

PhysicalStorageBlock hostLogicalUnit

protected transient StorableMap physicalStorageBlocks;
/** Creates a new view of the given logical unit with the specified

parameters. */

public HostLogicalUnit (LogicalUnitProvider logicalUnitProvider,

LogicalUnit logicalUnit,
String deviceFile, String hwPath, Node node) {

super ( );
this.logicalUnit = logicalUnit;
this.deviceFile = deviceFile;
this.hwPath = hwPath;
this.logicalUnitProvider = logicalUnitProvider;
this.node = node;
this.physicalStorageBlocks = null;
/* ::post-compile
if( logicalUnit != null) {

logicalUnit.setIsAssigned(true);

}
this.uniqueId = node.getDbid( ) + “:” + deviceFile;
::post-compile */

} // HostLogicalUnit
/** Helper method that will retrieve the Host via the Node */
/* ::post-compile
public Host getHost( ) {

Node node = getNode( );
if (node != null)
return (Host)node.getPlatformDevice( );
return null;

} // getHost
::post-compile */
/** Helper method that will return the Device referencing this */
public Device getDevice ( ){

/* ::post-compile
return (getLogicalUnitProvider( ) != null) ? (Device)

getLogicalUnitProvider( ) : null;

::post-compile */ return null;

}
/**
* Gets the HostLogicalUnit for the given system device and device

file.

* If no such host logical unit exists it will return a null.
*
* @param device The system device for which a host logical unit

should

* be retrieved.
* @param deviceFile The device file for the host logical unit to

retrieve.

*
* @return The host logical lun associated with the given system

device and

* identified on that system device by the given device file. If no

such

* host logical unit can be found a null will be returned.
*/
public static HostLogicalUnit getHostLogicalUnit(SystemDevice

device,

String deviceFile) {

/* ::post-compile
StorableMap nodes = device.getNodes( );
StorableCollection hostLogicalUnits =

HostLogicalUnit.getHostLogicalUnitListByDeviceFile(deviceFile);

Iterator iteration = hostLogicalUnits.iterator( );
while(iteration.hasNext( )) {

HostLogicalUnit hostLun = (HostLogicalUnit)iteration.next( );
Node lunNode = hostLun.getNode( );
// Test if found correct host lun, if so return immediately.
if(nodes.contains(lunNode))

return hostLun;

}
// if fail to find proper LUN for device file use *ugly* hack to
// search for an alternative name.
deviceFile = alternateDeviceFile(device, deviceFile);
hostLogicalUnits =

HostLogicalUnit.getHostLogicalUnitListByDeviceFile(deviceFile);

iteration = hostLogicalUnits.iterator( );
while(iteration.hasNext( )) {

HostLogicalUnit hostLun = (HostLogicalUnit)iteration.next( );
Node lunNode = hostLun.getNode( );
// Test if found correct host lun, if so return immediately.
if(nodes.contains(lunNode))

return hostLun;

}
// If never found proper host lun return null.
::post-compile */
return null;

}
/**
* Convenience method to determine the appropriate alternative

device file

* that may be in use if allocator is present.
*/
private static String alternateDeviceFile(SystemDevice device,

String deviceFile) {

String altDeviceFile = null;
/* ::post-compile
try {

if(device.getOsType( ) = = Host.SOLARIS) {

int index = deviceFile.lastIndexOf(‘:’);
String baseDeviceFile = deviceFile.substring(0, index);
altDeviceFile = baseDeviceFile + “:dummy”;

}
else

altDeviceFile = deviceFile;

}
catch(IndexOutOfBoundsException exception) {

altDeviceFile = deviceFile;

}
::post-compile */
return altDeviceFile;

}
/** Returns the string image of this object. */
/* ::post-compile
public String toString ( ) {

String class_string = super.toString( );
return class_string + “ HLU: \nDBID”+super.getDbid( )+

“\nLUID:”+(logicalUnit = = null ? 0 : logicalUnit.getDbid( ).longValue( )) +
“\nLUPID:” +( logicalUnitProvider = = null ? 0 :
logicalUnitProvider.getDbid( ).longValue( )) +
“\nuniqueID”+uniqueId+“\nhbaName:”+hbaName+“ \ndeviceFile:” +
getDeviceFile( ) +“\nhwPath”+hwPath+“\nnodeID:”+(node = = null ? 0 :
node.getDbid( ).longValue( ))+“\npathStatus”+pathStatus+“\npriority:”+
priority;

} // toString
::post-compile */
/** Provides the allocater filtering status for this particular Host-LU

visibility relationship */

/* ::post-compile
public int allocaterLunStatus( ) {

Host host = getHost( );
if (host = = null) {

return ALLOCATER_UNDEFINED;

}
LMHost lmHost = LMHost.getLMHostByRuid(host.getRuid( ));
if (lmHost = = null) {

return ALLOCATER_LU_NOT_CONTROLLED;

}
Iterator iter = lmHost.loadActiveAssignments( ).iterator( );
LMInitiatorTargetAssignment assignment = null;
LogicalUnit logicalUnit = getLogicalUnit( );
if (logicalUnit = = null) {

return ALLOCATER_UNDEFINED;

}
Ruid targetRuid = logicalUnit.getRuid( );
if (targetRuid = = null) {

return ALLOCATER_UNDEFINED;

}
while (iter.hasNext( )) {

assignment = (LMInitiatorTargetAssignment)iter.next( );
if (targetRuid.equals(assignment.getTarget( ).getRuid( ))) {

return ALLOCATER_LU_ASSIGNED;

}

}
return ALLOCATER_LU_NOT_ASSIGNED;

} // allocaterLunStatus
::post-compile */
/** Returns the value of the path property. */
public String getPath( ) {
/* ::post-compile

if( this.path != null)

::post-compile */

return this.path;

/* ::post-compile

else {

// path is SCSI | hostname | devicefile
if( getNode( ) != null){

PlatformDevice pdev = getNode( ).getPlatformDevice( );
String hostname = “”;
if( pdev instanceof Host ){

hostname = ((Host) pdev).getPrimaryIp( );

}
return Target.TARGET_TYPE_SCSI +

Target.PATH_SEPARATOR +

(hostname != null ? hostname : “”)+

Target.PATH_SEPARATOR +

(getDeviceFile( ) != null ? getDeviceFile( ) : “”) ;

}
else{

return “”;

}

}

::post-compile */
} // getPath

} // HostLogicalUnit

The invention may be embodied in other forms without departing from its spirit and essential characteristics. The described embodiments are to be considered only non-limiting examples of the invention. The scope of the invention is to be measured by the appended claims. All changes which come within the meaning and equivalency of the claims are to be embraced within their scope.

What is claimed:

1. A method of data extraction for use with a host, connected to one or more logical units (LUNs), that is operable to host a volume manager that manages access to said one or more LUNs via the creation of one or more volume groups, the method comprising:
providing one or more queries to said volume manager; and
determining, for each volume group, which of said one or more LUNs are members of the volume group based upon results of said queries, respectively.

2. The method of claim 1, wherein each volume group includes one or more logical volumes, the method further comprising
identifying, for each logical volume, portions of said one or more LUNs that are allocated to said one or more logical volumes based upon said results of said queries, respectively.

3. The method of claim 2, wherein
each of said portions is represented by a mapping between the respective LUN and the respective logical volume (LV), and
said mapping including
a map from the respective LUN to a physical storage block (PSB),
an at least indirect map from said PSB to a logical storage block (LSB), and
a map from said LSB to the respective LV.

4. The method of claim 3, wherein said LSB is a higher level LSB and said at least indirect map from said PSB to said higher level LSB includes
a map from said PSB to a lower level LSB; and
a map from said lower level LSB to said higher level LSB.

5. The method of claim 3, wherein
a plurality of LSBs can map to an LV;
a plurality of PSBs can map to an LSB; and
a LUN can map to a plurality of PSBs.

6. The method of claim 3, wherein said mapping is represented in a standardized data set.

7. The method of clam 6, wherein content of said standardized data set is independent of the type of volume manager to which said queries were made.

8. The method of claim 6, wherein said standardized data set is written in XML.

9. A code arrangement on a computer-readable medium for use for use with a host, connected to one or more logical units (LUNs), that is operable to host a volume manager that manages access to said one or more LUNs via the creation of one or more volume groups, execution of said code arrangement by one or more processors of the host causing data to be extracted from said volume manager,
the code arrangement comprising:
a query code segment to provide one or more queries to said volume manager; and
a determination code segment to determine, for each volume group, which of said one or more LUNs are members of the volume group based upon results of said queries, respectively.

10. The computer-readable code arrangement of claim 9, wherein each volume group includes one or more logical volumes, the computer-readable code arrangement further comprising
an identification code segment to identify, for each logical volume, portions of said one or more LUNs that are allocated to said one or more logical volumes based upon said results of said queries, respectively.

11. The computer-readable code arrangement of claim 10, wherein
each of said portions is represented by a mapping between the respective LUN and the respective logical volume (LV), and
said mapping including
a map from the respective LUN to a physical storage block (PSB),
an at least indirect map from said PSB to a logical storage block (LSB), and
a map from said LSB to the respective LV.

12. The computer-readable code arrangement of claim 11, wherein said LSB is a higher level LSB and said at least indirect map from said PSB to said higher level LSB includes
a map from said PSB to a lower level LSB; and
a map from said lower level LSB to said higher level LSB.

13. The computer-readable code arrangement of claim 11, wherein
a plurality of LSBs can map to an LV;
a plurality of PSBs can map to an LSB; and
a LUN can map to a plurality of PSBs.

14. The computer-readable code arrangement of claim 11, wherein said mapping is represented in a standardized data set.

15. The computer-readable code arrangement of clam 14, wherein content of said standardized data set is independent of the type of volume manager to which said queries were made.

16. The computer-readable code arrangement of claim 14, wherein said standardized data set is written in XML.

17. A host device, connected to one or more logical units (LUNs), that is operable to host a volume manager that manages access to said one or more LUNs via the creation of one or more volume groups, and that is operable to extract data from said volume manager by loading and executing a code arrangement according to claim 9.

18. A data extraction apparatus, connected to one or more logical units (LUNs), operatively connected to host a volume manager that manages access to said one or more LUNs via the creation of one or more volume groups, for causing data to be extracted from said volume manager, the data extraction apparatus comprising:
query means for providing one or more queries to said volume manager; and
determination means for determining, for each volume group, which of said one or more LUNs are members of the volume group based upon results of said queries, respectively.
